(19) United States
(12) Patent Application Publication
(10) Pub. No.: US 2005/0214675 A1
(43) Pub. Date: Sep. 29, 2005

(54) Positive-type photosensitive composition

(75) Inventors: Kotaro Watanabe, Shizuoka-ken (JP); Ikuo Kawauchi, Shizuoka-ken (JP); Yusuke Hatanaka, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/081,087

(22) Filed: Mar. 16, 2005

(30) Foreign Application Priority Data
Mar. 16, 2004 (JP) 2004-75119
Mar. 16, 2004 (JP) 2004-75121
Aug. 30, 2004 (JP) 2004-250843

(51) Int. Cl. G03C 1/492

(52) U.S. Cl. 430/270.1

(57) ABSTRACT

The positive-type photosensitive composition according to the present invention contains a novolak resin (A), an alkali-soluble resin (B) selected from the group consisting of resins prepared by addition polymerization of a vinyl compound and condensation polymers such as imide, amide, urethane, urea, ester, and resol resins, an infrared absorbing agent (C), and a sulfonium salt (D). The positive-type photosensitive composition is superior in sensitivity, greater in layer strength, and readily dissociates by infrared ray exposure, and thus is useful as the recording layer for positive-type planographic printing plate precursors.

### CROSS-REFERENCE TO RELATED APPLICATION

This application claims priority under 35 USC 119 from Japanese Patent Application Nos. 2004-075119 and 2004-075121, the disclosures of which are incorporated by reference herein. Reference is made to related Japanese Patent Application No. 2004-250843, the disclosure of which is incorporated by reference.

### BACKGROUND OF THE INVENTION

1. Field of the Invention

The present invention relates to a positive-type photosensitive composition that increases its solubility in an aqueous alkaline solution by exposure to infrared rays. In particular it relates to a positive-type photosensitive composition useful as an image-recording layer for so-called direct-plate-making planographic printing plate precursors that allow direct plate-making by scanning an infrared laser based on digital signals from, for example, a computer.

2. Description of the Related Art

Various photosensitive compositions have been used as visible image-forming materials and planographic printing plate materials. With the recent rapid progress in the development of lasers, especially in planographic printing, higher-output and smaller solid state and semiconductor lasers having emission wavelengths in the range from near-infrared to infrared region are becoming more easily accessible. When plate making is performed directly from digital data from, for example a computer, these lasers play an important role as exposure-light sources.

Positive-type planographic printing plate precursors for infrared laser have an aqueous alkaline solution-soluble binder resin and an IR dye or the like, that absorbs light and generates heat, as the essential components. Planographic printing plates are produced from the precursors using the following mechanism. The IR dye or the like therein functions as a solubilization inhibitor, substantially reducing the solubility of the binder resin, by interaction with the binder resin, in the unexposed regions (image regions). The binder resin dissolves in an alkaline developer in the exposed regions (non-image regions), because of the weakened interaction between the IR dye or the like and the binder resin, due to the heat generated.

However, the positive-type planographic printing plate precursors for infrared laser had the problem that the difference between the insolubility of binder resin in the unexposed regions (image regions) and the solubility thereof in the exposed regions (non-image regions) in the developer (hereinafter, referred to as solubility discrimination) was not large enough under various conditions of developing. Often this lead to variation in the quality of developed images, excessive or insufficient, depending on the conditions of developing.

To overcome this problem, a photosensitive composition wherein the major portion of the alkali-soluble resin is made of a novolak resin (e.g., European Patent Application Laid-Open No. 0823327A2) was proposed as the method for improving the solubility discrimination. The novolak resin in the unexposed region became less soluble in the developer, due to hydrogen bonding among phenolic hydroxyl groups, interaction with other additives contained in the photosensitive composition, or the like, and more soluble in the exposed region by the heat generated, improving the solubility discrimination. However, this resin still had the problem that the solubility discrimination was not really satisfactory, and also there was low developing stability (development latitude) for the conditions of use.

On the other hand, many compounds have been examined as solubilization inhibitors, and among them, onium salt-type solubilization inhibitors have been known to have very strong solubilization-inhibiting ability. However, although addition of a common onium salt compound was effective in improving the alkali resistance of the resin in the unexposed region, because of the enhanced solubilization-inhibiting potential, it still carried the problem of the deterioration in sensitivity caused by, for example, handling under white light. To overcome this problem, a new photosensitive composition containing a particular onium salt that has superior decomposition properties under light exposure was proposed (e.g., Japanese Patent Application Laid-Open (JP-A) No.2002-278050). Although this onium salt showed better properties showing at the same time both high solubilization-inhibiting ability and high sensitivity, it became apparent that the salt caused a new problem. This problem was one of the deterioration in printing properties with time when, for example, an exposed plate was not developed immediately after exposure but developed after a certain period of time. The deterioration in printing properties with time after exposure is a serious problem in the plate-making process, requiring improvement. (Hereinafter, the degree of change in the printing properties over time after exposure is expressed by the term “post-exposure stability”, and a greater degree of deterioration in printing properties is referred to as “inferior post-exposure stability”.)

Recently, another photosensitive composition for improvement in development latitude was disclosed, containing a novolak resin and a vinyl polymer containing a particular amount of carboxyl groups and having a preadjusted solubility parameter (e.g., JP-A No. 2003-345014). The photosensitive composition is superior in coating forming properties and coating strength; further more the exposed regions thereof are rapidly dissolved in an aqueous alkaline solution. Thus the photosensitive composition is effective in improving the printing durability and the development latitude when used as a recording layer of a planographic printing plate precursor. However, the photosensitive composition still requires further improvement in the post-exposure stability when it is applied to a planographic printing plate precursor.

### SUMMARY OF THE INVENTION

The present invention has been made in view of the above circumstances and provides a positive-type photosensitive composition superior in sensitivity, greater in layer strength, and which readily releases the mutual interactions by infrared ray exposure, which is useful as a recording layer for positive-type planographic printing plate precursor.

The invention also provides a photosensitive composition superior in development latitude, sensitivity, and post-exposure stability, and useful as a recording layer for positive-type planographic printing plate precursors.

After intensive studies, the present inventors have found that the characteristics can be achieved by the means described below, and have achieved the invention.

A first aspect of the invention is a positive-type photosensitive composition comprising a novolak resin (A), an alkali-soluble resin (B) selected from the group consisting of resins prepared by addition polymerization of a vinyl compound, and condensation polymers such as imide, amide, urethane, urea, ester, and resol resins, infrared absorbing agent (C), and a sulfonium salt (D).

Although not completely clear yet, the action of the invention is thought to be as follows:

The photosensitive composition according to the invention, which contains a novolak resin (A) and a specific alkali-soluble non novolak resin (B), is likely more effective in stabilizing the layer than a layer consisting only of a novolak resin.

Also the addition of the sulfonium salt (D), which forms strong interactions between the novolak resin (A) and the specific alkali-soluble resin (B), seems to be effective in increasing the layer strength.

Specifically, the specific alkali-soluble resin (B) for use in the invention is uniformly compatible with both the novolak resin (A) and the sulfonium salt (D), allowing stable, uniform distribution of the sulfonium salt (D) and the resins (A) and (B), in close proximity to each other in the photosensitive composition layer. This leads to enhanced interactions between the sulfonium salt (D) and the resins (A) and (B) and consequently a further increase in layer strength.

On the other hand, when the photosensitive composition according to the invention is subjected to infrared ray exposure, the sulfonium salt (D) shows high sensitivity and decomposes readily, thereby eliminating the strong interactions with the resins (A) and (B).

As described above, the sulfonium salt (D) gets close to the resins (A) and (B) in the photosensitive composition layer. For that reason, the release of the interactions occurs close to the resins, resulting in a higher degree of effectiveness than that when a generalized onium salt is added separately to the photosensitive composition.

As described above, the photosensitive composition according to the invention is superior in its layer stability and layer strength, improving the resistance of the image regions to the developer, and the image regions become less vulnerable to damage with developing solutions of higher activity, when applied as the recording layer for positive-type planographic printing plate precursor.

As described above, in the non-image regions (exposed regions), the sulfonium salt (D) decomposes with high sensitivity by infrared ray exposure, and more ready solubility in an alkali solution develops, accelerating the dissolution of the photosensitive composition in the non-image region into the aqueous alkaline solution.

When the photosensitive composition according to the invention containing a sulfonium salt (D) is applied to the recording layer for a positive-type planographic printing plate precursor, if an exposure plate is not developed immediately after exposure but developed after a certain period of time, the alkali-solubility of the exposed region does not deteriorate. This is because the sulfonium salt (D) decomposes readily with high sensitivity by exposure, and as well the decomposition reaction is irreversible, which seems to be effective in suppressing the deterioration in printing properties over time.

It is thought that for these reasons, the positive-type planographic printing plate precursor using the photosensitive composition according to the invention is superior in development latitude, sensitivity, and post-exposure stability.

Thus, the invention provides a positive-type photosensitive composition superior in sensitivity, greater in layer strength, which readily releases the mutual interactions by infrared ray exposure, and is useful as a recording layer for a positive-type planographic printing plate precursor.

The invention also provides a photosensitive composition superior in development latitude, sensitivity, and post-exposure stability and useful as a recording layer for positive-type planographic printing plate precursor.

In a second aspect of the invention, the positive-type photosensitive composition according to the invention (image-forming material) has a support, and an image-forming layer formed on the support. Wherein the image-forming layer contains a novolak-type phenol resin (A) containing phenol as a structural unit, a photothermal converter (B), and a sulfonium salt (C).

Post-exposure stability is generally improved at the sacrifice of development latitude. However, to our surprise, the positive-type photosensitive composition according to the invention resulted in improvement in both sensitivity and development latitude as well as in post-exposure stability.

Although the action of the invention is not clear, it seems that addition of a sulfonium salt to the image-forming layer leads to an increase in the resistance of image regions to the developer due to the interaction with the particular novolak resin, a film-forming component in the image-forming layer, or more specifically, an interaction with phenol, the structural unit thereof. This makes the image regions more resistant to damage by highly reactive developers and formes image regions superior in development endurance.

Because the sulfonium salt is readily decomposable by heat and the decomposition reaction is irreversible, the development endurance derived by the sulfonium salt disappears rapidly by decomposition in the infrared laser-exposed regions, resulting in improvement in printing properties and superior solubility discrimination.

In general in the exposed regions of the positive-type image-forming layer, a deterioration in printing properties over time is caused by re-formation of the interaction between the novolak resin and the solubilization inhibitor that was lost on exposure.

However, in the invention, the sulfonium salt added to the image-forming layer decomposes rapidly in the infrared laser-exposed regions and the development resistance derived from the sulfonium salt disappears, leading to an improvement in the printing properties in the exposed regions. The development resistance disappears irreversibly by the decomposition of the sulfonium salt. For that reason, the deterioration in printing properties over time, after exposure, is also prevented.

In the invention, the term “compatible with heat mode” means that the precursor is compatible with recording by heat-mode exposure.

The definition of the heat-mode exposure in the invention will be described below in detail. As described in Hans-Joachim Timpe, IS&Ts NIP 15: 1999 International Conference on Digital Printing Technologies, p. 209, the disclosure of which is incorporated by reference herein, there are grossly two modes of processes from optical excitation of a light absorption material (e.g. dye) in a photosensitive material, via chemical or physical changes, to give image formation.

One is a so-called photon mode, wherein the optically excited light absorption material is inactivated by some photochemical interaction with another reactive material present in the photosensitive material (e.g., energy transfer or electron transfer), and the resulting activated reaction product triggers a chemical or physical change that is needed for the image formation described above.

Another is a so-called heat mode wherein the optically excited light absorption material is inactivated, emitting heat, this heat then triggers the chemical or physical change of the reactive material needed for the image formation described above.

There are also other special modes such as ablation wherein material is scattered explosively by locally concentrated light energy, and multi-photon absorption wherein a molecule absorbs multiple photons at the same time, but the description thereof is omitted here.

Exposure processes in the modes described before are referred to respectively as photon-mode exposure and heat-mode exposure. The technical difference between photon-mode exposure and heat-mode exposure is whether it is possible to add the energy of several exposure photons to the energy of the desired reaction.

For example, assume a case when a reaction is triggered by n photons. By the photon-mode exposure, which utilizes a photochemical interaction, the law of conservation of quantum energy and momentum prohibits the addition of the energy of several photons. In other words, in order to trigger a reaction, the following relation should be satisfied:

“Energy amount of a single photon>=reaction energy amount”.

Whereas, in heat-mode exposure, which utilizes the heat converted from the photoenergy applied during photoexcitation, the addition of energy from several photons is allowed. Thus in this case, only the following relationship need be satisfied:

“Energy amount of n photons>=reaction energy amount”.

However, the addition of the energy is restricted by thermal diffusion.

Namely, if the subsequent photoexcitation—inactivation process, generating heat, occurs before the removal of heat from the exposed region area (reactive area) by thermal diffusion, then heat certainly builds up, leading to an increase in the temperature of the area. However, if the subsequent heat generation process is delayed then there is an escape of heat, prohibiting accumulation of heat.

With heat-mode exposure the result is different between when high-energy light is irradiated for a short period and when low-energy light is irradiated for a long period, even if the total exposure energy is the same. The short-term irradiation of high-energy light is more advantageous for heat accumulation.

Of course, a similar phenomenon may be encountered due to the influence of the diffusion of reactive species even with photon-mode exposure, but practically this does not occur.

In terms of the properties of the photosensitive material, with photon mode the inherent sensitivity of photosensitive material (energy of the reaction required for image formation) remains constant even when the exposure power density (W/cm²)(energy density per unit period) varies, but the inherent sensitivity of the photosensitive material increases as the exposure power density increases with heat mode.

Accordingly, when these modes are compared in practice as image recording materials, with the necessary exposure times for maintaining the required productivity rates, photon-mode exposure photosensitive materials are inherently sensitive at a relatively low level (approximately 0.1 mJ/cm²), and can be made highly sensitive. However, the reaction inevitably occurs with photon-mode exposure, no matter how low the exposure intensity is, often leading to the problem of low-exposure background fogging in unexposed regions.

In contrast, with heat-mode exposure the reaction occurs only when the photosensitive material is irradiated at a certain exposure intensity or higher. As a result, considering the thermal stability of photosensitive materials, a photosensitive material normally having an inherent sensitivity of approximately 50 mJ/cm² can avoid the problem of the low-exposure background fogging.

In fact, photosensitive material require an exposure power density on the plate surface of 5,000 W/cm² or more, preferably 10,000 W/cm² or more, with heat-mode exposure. However, although not described here in detail, use of a high-power density laser of 5.0×10⁵ W/cm² or more is not favorable, as it causes ablation, resulting in problems such as staining of the light source.

In short, the invention provides an image-forming material useful for positive-type planographic printing plate precursors compatible with heat mode, superior in solubility discrimination, and favorable in post-exposure stability. Application of this image-forming material enables production of a positive-type planographic printing plate precursors superior in development latitude, permitting high-sensitivity recording, and with improved post-exposure stability.

### DETAILED DESCRIPTION OF THE INVENTION

Hereinafter, a first embodiment of the positive-type photosensitive composition according to the present invention (hereinafter, referred to simply as photosensitive composition) will be described in detail.

### First Embodiment

The positive-type photosensitive composition according to the invention (present embodiment) characteristically contains a novolak resin (A), an alkali-soluble resin (B) selected from the group consisting of resins prepared by addition polymerization of a vinyl compound and condensation polymers such as imide, amide, urethane, urea, ester, and resol resins, (hereinafter, referred to as specific alkali-soluble resin), an infrared absorbing agent (C), and a sulfonium salt (D).

Constituent components of the photosensitive composition according to the invention will be described separately below.

[Novolak Resin (A)]

Examples of the novolak resins used in the invention include resins prepared by polycondensation of at least one phenol such as phenol, o-cresol, m-cresol, p-cresol, 2,5-xylenol, 3,5-xylenol, o-ethylphenol, m-ethylphenol, p-ethylphenol, propylphenol, n-butylphenol, tert-butylphenol, 1-naphthol, 2-naphthol, pyrocatechol, resorcinol, hydroquinone, pyrogallol, 1,2,4-benzenetriol, fluoroglycinol, 4,4′-biphenyldiol, or 2,2-bis(4′-hydroxyphenyl)propane, with at least one aldehydes such as formaldehyde, acetaldehyde, propionaldehyde, benzaldehyde, or furfural (formaldehyde may be substituted with paraformaldehyde and acetaldehyde with paraldehyde) or a ketone such as acetone, methylethylketone, or methylisobutylketone, for example, in the presence of an acid catalyst.

In the invention, favorable are polycondensation polymers from a phenol such as phenol, o-cresol, m-cresol, p-cresol, 2,5-xylenol, 3,5-xylenol, or resorcinol and an aldehyde or ketone such as formaldehyde, acetaldehyde, or propionaldehyde; in particular, polycondensation polymers from a mixed phenol containing m-cresol: p-cresol: 2,5-xylenol: 3,5-xylenol: resorcinol at a molar ratio of 40 to 100:0 to 50:0 to 20:0 to 20:0 to 20, or containing phenol:m-cresol:p-cresol at a molar ratio of 0 to 100:0 to 70:0 to 60 and formaldehyde are preferable.

The photosensitive composition according to the invention contains the sulfonium salt (D) described below as a solubilization inhibitor. Considering the interaction with the sulfonium salt, a polycondensation polymer from a mixed phenol containing m-cresol: p-cresol: 2,5-xylenol: 3,5-xylenol: resorcinol at a molar ratio of 70 to 100:0 to 30:0 to 20:0 to 20:0 to 20, or containing phenol:m-cresol:p-cresol at a molar ratio of 10 to 100:0 to 60:0 to 40 and formaldehyde is preferable as the novolak resin (A) in the invention.

The weight-average molecular weight of the novolak resin (A) as polystyrene, as determined by gel-permeation chromatography (hereinafter, referred simply as weight-average molecular weight) is preferably 500 to 20,000, still more preferably 1,000 to 15,000, and particularly preferably 3,000 to 12,000. When the weight-average molecular weight is in the range, the resin has a sufficiently high layer-forming capacity and a high alkali-solubility in the region exposed to infrared ray irradiation.

Alternatively, the content of novolak resin (A) in the photosensitive composition according to the invention is preferably in the range of 50 to 95%, more preferably in the range of 70 to 93%, and still more preferably, 75 to 85% by weight with respect to the total solid matters in the photosensitive layer composition, from the viewpoints of both surface layer-forming properties and resistance to alkaline developer.

[Specific Alkali-Soluble Resin (B)]

The specific alkali-soluble resins (B) according to the invention are resins prepared by addition polymerization of a vinyl compound or condensation polymers such as imide, amide, urethane, urea, ester, and resol resins. These resins are described separately in detail.

[Resin Prepared by Addition Polymerization of a Vinyl Compound]

The resins prepared by addition polymerization of a vinyl compound according to the invention (hereinafter, referred to as vinyl polymers) include resins prepared by addition polymerization of a vinyl compound such as styrene, vinyl chloride, vinyl acetate, vinylether, acrylonitrile, methacrylonitrile, acrylamide, methacrylamide, acrylic acid, methacrylic acid, or ethylene.

More specific examples thereof include polyhydroxystyrene, polyhalogenated hydroxystyrene, copolymers of N-(4-hydroxyphenyl)methacrylamide, copolymers of hydroquinone monomethacrylate, carboxyl group-containing vinyl polymers, phenolic hydroxyl group-containing acrylic resins, acrylic resins having a sulfonamide group, and the like.

Among them, carboxyl group-containing vinyl polymers are preferable for improvement in the resistance to an alkaline developer in the unexposed region by the interactions between carboxyl groups and between the carboxyl groups and the phenolic hydroxyl groups.

(Carboxyl Group-Containing Vinyl Polymer)

The carboxyl group-containing vinyl polymer according to the invention can be prepared by addition polymerization of a monomer having a carboxyl group.

Among the carboxyl group-containing vinyl polymers, vinyl polymers (particular vinyl polymers) containing at least one copolymerization component having a carboxyl group, having carboxyl groups in the molecule at a content of 2.0 meq/g or more, and having a solubility parameter of less than 21.3 MPa^{1/2} are more preferable.

Monomer having a carboxyl group for use as the copolymerization component for the particular vinyl polymer above is not particularly limited, if it has a carboxyl group and a polymerizable double bond in the molecule, and particularly preferable examples thereof include those represented by the following General Formula (1).

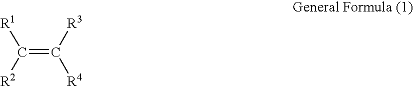

In General Formula (1), R¹ to R⁴ each independently represent a hydrogen atom, an alkyl group, or an organic group represented by the following General Formula (2); and at least one of R¹ to R⁴ is the organic group represented by General Formula (2). At least one of the groups R¹ to R⁴ preferably has one or two organic groups, particularly favorably one organic group represented by General Formula (2) from the viewpoints of the copolymerizability and the availability of raw material during production of the particular vinyl polymer, and the groups of R¹ to R⁴ other than the organic group represented by General Formula (2) are preferably an alkyl group or a hydrogen atom, particularly preferably a hydrogen atom, from the viewpoint of the flexibility of the particular vinyl polymer obtained by polymerization,

From the same reason, when the groups R¹ to R⁴ are an alkyl group, the alkyl group is preferably an alkyl group having 1 to 4 carbons, and in particular a methyl group.
—X—COOH General Formula (2)

In General Formula (2), X represents a single bond, an alkylene group, an arylene group which may have one or more substituents, or a group represented by one of the following formulae (3) to (5), and is preferably a single bond, an arylene group represented by a phenylene group or a group represented by the following structure, and in particular a single bond from the viewpoints of the polymerizability and the availability of raw material.

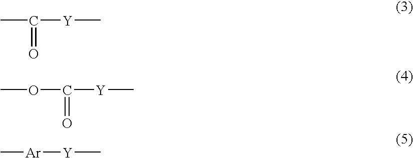

In Structural Formulae (3) to (5), Y represents a bivalent connecting group, and Ar an arylene group which may have one or more substituents. Y is preferably an alkylene group having 1 to 16 carbons or a single bond, the methylene (—CH₂—) in the alkylene group may be substituted with an ether bond (—O—), thioether bond (—S—), ester bond (—COO—), or amide bond (—CONR—; R is a hydrogen atom or alkyl group), and the bond substituting the methylene group is preferably an ether or ester bond.

Particularly preferable typical examples of the bivalent connecting groups are listed below.

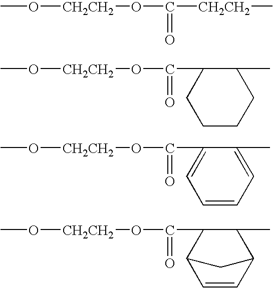

Particularly preferable examples of the monomers having a carboxyl group represented by the General Formula (1) above are shown below, but the invention is not limited thereto.

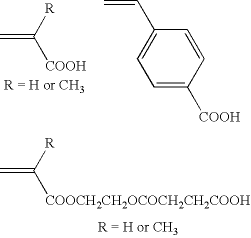

These particular vinyl polymers according to the invention can be prepared by copolymerizing one of these monomers having a carboxyl group with another copolymerization component, and the copolymerization ratio is calculated according to the following desirable content of the carboxyl group.

The content of the carboxyl groups in the particular vinyl polymer is 2.0 meq/g or more (unit: milimolar equivalence per g of vinyl polymer), preferably 2.2 meq/g or more, for ensuring alkaline printing properties. The upper limit of the content of carboxyl group is not particularly limited, but is preferably less than 5.0 meq/g, for ensuring the hydrophobic nature of the composition and the favorable physical properties of the layer.

The particular vinyl polymer for use in the invention characteristically has a content of carboxyl group of 2.0 meq/g or more as described above and a solubility parameter of the particular vinyl polymer of less than 21.3 MPa^{1/2}. The solubility parameter used is a value calculated according to the theoretical equation proposed by Toshinao Okitsu (Journal of the Adhesion Society of Japan Vol. 29, No. 6 (1993) pp. 249 to 259) by employing a weighted average calculated according to the molar ratio of copolymerization components.

It is necessary to copolymerize a monomer containing the carboxyl group above with another monomer and thus reduce the solubility parameter of the resulting polymer, for adjustment of the solubility parameter of the particular vinyl polymer to less than 21.3 MPa^{1/2}. It is because homopolymers only from the monomer containing the carboxyl group above have an excessively high solubility parameter. Other monomer used as the copolymerization component is not particularly limited if the monomers if it is a component copolymerizable with the monomer having a carboxyl group and has the physical properties reducing the solubility parameter of the particular vinyl polymer, and preferable examples thereof include the following monomers (1) to (11):

(1) Acrylic and methacrylic esters having one or more aliphatic hydroxyl groups such as 2-hydroxyethyl acrylate or 2-hydroxyethyl methacrylate;

(2) Alkyl acrylates such as methyl acrylate, ethyl acrylate, propyl acrylate, butyl acrylate, amyl acrylate, hexyl acrylate, octyl acrylate, benzyl acrylate, 2-chloroethyl acrylate, glycidyl acrylate, and N-dimethylaminoethyl acrylate;

(3) Alkyl methacrylates such as methyl methacrylate, ethyl methacrylate, propyl methacrylate, isopropyl methacrylate, butyl methacrylate, isobutyl methacrylate, amyl methacrylate, hexyl methacrylate, cyclohexyl methacrylate, 2-ethylhexyl methacrylate, benzyl methacrylate, 2-chloroethyl methacrylate, glycidyl methacrylate, and N-dimethylaminoethyl methacrylate;

(4) Acrylamides or methacrylamides such as acrylamide, methacrylamide, N-methylol acrylamide, N-ethyl acrylamide, N-hexyl methacrylamide, N-cyclohexyl acrylamide, N-hydroxyethyl acrylamide, N-phenyl acrylamide, N-nitrophenyl acrylamide, N-ethyl-N-phenyl acrylamide, N,N-dimethyl acrylamide, N,N′-diisopropyl acrylamide, and acryloylmorpholine;

(5) Vinylethers such as ethylvinylether, 2-chloroethylvinylether, hydroxyethylvinylether, propylvinylether, butylvinylether, octylvinylether, and phenylvinylether;

(6) Vinylesters such as vinyl acetate, vinyl chloroacetate, vinyl butyrate, and vinyl benzoate;

(7) Vinylesters such as vinyl acetate, vinyl chloroacetate, vinyl butyrate, and vinyl benzoate;

(8) Vinylketones such as methylvinylketone, ethylvinylketone, propylvinylketone, and phenylvinylketone;

(9) Olefins such as ethylene, propylene, isobutylene, butadiene, and isoprene;

(10) N-vinylpyrrolidone, N-vinylcarbazole, 4-vinylpyridine, acrylonitrile, methacrylonitrile, and the like; and

(11) Unsaturated imides such as N-acryloyl acrylamide, N-acetyl methacrylamide, N-propionyl methacrylamide, and N-(p-chlorobenzoyl)methacrylamide.

Among the comonomer components (1) to (11), alkyl acrylates (2), alkyl methacrylates (3), acrylamide or methacrylamidse (4), and styrenes (7) are preferably used; alkyl acrylates (2) and alkyl methacrylates (3) are still more preferably used for controlling the solubility parameter to less than 21.3 MPa^{1/2} and improving the surface layer-forming properties; and use of the alkyl acrylates (2) is most preferable, from the viewpoint of the flexibility of the particular polymer produced as the result of polymerization.

Further, the alkyl acrylates (2) or alkyl methacrylates (3), when used as the copolymerization component, are particularly preferably alkyl acrylates or alkyl methacrylates having an unsubstituted alkyl group, and the unsubstituted alkyl group may be a straight-chain or branched-chain group. The number of carbons of the alkyl group is preferably 2 to 8 and more preferably 2 to 4.

From the point of the compatibility with the novolak resin (A) described above, combined use of two or more alkyl acrylates or alkyl methacrylates in copolymerization with the monomer containing the carboxyl group above is preferable, and combined use of straight-chain and branched-chain alkyl acrylates or alkyl methacrylates in copolymerization is particularly preferable.

The weight-average molecular weight of the particular vinyl polymer according to the invention particular is preferably 15,000 to 200,000, still more preferably 25,000 to 100,000, and particularly preferably 32,000 to 70,000. When the molecular weight is in the range, the vinyl polymer shows a sufficiently high layer-forming capacity and a high alkali-solubility in the region exposed to infrared ray irradiation.

The vinyl polymer according to the invention particular can be prepared, using a known radical polymerization initiator by any of known methods including graft copolymerization, block copolymerization, random copolymerization, and the like.

Vinyl polymers favorably used in the invention among the particular vinyl polymers are exemplified below, but the invention is not limited thereto. The number in parenthesis indicates the solubility parameter of each unit (MPa^{1/2}); the number of (1), the content of carboxyl group (meq/g); and the number of (2), the solubility parameter of polymer (MPa^{1/2}).

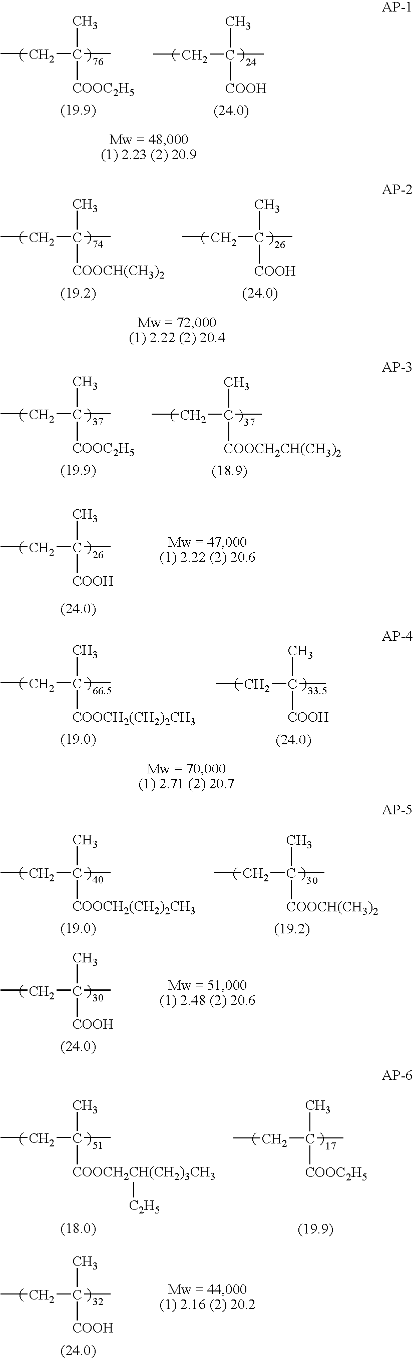

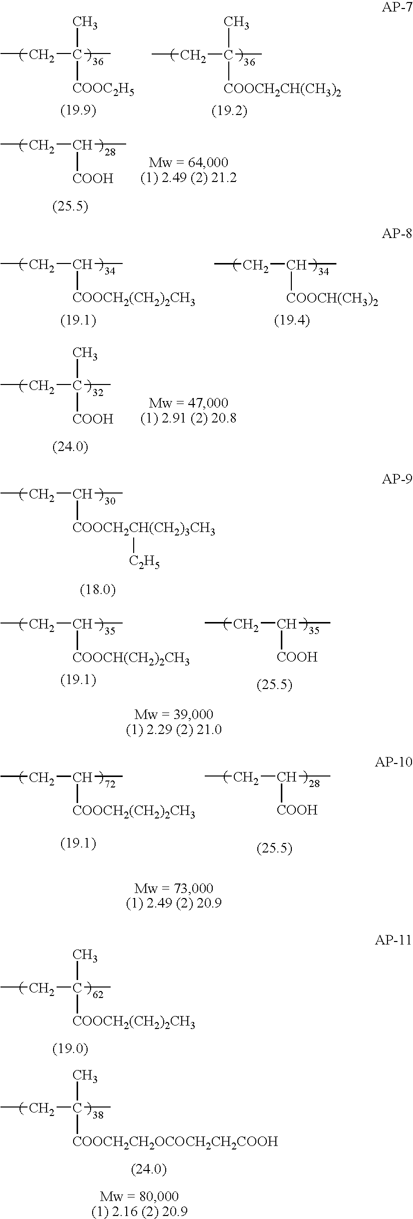

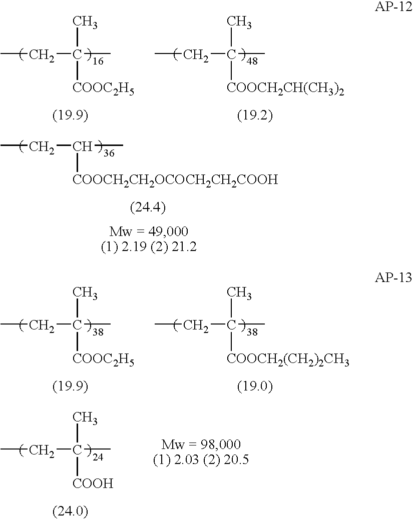

[Urethane Resin Prepared by Condensation Polymerization]

The urethane resin prepared by condensation polymerization in the invention (hereinafter, referred to simply as urethane resin) is not particularly limited if it is soluble in water and an aqueous alkaline solution, and among many urethane resins, the urethane resins having a carboxyl group at the side chain are preferable, and specific examples thereof include polyurethane resins having a reaction product from a diisocyanate compound represented by the following General Formula (A) and at least one diol compound having a carboxyl group represented by the following General Formula (B) or (C) as the main skeleton.

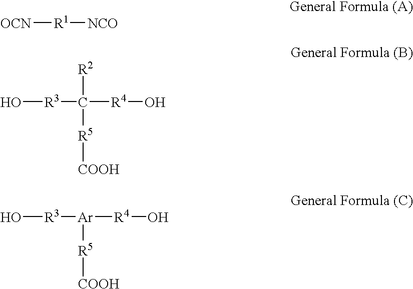

In General Formula (A), R¹ represents a bivalent connecting group. The bivalent connecting group is, for example, an aliphatic hydrocarbon, alicyclic hydrocarbon, or aromatic hydrocarbon, and is preferably, an alkylene group having 2 to 10 carbons or an arylene group having 6 to 30 carbons. The arylene group may have two or more cyclic structures bound to each other via bivalent organic connecting groups such as single bond, methylene group, or the like or a fused polycyclic structure.

In addition, R¹ may contain as needed another functional group such as ester, urethane, amide, and ureide group that is not reactive with the isocyanate group in Formula (A). Additionally, R¹ may have a substituent, and examples of the possible substituents include those inert to the isocyanate group such as halogen atoms (—F, —Cl, —Br, and —I), alkyl groups, alkoxyl groups, alkyl ester groups, cyano group, and the like.

Besides the compounds represented by the General Formula (A) above, the diisocyanate compounds for use in the invention include high-molecular weight diisocyanate compounds having isocyanate groups at both terminal of the polymeric compound, for example, oligomers or polymers of the diol compounds described below.

In General Formula (B), R² represents a hydrogen atom, alkyl group, aralkyl group, aryl group, alkoxy group, or aryloxy group. R² may have a substituent, and examples of the possible substituent include cyano group, nitro group, halogen atoms (—F, —Cl, —Br, —I), —CONH₂, —COOR⁶, —OR⁶, —NHCONHR⁶, —NHCOOR⁶, —NHCOR⁶, —OCONHR⁶, —CONHR⁶ (wherein, R⁶ represents an alkyl group having 1 to 10 carbons or an aralkyl group having 7 to 15 carbons), and the like.

Preferable examples of R² include a hydrogen atom, unsubstituted alkyl groups having 1 to 8 carbons, and unsubstituted aryl groups having 6 to 15 carbons.

In General Formula (B) or (C), R³, R⁴, and R⁵ each independently represent a single bond or a bivalent connecting group. The bivalent connecting groups include aliphatic hydrocarbons and aromatic hydrocarbons. R³, R⁴, and R⁵ may have a substituent, and the possible substituents include alkyl groups, aralkyl groups, aryl groups, alkoxy groups, halogen atoms (—F, —Cl, —Br, and —I), and the like.

Preferable examples of R³, R⁴, and R⁵ include alkylene groups having 1 to 20 carbons unsubstituted and unsubstituted arylene groups having 6 to 15 carbons, and more preferable examples are alkylene groups having 1 to 8 carbons unsubstituted. R³, R⁴, and R⁵ may have as needed another functional group inert to the isocyanate group in General Formula (A), for example, an ester, urethane, amide, ureide, or ether group.

In addition, two or three of the R², R³, R⁴, and R⁵ groups may bind to each other, forming a cyclic structure.

In General Formula (C), Ar represents a trivalent aromatic hydrocarbon which may have one or more substituents, and preferably an arylene group having 6 to 15 carbons.

Typical examples of the diisocyanate compounds represented by the General Formula (A) above include the followings, but the invention is not limited thereto: aromatic diisocyanate compounds such as 2,4-tolylene diisocyanate, dimer of 2,4-tolylene diisocyanate, 2,6-tolylene diisocyanate, p-xylylene diisocyanate, m-xylylene diisocyanate, 4,4′-diphenylmethane diisocyanate, 1,5-naphthylene diisocyanate, and 3,3′-dimethylbiphenyl-4,4′-diisocyanate; aliphatic diisocyanate compounds such as hexamethylene diisocyanate, trimethylhexamethylene diisocyanate, lysine diisocyanate, and dimer acid diisocyanate; alicyclic diisocyanate compounds such as isophorone diisocyanate, 4,4′-methylene bis(cyclohexylisocyanate), methylcyclohexane-2,4 (or 2,6)-diisocyanate, and 1,3-(isocyanatomethyl)cyclohexane; diisocyanate compounds obtained by reaction of a diol and a diisocyanate, for example, an adduct from one mole of 1,3-butylene glycol and two moles of tolylene diisocyanate; and the like.

Among them, compounds having one or more aromatic rings such as 4,4′-diphenylmethane diisocyanate, xylylene diisocyanate, and tolylene diisocyanate are more preferable from the viewpoint of printing durability.

Alternatively, typical examples of the diol compounds having a carboxyl group represented by General Formula (B) or (C) include the followings, but the invention is not limited thereto: 3,5-dihydroxybenzoic acid, 2,2-bis(hydroxymethyl)propionic acid, 2,2-bis(hydroxyethyl)propionic acid, 2,2-bis(3-hydroxypropyl)propionic acid, 2,2-bis(hydroxymethyl)acetic acid, bis-(4-hydroxyphenyl)acetic acid, 4,4-bis-(4-hydroxyphenyl)pentane acid, tartaric acid, and the like.

Among them, 2,2-bis(hydroxymethyl)propionic acid and 2,2-bis(hydroxyethyl)propionic acid are more preferable from the viewpoint of reactivity with isocyanates.

The polyurethane resin according to the invention is a resin prepared by using two or more of the diisocyanate compounds represented by the General Formula (A) above and two or more of the diol compounds having a carboxyl group represented by General Formula (B) or (C) respectively.

The polyurethane resin may contain, in addition to the diol compound having a carboxyl group represented by General Formula (B) or (C), another diol compound containing no carboxyl group and having one or more substituents which are inert to the isocyanate group in General Formula (A) to the extent that does not decrease the alkaline printing properties.

Typical examples of the other diol compounds include the followings: ethylene glycol, propylene glycol, neopentylglycol, 1,3-butylene glycol, 1,6-hexanediol, 2-butene-1,4-diol, 2,2,4-trimethyl-1,3-pentanediol, 1,4-bis-β-hydroxyethoxycyclohexane, cyclohexane dimethanol, tricyclodecane dimethanol, hydrogenated bisphenol A, hydrogenated bisphenol F, ethylene oxide adduct of bisphenol A, propylene oxide adduct of bisphenol A, ethylene oxide adduct of bisphenol F, propylene oxide adduct of bisphenol F, ethylene oxide adduct of hydrogenated bisphenol A, propylene oxide adduct of hydrogenated bisphenol A, hydroquinone dihydroxyethylether, p-xylylene glycol, dihydroxyethylsulfone, bis-(2-hydroxyethyl)-2,4-tolylene dicarbamate, 2,4-tolylene-bis-(2-hydroxyethylcarbamide), bis-(2-hydroxyethyl)-m-xylylene carbamate, bis-(2-hydroxyethyl phthalate, and the like.

The urethane resin according to the invention can be prepared by condensation polymerization of the diisocyanate compound above and the diol compound above under heat in an aprotic solvent in the presence of a known catalyst that has a catalytic activity suitable for the reactivities of the compounds.

The molar ratio of the diisocyanate to the diol compound used is preferably, 0.8:1 to 1.2:1, and if there are isocyanate groups remaining at the terminals of the polymer, the isocyanate groups are treated with an alcohol, amine, or the like, so that there is no isocyante groups remaining on the polymer.

Further, resins having an aromatic skeleton in the structure are more preferable as the urethane resin according to the invention from the point of chemical resistance.

The weight-average molecular weight of the urethane resin according to the invention is preferably 1,000 or more and still more preferably in the range of 5,000 to 100,000. These polyurethane resins may be used alone or in combination of two or more.

[Urea Resin Prepared by Condensation Polymerization]

The urea resin prepared by condensation polymerization in the invention (hereinafter, referred to simply as urea resin) is not particularly limited if it is insoluble in water and soluble in an alkali solution and contains an urea bond in the polymer main chain.

The urea bond generally means a bond “—NH—CO—NH—”, but the urea bond in the invention also include the structure above wherein the hydrogen of the “—NH—” is replaced with any substituent.

Examples of the urea bonds in the invention include those represented by the following General Formula (a).

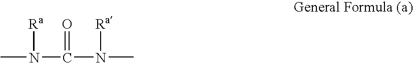

In General Formula (a), R^{a} and R^{a′} each independently represent a hydrogen atom, alkyl group, aryl group, or aralkyl group. In the invention, R^{a} and R^{1′} each are preferably a hydrogen atom.

When R^{a} and R^{a′} are an alkyl group, the alkyl group preferably has a carbon number of about 1 to 20 and more preferably a carbon number of about 1 to 6.

When R^{a} and R^{a′} are an aryl group, the aryl group preferably has a carbon number of about 6 to 24 and more preferably a carbon number of about 6 to 15.

When R^{a} and R^{a′} are an aralkyl group, the aralkyl group preferably has a carbon number of about 7 to 24 and more preferably a carbon number of about 7 to 15. In addition, at least one of the substituents represented by R^{a} and R^{a′} may bind to another binding site on the nitrogen atom to which the substituent is bound, forming a cyclic structure, and for example, the bond represented by the following formula is also included the urea bonds according to the invention.

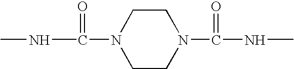

One of the methods for introducing the urea bond into a polymer main chain is to react a compound having an isocyanate group with a primary or secondary amine.

The urea resin according to the invention is preferably a resin having a reaction product from at least one diisocyanate compound represented by the following General Formula (b), at least one diol compound having a carboxyl group represented by the following General Formulae (c), (d) and (e), and at least one compound capable of introducing an urea bond into polymer main chain such as a compound having a primary or secondary amine as the main skeleton.

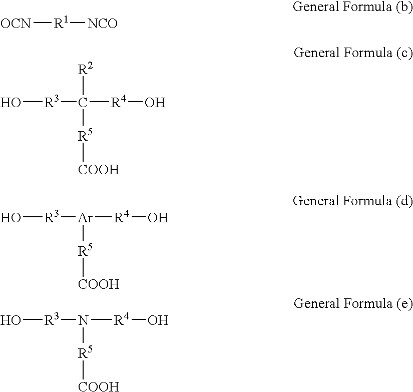

In General Formula (b), R¹ represents a bivalent connecting group. The connecting group is for example an aliphatic hydrocarbon, alicyclic hydrocarbon, or aromatic hydrocarbon, and preferably, an alkylene group having 2 to 12 carbons or an arylene group having 6 to 20 carbons. The arylene group may contain two or more cyclic structures that are bound to each other via bivalent organic connecting groups such as single bond and methylene group or a fused polycyclic structure. In addition, R¹ may contain as needed another functional group inert to the isocyanate group in Formula (b) such as an ester, urethane, or amide group.

Further, R¹ may have a substituent, and preferable examples of the possible substituents include alkyl groups, aralkyl groups, aryl groups, alkoxy groups, halogen atoms (—F, —Cl, —Br, and —I), and the like.

In addition to the compounds represented by the General Formula (b) above, the diisocyanate compound used in the invention may also include, for example, a high-molecular weight diisocyanate compound having isocyanate groups at both terminal of the polymeric compound, such as an oligomer or polymer of the diol compound described below.

Typical examples of the diisocyanate compounds include the followings, but the invention is not limited thereto: aromatic diisocyanate compounds such as 2,4-tolylene diisocyanate, dimer of 2,4-tolylene diisocyanate, 2,6-tolylene diisocyanate, p-xylylene diisocyanate, m-xylylene diisocyanate, 4,4′-diphenylmethane diisocyanate, 1,5-naphthylene diisocyanate, and 3,3′-dimethylbiphenyl-4,4′-diisocyanate; aliphatic diisocyanate compounds such as hexamethylene diisocyanate, trimethylhexamethylene diisocyanate, lysine diisocyanate, and dimer acid diisocyanate; alicyclic diisocyanate compounds such as isophorone diisocyanate, 4,4′-methylene bis(cyclohexylisocyanate), methylcyclohexane-2,4 (or 2,6)diisocyanate, and 1,3-(isocyanatomethyl)cyclohexane; diisocyanate compounds obtained by reaction of a diol and a diisocyanate, for example, an adduct from one mole of 1,3-butylene glycol and two moles of tolylene diisocyanate; and the like.

Among them, compounds having one or more aromatic rings such as 4,4′-diphenylmethane diisocyanate, p-xylylene diisocyanate, and 3,3′dimethylbiphenyl-4,4′-diisocyanate are more preferable from the viewpoints of printing durability and chemical resistance.

In General Formula (c), R² represents a hydrogen atom, alkyl group, aralkyl group, aryl group, alkoxy group, or aryloxy group. R² may have a substituent, and examples of the possible substituents include cyano group, nitro group, halogen atoms (—F, —Cl, —Br, and —I), —CONH₂, —COOR⁶, —OR⁶, —NHCONHR⁶, —NHCOOR⁶, —NHCOR⁶, —OCONHR⁶, —CONHR⁶ (wherein, R⁶ represents an alkyl group having 1 to 10 carbons or an aralkyl group having 7 to 15 carbons), and the like.

Preferably, R² is a hydrogen atom, an unsubstituted alkyl group having 1 to 8 carbons, or an unsubstituted aryl group having 6 to 15 carbons.

In General Formula (c), (d) or (e), R³, R⁴, and R⁵ each independently represent a single bond or a bivalent connecting group. The bivalent connecting groups include aliphatic hydrocarbons and aromatic hydrocarbons. R³, R⁴, and R⁵ may have a substituent, and examples of the possible substituents include alkyl groups, aralkyl groups, aryl groups, alkoxy groups, halogen atoms (—F, —Cl, —Br, and —I), and the like.

Preferably, R³, R⁴, and R⁵ each are an unsubstituted alkylene group having 1 to 20 carbons or an unsubstituted arylene group having 6 to 15 carbons, and more preferably an unsubstituted alkylene group having 1 to 8 carbons. R³, R⁴, and R⁵ each may have as needed another functional group inert to the isocyanate group in the General Formula (b) above such as an ester, urethane, amide, ureide, or ether group.

In addition, two or three of the groups R², R³, R⁴, and R⁵ may bind to each other, forming a cyclic structure.

In General Formula (d), Ar represents a trivalent aromatic hydrocarbon which may have one or more substituents, and preferably an arylene group having 6 to 15 carbons.

Typical examples of the diol compounds having a carboxyl group represented by General Formula (c), (d) or (e) include the followings, but the invention is not limited thereto: 3,5-dihydroxybenzoic acid, 2,2-bis(hydroxymethyl)propionic acid, 2,2-bis(2-hydroxyethyl)propionic acid, 2,2-bis(3-hydroxypropyl)propionic acid, bis(hydroxymethyl)acetic acid, bis(4-hydroxyphenyl)acetic acid, 4,4-bis(4-hydroxyphenyl)pentane acid, tartaric acid, N,N-dihydroxyethylglycine, and the like.

Among them, 3.5-dihydroxybenzoic acid and 2,2-bis(hydroxymethyl)propionic acid are preferable from the easiness in production.

The compound capable of introducing an urea bond into polymer main chain used in the invention is not particularly limited, and examples thereof include compounds having at least one primary or secondary amine in the molecule such as aliphatic diamine compounds, aromatic diamine compounds, heterocyclic amine compounds, and amino alcohol or aminophenol compounds, compounds having a preintroduced urea bond in the molecule (hereinafter, referred to as “urea compounds”), and the like.

Among them, primary aliphatic diamines and primary aromatic diamines are particularly preferable from the viewpoint of printing durability.

Typical examples of the compounds include the followings, but the invention is not limited thereto:

Aliphatic diamine compounds: particularly preferably, ethylenediamine, propylenediamine, tetramethylenediamine, pentamethylenediamine, hexamethylenediamine, heptamethylenediamine, octamethylenediamine, dodecamethylenediamine, propane-1,2-diamine, bis(3-aminopropyl)methylamine, 1,3-bis(3-aminopropyl)tetramethyl siloxane, piperazine, 2,5-dimethylpiperazine, N-(2-aminoethyl)piperazine, 4-amino-2,2,6,6-tetramethylpiperidine, N,N-dimethyl ethylenediamine, lysine, L-cystine, and the like.

Among them, ethylenediamine, propylenediamine, tetramethylenediamine, and hexamethylenediamine are particularly preferable.

Aromatic diamine compounds: o-phenylenediamine, m-phenylenediamine, p-phenylenediamine, 2,4-tolylenediamine, benzidine, o-ditoluidine, o-dianisidine, 4-nitro-m-phenylenediamine, 2,5-dimethoxy-p-phenylenediamine, bis-(4-aminophenyl)sulfone, 4-carboxy-o-phenylenediamine, 3-carboxy-m-phenylenediamine, 4,4′-diaminodiphenylether, 1,8-naphthalenediamine, and the like.

Among them, m-phenylenediamine and 4,4′-diaminodiphenylether are particularly preferable.

Heterocycle amine compound: 2-aminoimidazole, 3-aminotriazole, 5-amino-1H-tetrazole, 4-aminopyrazole, 2-aminobenzimidazole, 2-amino-5-carboxy-triazole, 2,4-diamino-6-methyl-S-triazine, 2,6-diamino pyridine, L-histidine, DL-tryptophan, adenine, and the like.

Amino alcohol or aminophenol compounds: ethanolamine, N-methyl-ethanolamine, N-ethyl-ethanolamine, 1-amino-2-propanol, 1-amino-3-propanol, 2-aminoethoxyethanol, 2-aminothioethoxyethanol, 2-amino-2-methyl-1-propanol, p-aminophenol, m-aminophenol, o-aminophenol, 4-methyl-2-aminophenol, 2-chloro-4-aminophenol, 4-methoxy-3-aminophenol, 4-hydroxybenzylamine, 4-amino-1-naphthol, 4-aminosalicyclic acid, 4-hydroxy-N-phenylglycine, 2-aminobenzylalcohol, 4-aminophenethylalcohol, 2-carboxy-5-amino-1-naphthol, L-tyrosine, and the like.

Among them, m-aminophenol and 4-aminophenethylalcohol are particularly preferable.

The urea compound used in the invention is not particularly limited, if it has at least one urea bond in a molecule and if it is capable of introducing an urea bond into the main chain of polymer during polymerization.

Specific examples thereof include 2,4-tolylene-bis(2-hydroxyethylcarbamide), m-xylylene-bis(2-hydroxyethylcarbamide), hexamethylene-bis(2-hydroxyethylcarbamide), 4,4′-diphenylmethane-bis(2-hydroxyethylcarbamide), 1,5-naphthalene-bis(2-hydroxyethylcarbamide) and the like, and among them, hexamethylene-bis(2-hydroxyethylcarbamide) and 4,4′-diphenylmethane-bis(2-hydroxyethylcarbamide) are particularly preferable.

In addition, a diol compound different from those represented by the General Formulae (c) to (e) may be introduced into main chain in the range that does not impair the advantageous effects of the invention.

Specific examples thereof include ethylene glycol, diethylene glycol, triethylene glycol, tetraethylene glycol, propylene glycol, dipropylene glycol, polyethylene glycol, polypropylene glycol, neopentylglycol, 1,3-butylene glycol, 1,6-hexanediol, 2-buten-1,4-diol, 2,2,4-trimethyl-1,3-pentanediol, 1,4-bis-β-hydroxyethoxycyclohexane, cyclohexane dimethanol, tricyclodecane dimethanol, hydrogenated bisphenol A, hydrogenated bisphenol F, ethylene oxide adduct of bisphenol A, propylene oxide adduct of bisphenol A, ethylene oxide adduct of bisphenol F, propylene oxide adduct of bisphenol F, ethylene oxide adduct of hydrogenated bisphenol A, propylene oxide adduct of hydrogenated bisphenol A, hydroquinone dihydroxyethylether, p-xylylene glycol, dihydroxyethylsulfone, bis(2-hydroxyethyl)-2,4-tolylene dicarbamate, bis(2-hydroxyethyl)-m-xylylene dicarbamate, bis(2-hydroxyethyl) isophthalate, and the like.

The urea resin according to the invention can be prepared by dissolving the components in an aprotic solvent, adding a known catalyst suitable for the reactivities of the raw materials, and condensation-polymerizing the mixture by heating.

The molar ratio of the total of the diol compound represented by General Formulae (c) to (e) and the compounds having a primary or secondary amine and/or the compound having an urea bond to the diisocyanate compound used is preferably 0.8:1 to 1.2:1, and if there are isocyanate groups remaining at the terminals of the polymer, the isocyanate groups are treated with an alcohol, amine, or the like, so that there is no isocyante group remaining on the polymer.

Alternatively, the molar ratio of the compound having a primary or secondary amine and/or the urea compound to the diol compound represented by General Formulae (c) to (e) is preferably 95:5 to 0:100, more preferably 90:10 to 10:90, and still more preferably 80:20 to 20:80.

The weight-average molecular weight of the urea resin according to the invention is preferably 1,000 or more and still more preferably in the range of 3,000 to 200,000.

These urea resins may be used alone or in combination of two or more.

[Ester Resin Prepared by Condensation Polymerization]

The ester resin prepared by condensation polymerization in the invention (hereinafter, referred to simply as ester resin) is not particularly limited, if it is soluble in water and an alkali solution and has an ester bond in the polymer main chain.

Examples of the resins having an ester bond in the polymer main chain include poly(ester-urethane)-based resins, polyester resins, and the like. In the invention, poly(ester-urethane)-based resins are particularly preferable.

One of the methods for introducing an ester bond into the polymer main chain in the ester resin according to the invention is, for example, to react an isocyanate compound with a diol compound containing an alkali-soluble group in the structure and a diol compound having an ester bond in the structure.

For example, polymeric compounds having a reaction product from the diisocyanate compound represented by the following General Formula (i), at least one compound selected from the diol compounds having a carboxy group represented by the following General Formulae (ii), (iii) and (iv), and at least one compound selected from the diol compounds represented by the following General Formulas (v) and (vi) as the main skeleton are preferable as the ester resin according to the invention.

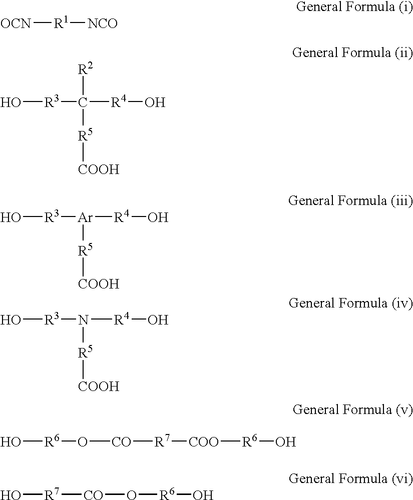

In General Formula (i), R¹ represents a bivalent connecting group. The connecting group is preferably an aliphatic hydrocarbon, an alicyclic hydrocarbon, or an aromatic hydrocarbon, and preferably, an alkylene group having 2 to 12 carbons or an arylene group having 6 to 20 carbons. The arylene group may contain two or more cyclic structures that are bound to each other via bivalent organic connecting groups such as single bond and methylene group or a fused polycyclic structure. R¹ may contain as needed another functional group inert to the isocyanate group in Formula (b) such as an ester, urethane, or amide group.

R¹ may have additionally a substituent, and preferable examples of the possible substituents include alkyl groups, aralkyl groups, aryl groups, alkoxy groups, halogen atoms (—F, —Cl, —Br, and —I), and the like.

In addition to the compounds represented by the General Formula (b) above, the diisocyanate compound used in the invention may also contain, for example, a high-molecular weight diisocyanate compound having isocyanate groups at both terminal of the polymeric compound, such as an oligomer or polymer of the diol compound described below.

Typical examples of the diisocyanate compounds include the followings, but the invention is not limited thereto: aromatic diisocyanate compounds such as 2,4-tolylene diisocyanate, dimer of 2,4-tolylene diisocyanate, 2,6-tolylene diisocyanate, p-xylylene diisocyanate, m-xylylene diisocyanate, 4,4′-diphenylmethane diisocyanate, 1,5-naphthylene diisocyanate, and 3,3′-dimethylbiphenyl-4′-diisocyanate; aliphatic diisocyanate compounds such as hexamethylene diisocyanate, trimethylhexamethylene diisocyanate, lysine diisocyanate, and dimer acid diisocyanate; alicyclic diisocyanate compounds such as isophorone diisocyanate, 4,4′-methylene bis(cyclohexylisocyanate), methylcyclohexane-2,4 (or 2,6)-diisocyanate, and 1,3-(isocyanatomethyl)cyclohexane; diisocyanate compounds obtained by reaction of a diol and a diisocyanate, for example, an adduct from one mole of 1,3-butylene glycol and two moles of tolylene diisocyanate; and the like.

Among them, compounds having one or more aromatic rings such as 4,4′-diphenylmethane diisocyanate, xylylene diisocyanate, and tolylene diisocyanate are more preferable from the viewpoints of printing durability and chemical resistance.

In General Formula (ii), R² represents a hydrogen atom, alkyl group, aralkyl group, aryl group, alkoxy group, or aryloxy group. R² may have a substituent, and examples of the possible substituents include cyano group, nitro group, halogen atoms (—F, —Cl, —Br, and —I), —CONH₂, —COOR⁸, —OR⁸, —NHCONHR⁸, —NHCOOR⁸, —NHCOR⁸, —OCONHR⁸, —CONHR⁸ (wherein, R⁸ represents an alkyl group having 1 to 10 carbons or an aralkyl group having 7 to 15 carbons), and the like.

Preferably, R² is a hydrogen atom, an unsubstituted alkyl group having 1 to 8 carbons, or an unsubstituted aryl group having 6 to 15 carbons.

General Formula (ii), (iii) or (iv), R³, R⁴, and R⁵ each independently represent a single bond or a bivalent connecting group. The bivalent connecting groups include aliphatic hydrocarbons and aromatic hydrocarbons. R³, R⁴, and R⁵ may have a substituent, and examples of the possible substituents include alkyl groups, aralkyl groups, aryl groups, alkoxy groups, halogen atoms (—F, —Cl, —Br, and —I), and the like.

Preferably, R³, R⁴, and R⁵ each are an unsubstituted alkylene group having 1 to 20 carbons or an unsubstituted arylene group having 6 to 15 carbons, and more preferably an unsubstituted alkylene group having 1 to 8 carbons. R³, R⁴, and R⁵ each may have as needed another functional group inert to the isocyanate group shown in the General Formula (b) above, such as an ester, urethane, amide, ureide, or ether group.

In addition, two or three of the groups R², R³, R⁴, and R⁵ may bind to each other, forming a cyclic structure.

In General Formula (iii), Ar represents a trivalent aromatic hydrocarbon which may have one or more substituents and is preferably an arylene group having 6 to 15 carbons.

Typical examples of the diol compounds having a carboxyl group represented by General Formula (ii), (iii) or (iv) include the followings, but the invention is not limited thereto: 3,5-dihydroxybenzoic acid, 2,2-bis(hydroxymethyl)propionic acid, 2,2-bis(2-hydroxyethyl)propionic acid, 2,2-bis(3-hydroxypropyl)propionic acid, bis(hydroxymethyl)acetic acid, bis(4-hydroxyphenyl)acetic acid, 4,4-bis(4-hydroxyphenyl)pentanoic acid, tartaric acid, N,N-dihydroxyethylglycine, and the like.

Among them, 3,5-dihydroxybenzoic acid and 2,2-bis(hydroxymethyl)propionic acid are preferable from easiness in preparation.

In General Formula (v) or (vi), R⁶ and R⁷ each independently represent a bivalent connecting group, and may bind to each other, forming a cyclic structure. The bivalent connecting groups include aliphatic hydrocarbon and aromatic hydrocarbon, and heterocyclic moieties. In addition, R⁶, R⁷ may have a substituent, and examples of the possible substituents include cyano group, nitro group, halogen atoms (—F, —Cl, —Br, and —I), —CONH₂, —COOR⁸, —OR⁸, —NHCONHR⁸, —NHCOOR⁸, —NHCOR⁸, —OCONHR⁸, —CONHR⁸ (wherein, R⁸ represents an alkyl group having 1 to 10 carbons or an aralkyl group having 7 to 15 carbons), and the like.

Preferable examples of the groups R⁶ and R⁷ include unsubstituted alkylene groups having 1 to 20 carbons, unsubstituted arylene groups having 6 to 15 carbons, and heterocyclic hydrocarbons groups having 4 or more carbons. More preferably, R⁶ and R⁷ each are an unsubstituted alkylene group having 1 to 8 carbons.

Typical examples of the compounds represented by General Formula (v) or (vi) (No.1 to No.28) are listed below, but the invention is not limited thereto:

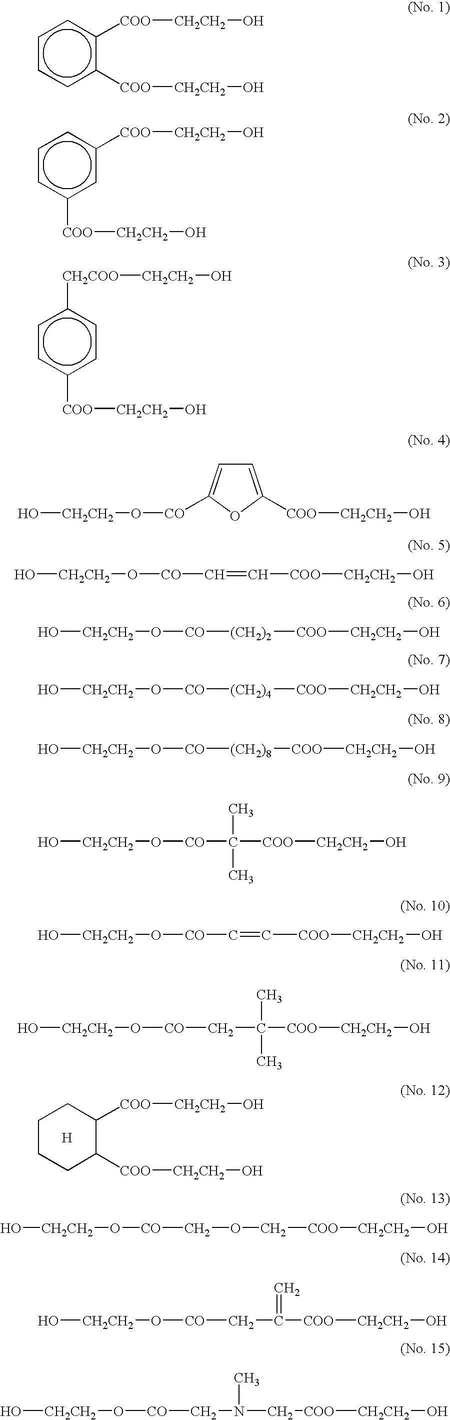

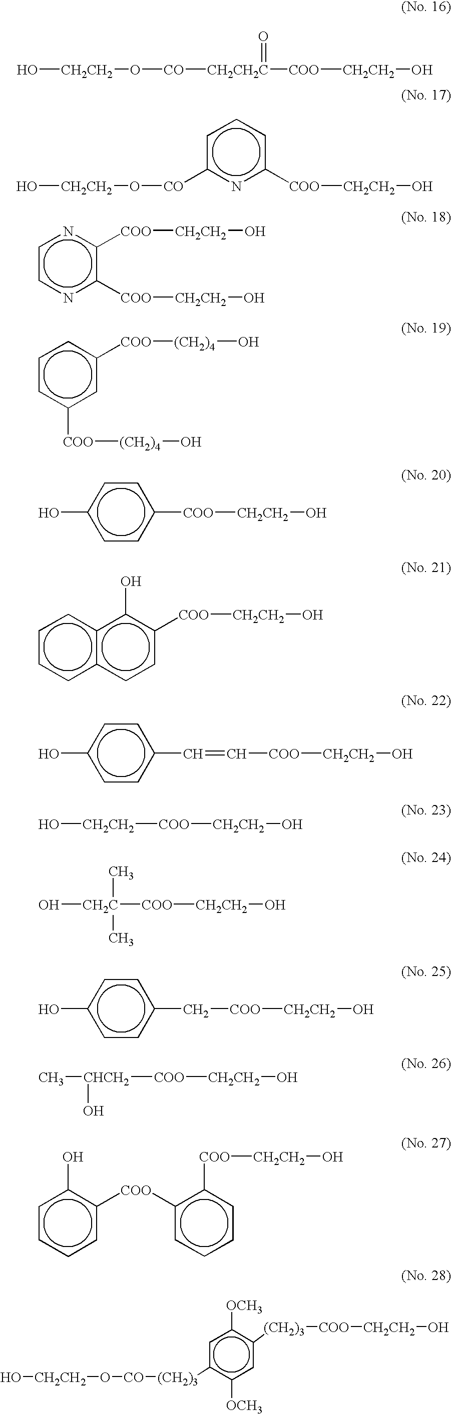

In addition, in the invention, a diol compound different from the compounds described above may be introduced in the main chain of ester resin in the range that does not impair the advantageous effects of the invention.

Typical examples thereof include ethylene glycol, diethylene glycol, triethylene glycol, tetraethylene glycol, propylene glycol, dipropylene glycol, polyethylene glycol, polypropylene glycol, neopentylglycol, 1,3-butylene glycol, 1,6-hexanediol, 2-butene-1,4-diol, 2,2,4-trimethyl-1,3-pentanediol, 1,4-bis-β-hydroxyethoxycyclohexane, cyclohexane dimethanol, tricyclodecane dimethanol, hydrogenated bisphenol A, hydrogenated bisphenol F, ethylene oxide adduct of bisphenol A, propylene oxide adduct of bisphenol A, ethylene oxide adduct of bisphenol F, propylene oxide adduct of bisphenol F, ethylene oxide adduct of hydrogenated bisphenol A, propylene oxide adduct of hydrogenated bisphenol A, hydroquinone dihydroxyethylester, p-xylylene glycol, dihydroxyethylsulfone, bis(2-hydroxyethyl)-2,4-tolylene dicarbamate, bis(2-hydroxyethyl)-m-xylylene dicarbamate, bis(2-hydroxyethyl) isophthalate, and the like.

The ester resin according to the invention can be prepared by dissolving the components above in an aprotic solvent, adding a known catalyst suitable for the reactivities of the raw materials, and condensation-polymerizing the mixture by heating.

The molar ratio of the total of at least one compound selected from the diol compounds represented by General Formulae (ii), (iii) and (iv) and the compounds represented by General Formulae (v) and/or (vi) to the diisocyanate compound represented by General Formula (i) is preferably 0.8:1 to 1.2:1, and if there are isocyanate groups remaining at the terminals of the polymer, the isocyanate groups are treated with an alcohol, amine, or the like, so that there is no isocyante group remaining on the polymer.

The amount of the compounds represented by General Formulae (v) and/or (vi) used in the diisocyanate compound represented by General Formula (i) is preferably 1 mole % or more and more preferably in the range of 5 to 50 mole %. Use of the compounds in an amount of 50 mole % or more may lead to deterioration in the solubility in organic solvent.

The weight-average molecular weight of the ester resin according to the invention is preferably 1,000 or more and still more preferably in the range of 3,000 to 200,000.

The ester resins according to the invention may be used alone or in combination.

[Amide Resin Prepared by Condensation Polymerization]

The amide resin prepared by condensation polymerization in the invention (hereinafter, referred to simply as amide resin) is not particularly limited if it is a resin having an amide bond in the polymer main chain that is soluble in water and an alkali solution and can exert the advantageous effects of the invention.

Examples of the amide resins according to the invention include polyacrylamide-based resins, poly(urethane-amide)-based resins, and the like, and poly(urethane-amide)-based resins are particularly preferable.

One of the methods for introducing an amide bond into the polymer main chain in the ester resin according to the invention is, for example, to react an isocyanate compound with a diol compound containing an alkali-soluble group in the structure and a diol compound containing an amide bond in the structure.

For example, the amide resin according to the invention is preferably a polymeric compound having a reaction product from a diisocyanate compound represented by the following General Formula (I), at least one compound selected from the diol compounds having a carboxy group represented by the following General Formulae (II), (III) and (IV), and at least one compound selected from the diol compounds represented by the following General Formulae (V) and (VI) as the main skeleton.

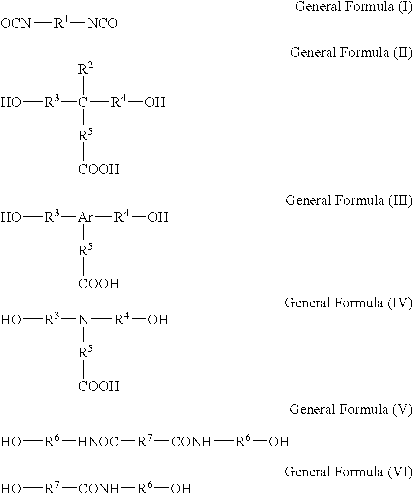

In General Formula (I), R¹ represents a bivalent connecting group. The connecting group is preferably an aliphatic hydrocarbon, an alicyclic hydrocarbon, or an aromatic hydrocarbon, and preferably, an alkylene group having 2 to 12 carbons or an arylene group having 6 to 20 carbons. The arylene group may contain two or more cyclic structures that are bound to each other via bivalent organic connecting groups such as single bond and methylene group or a fused polycyclic structure.

R¹ may contain as needed another functional group inert to the isocyanate group in Formula (b) such as an ester, urethane, and amide group.

In addition, R¹ may have a substituent, and preferable examples of the possible substituents include alkyl groups, aralkyl groups, aryl groups, alkoxy groups, halogen atoms (—F, —Cl, —Br, and —I), and the like.

In addition to the compounds represented by the General Formula (I) above, the diisocyanate compound used in the invention may also contain, for example, a high-molecular weight diisocyanate compound having isocyanate groups at both terminal of the polymeric compounds, such as an oligomer or polymer of the diol compound described below.

Typical examples of the diisocyanate compounds include the followings, but the invention is not limited thereto: aromatic diisocyanate compounds such as 2,4-tolylene diisocyanate, dimer of 2,4-tolylene diisocyanate, 2,6-tolylene diisocyanate, p-xylylene diisocyanate, m-xylylene diisocyanate, 4,4′-diphenylmethane diisocyanate, 1,5-naphthylene diisocyanate, and 3,3′-dimethylbiphenyl-4,4′-diisocyanate; aliphatic diisocyanate compounds such as hexamethylene diisocyanate, trimethylhexamethylene diisocyanate, lysine diisocyanate, and dimer acid diisocyanate; alicyclic diisocyanate compounds such as isophorone diisocyanate, 4,4′-methylene bis(cyclohexylisocyanate), methylcyclohexane-2,4 (or 2,6′) diisocyanate, and 1,3-(isocyanatomethyl)cyclohexane; diisocyanate compounds obtained by reaction of a diol and a diisocyanate, for example, an adduct from one mole of 1,3-butylene glycol and two moles of tolylene diisocyanate; and the like.

Among them, compounds having one or more aromatic rings such as 4,4′-diphenylmethane diisocyanate, xylylene diisocyanate, and tolylene diisocyanate are more preferable from the viewpoints of printing durability and chemical resistance.

In General Formula (II), R² represents a hydrogen atom, alkyl group, aralkyl group, aryl group, alkoxy group, or aryloxy group. R² may have a substituent, and examples of the possible substituents include cyano group, nitro group, halogen atoms (—F, —Cl, —Br, and —I), —CONH₂, —COOR⁸, —OR⁸, —NHCONHR⁸, —NHCOOR⁸, —NHCOR⁸, —OCONHR⁸, —CONHR⁸ (wherein, R⁸ represents an alkyl group having 1 to 10 carbons or an aralkyl group having 7 to 15 carbons), and the like.

Preferably, R² is a hydrogen atom, an unsubstituted alkyl group having 1 to 8 carbons, or an unsubstituted aryl group having 6 to 15 carbons.

In General Formula (II), (III) or (IV), R³, R⁴, and R⁵ each independently represent a single bond or a bivalent connecting group. The bivalent connecting groups include aliphatic hydrocarbons and aromatic hydrocarbons. R³, R⁴, and R⁵ may have a substituent, and examples of the possible substituents include alkyl groups, aralkyl groups, aryl groups, alkoxy groups, halogen atoms (—F, —Cl, —Br, and —I), and the like.

Preferably, R³, R⁴, and R⁵ each are an unsubstituted alkylene group having 1 to 20 carbons or an unsubstituted arylene group having 6 to 15 carbons, and more preferably an unsubstituted alkylene group having 1 to 8 carbons. R³, R⁴, and R⁵ each may have as needed another functional group inert to the isocyanate group in the General Formula (b) above such as an ester, urethane, amide, ureide, or ether group.

In addition, two or three of the groups R², R³, R⁴, and R⁵ may bind to each other, forming a cyclic structure.

In General Formula (III), Ar represents a trivalent aromatic hydrocarbon which may have one or more substituents and is preferably an arylene group having 6 to 15 carbons.

Typical examples of the diol compounds having a carboxyl group represented by General Formula (II), (III) or (IV) include the followings, but the invention is not limited thereto: 3,5-dihydroxybenzoic acid, 2,2-bis(hydroxymethyl)propionic acid, 2,2-bis(2-hydroxyethyl)propionic acid, 2,2-bis(3-hydroxypropyl)propionic acid, bis(hydroxymethyl)acetic acid, bis(4-hydroxyphenyl)acetic acid, 4,4-bis(4-hydroxyphenyl)pentane acid, tartaric acid, N,N-dihydroxyethylglycine, and the like.

Among them, 3,5-dihydroxybenzoic acid and 2,2-bis(hydroxymethyl)propionic acid are preferable from easiness in preparation.

In General Formula (V) or (VI), R⁶ and R⁷ each independently represent a bivalent connecting group, and may bind to each other, forming a cyclic structure. The bivalent connecting groups include aliphatic hydrocarbon, aromatic hydrocarbon, and heterocyclic moieties. R⁶ and R⁷ may have a substituent, and examples of the possible substituents include alkyl groups, aralkyl groups, aryl groups, alkoxy group, halogen atoms (—F, —Cl, —Br, and —I), and the like. R⁶ and R⁷ may contain as needed another functional group inert to the isocyanate group in Formula (b) such as a carbonyl group, ester group, urethane group, amide group, or ureide group.

R⁶ and R⁷ each are preferably an unsubstituted alkylene group having 1 to 20 carbons, an unsubstituted arylene group having 6 to 15 carbons, or a heterocyclic hydrocarbon group having 4 or more carbons. Further preferably, R⁶ and R⁷ each are an unsubstituted alkylene group having 1 to 8 carbons.

Typical examples of the compounds represented by General Formula (V) or (VI) (No.1 to No.28) are listed below but the invention is not limited thereto:

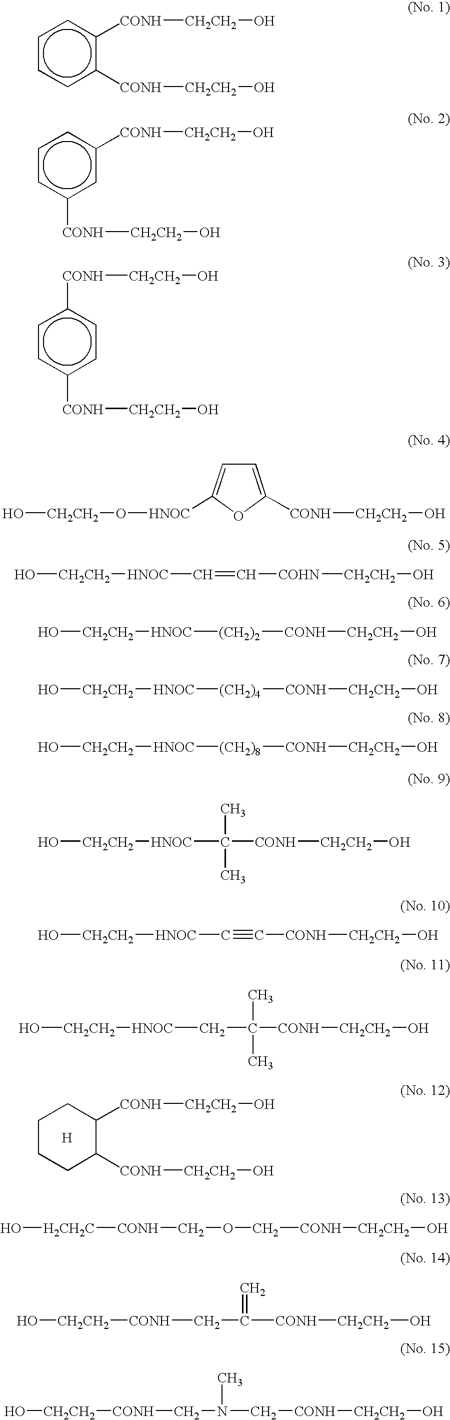

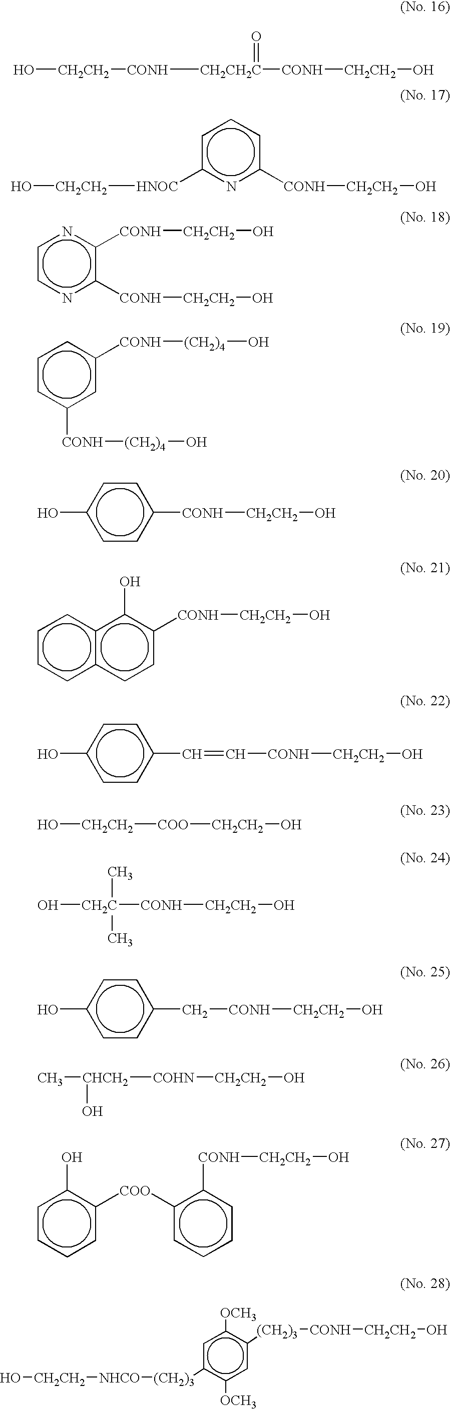

In addition, in the invention, another diol compound having no carboxy or ester group that is inert to isocyanate group may be added to the main chain of amide resin in the range that does not decrease the alkaline printing properties.

Specifice examples thereof include ethylene glycol, diethylene glycol, triethylene glycol, tetraethylene glycol, propylene glycol, dipropylene glycol, polyethylene glycol, polypropylene glycol, neopentylglycol, 1,3-butylene glycol, 1,6-hexanediol, 2-butene-1,4-diol, 2,2,4-trimethyl-1,3-pentanediol, 1,4-bis-β-hydroxyethoxycyclohexane, cyclohexane dimethanol, tricyclodecane dimethanol, hydrogenated bisphenol A, hydrogenated bisphenol F, ethylene oxide adduct of bisphenol A, propylene oxide adduct of bisphenol A, ethylene oxide adduct of bisphenol F, propylene oxide adduct of bisphenol F, ethylene oxide adduct of hydrogenated bisphenol A, propylene oxide adduct of hydrogenated bisphenol A, hydroquinone dihydroxyethylether, p-xylylene glycol, dihydroxyethylsulfone, bis(2-hydroxyethyl)-2,4-tolylene dicarbamate, 2,4-tolylene-bis(2-hydroxyethylcarbamide), bis(2-hydroxyethyl)-m-xylylene dicarbamate, and the like.

The amide resin according to the invention can be prepared by dissolving the components above in an aprotic solvent, adding a known catalyst suitable for the reactivities of the raw materials, and condensation-polymerizing the mixture by heating.

The molar ratio of the total of at least one compound selected from the diol compounds represented by General Formulae (II), (III) and (IV) and the compounds represented by General Formulae (V) and/or (VI) to the diisocyanate compound represented by General Formula (I) is preferably 0.8:1 to 1.2:1, and if there are isocyanate groups remaining at the terminals of the polymer, the isocyanate groups are treated with an alcohol, amine, or the like, so that there is no isocyante group remaining on the polymer.

Alternatively, the content of the compound represented by General Formulae (IV) and/or (VI) used in the diol compound represented by General Formula (1) is preferably 1 mole % or more and more preferably in the range of 5 to 70 mole %.

The weight-average molecular weight of the amide resin according to the invention is preferably 1,000 or more and still more preferably in the range of 5,000 to 200,000.

The amide resins according to the invention may be used alone or in combination.

[Imide Resin Prepared by Condensation Polymerization]

The imide resin prepared by condensation polymerization in the invention (hereinafter, referred to simply as imide resin) is not particularly limited if it is soluble in water and an alkali solution and can exert the advantageous effects of the invention. Examples of the imide resins favorably used in the invention include the followings:
(Pi-1) Resin obtained by heating and imidizing the condensate of 4,4′-diamino-4″-hydroxytriphenylmethane and 4,4′-hexafluoroisopropylidene diphthalic acid anhydride. 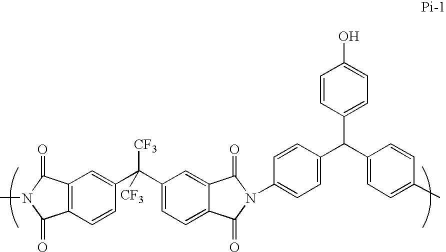
   (Pi-2)

Resin obtained by heating and imidizing the condensate of 2,3,3′,4′-biphenyltetracarboxylic acid anhydride and 3,3′-dihydroxybenzidine. 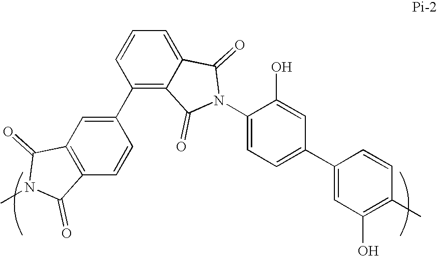
(Pi-3)

Resin obtained by heating and imidizing the condensate of pyromellitic acid anhydride and 3,3′-dihydroxybenzidine. 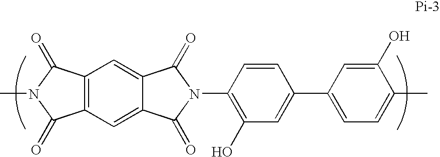
(Pi-4)

Resin obtained by heating and imidizing the condensate of pyromellitic acid anhydride and 2,2-bis(3-amino-4-hydroxyphenyl)hexafluoropropane. 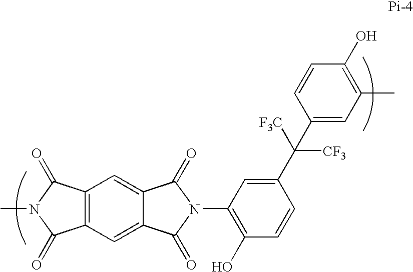
(Pi-5)

Resin obtained by heating and imidizing the condensate of 4,4′-hexafluoroisopropylidene diphthalic acid anhydride and 2,2-bis(3-amino-4-hydroxyphenyl)hexafluoropropane. 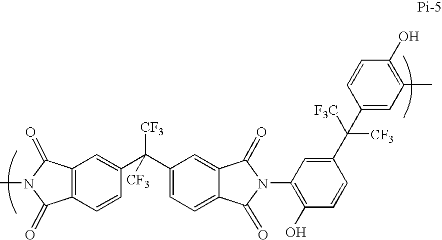
(Pi-6)

Resin obtained by heating and imidizing the condensate of 3,3′,4,4′-benzophenonetetracarboxylic acid dianhydride and 2,2-bis(3-amino-4-hydroxyphenyl)hexafluoropropane.

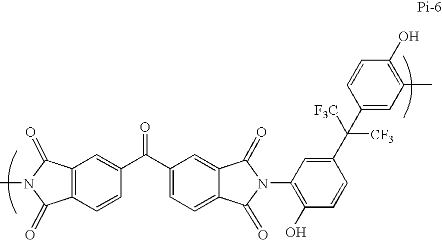

The weight-average molecular weight of the imide resin according to the invention is preferably 1,000 or more and still more preferably in the range of 5,000 to 200,000.

The imide resins according to the invention may be used alone or in combination.

[Resol Resin Prepared by Condensation Polymerization]

The resol resin prepared by condensation polymerization according to the invention (hereinafter, referred to simply as resol resin) is not particularly limited if it is soluble in water and an alkali solution and can exert the advantageous effects of the invention.

Examples of the resol resins according to the invention include compounds obtained by condensation polymerization of a phenol and an aldehyde under a basic condition. Preferable examples of the compounds include compounds obtained by condensation polymerization of a phenol and an aldehyde under a basic condition, compounds obtained from m-cresol and formaldehyde, compounds obtained from bisphenol A and formaldehyde, compounds obtained from 4,4′-bisphenol and formaldehyde, as well as the compounds disclosed as resol resins in U.K. Patent No. 2,082,339, and the like.

The content of the specific alkali-soluble compound in the photosensitive composition according to the invention is preferably in the range of 0.5 to 30% and more preferably in the range of 0.5 to 20% by weight with respect to the total solid matter in the photosensitive layer composition. A content of less than 0.5% by weight leads to a narrower development latitude, while a content of more than 30% by weight to deterioration in sensitivity and insufficient improvement in printing durability after post-heating treatment.

When a novolak resin (A) and an alkali-soluble resin (B) are used in combination as in the case for producing the photosensitive composition according to the invention, the content of the alkali-soluble resin (B) is preferably 40% by weight or less and more preferably 20% by weight or less, with respect to the novolak resin (A).

[Infrared Absorbing Agent (C)]

Infrared-absorbing dyes or pigments having an absorption maximum wavelength in the range of 760 nm to 1,200 nm are favorably used as the infrared absorbing agent (C) usable in the photosensitive composition according to the invention, from the viewpoint of compatibility with high-output lasers, i.e., readily available exposure-light sources.

The dyes may be commercially available ones and, for example, known ones described in publications such as “Dye Handbook” (edited by the Society of Synthesis Organic Chemistry, Japan, and published in 1970). Specific examples thereof include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squalirium dyes, pyrylium dyes, metal thiolate complexes, oxonol dyes, diimonium dyes, aminium dyes, and croconium dyes.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squalirium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentamethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squalirium dyes, pyrylium salts, thiopyrylium dyes, and nickel thiolate complexes. Dyes represented by the following general formulae (a) to (e) are also preferable since such dyes are excellent in terms of photothermal conversion efficiency. The cyanine dyes represented by the following general formula (S-1) are most preferable for the following reason: when the dyes are used in the photosensitive composition of the invention, the dyes manifest a high degree of interaction with the alkali-soluble resin, and the dyes are also excellent in terms of stability and economy.
General formula (S-1)

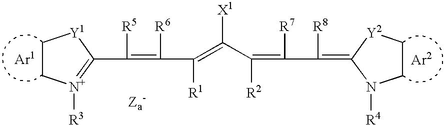

In general formula (S-1), X¹ represents a hydrogen atom, a halogen atom, —NPh₂, X²-L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following: 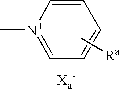
wherein Xa⁻ has the same definition as Za⁻, which will be described at a later time, and R^{a} represents a substituent selected from a hydrogen atom, an alkyl group, an aryl group, a substituted or unsubstituted amino group, or a halogen atom;

R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.

Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group. R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

Za⁻ represents a counter anion. However, in a case where the cyanine dye represented by general formula (S-1) has an anionic substituent in the structure thereof and there is accordingly no need to neutralize electric charges in the dye, Za⁻ is not required. From the viewpoint of the storage stability of the recording layer coating solution, Za⁻ is preferably an ion of a halogen, perchlorate, tetrafluroborate, hexafluorophosphate, carboxylate or sulfonate. From the viewpoints of compatibility of the dye with the alkali-soluble resin and solubility in the coating solution, Za⁻ is preferably a halogen ion, or an organic acid ion such as a carboxylic acid ion or sulfonic acid ion, more preferably a sulfonic acid ion, and even more preferably an arylsulfonic acid ion.

Specific examples of the cyanine dye represented by general formula (S-1), and which can be preferably used in the invention, include dyes in JP-A No. 2001-133969 (paragraphs [0017] to [0019]), JP-A No. 2002-40638 (paragraphs [0012] to [0038]), and JP-A No. 2002-23360 (paragraphs [0012] to [0023]), as well as dyes illustrated below.

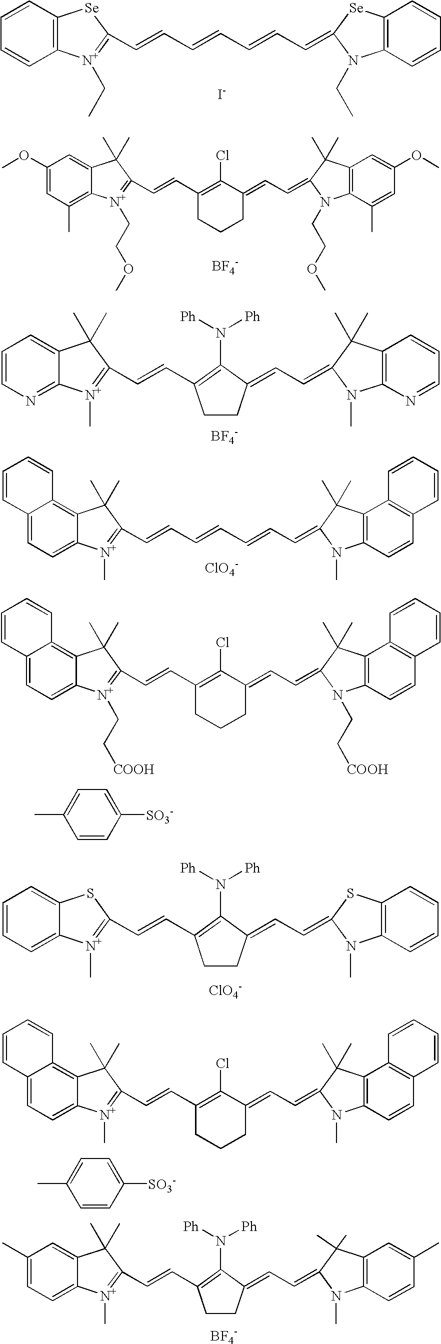

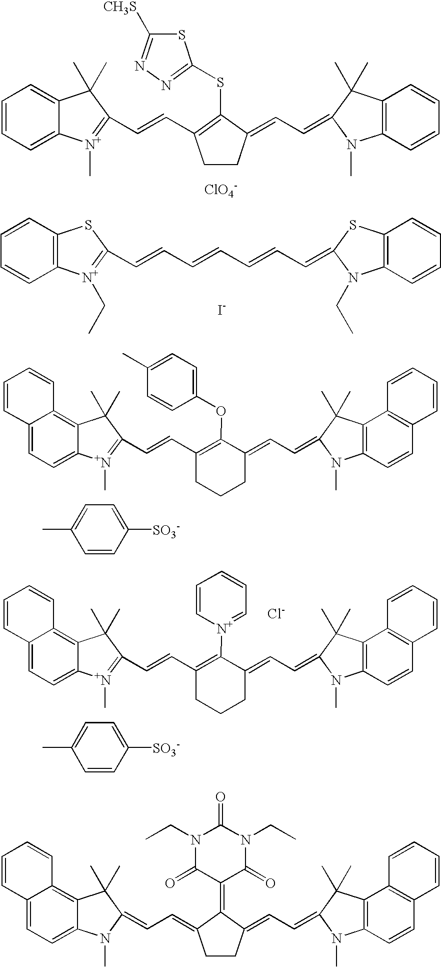

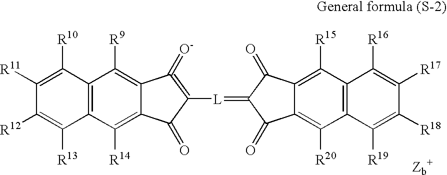

In general formula (S-2), L represents a methine chain having 7 or more conjugated carbon atoms, and the methine chain may have one or more substituent. The substituents may be bonded to each other to form a cyclic structure. Zb⁺ represents a counter cation. Preferable examples of the counter cation include ammonium, iodonium, sulfonium, phosphonium and pyridinium ions, and alkali metal cations (such as Ni⁺, K⁺ and Li⁺).

R⁹ to R¹⁴ and R¹⁵ to R²⁰ each independently represents a substituent selected from hydrogen atom, halogen atom, and cyano, alkyl, aryl, alkenyl, alkynyl, carbonyl, thio, sulfonyl, sulfinyl, oxy and amino groups; or a substituent obtained by combining two or three from among these substituents. Two or three out of R⁹ to R¹⁴ and R¹⁵ to R²⁰ may be bonded to each other to form a cyclic structure.

A dye wherein L in general formula (S-2) represents a methine chain having 7 conjugated carbon atoms, and each of R⁹ to R¹⁴ and R¹⁵ to R²⁰ represents a hydrogen atom, is preferable since such a dye can be easily obtained and exhibits advantageous effects.

Specific examples of the dye represented by general formula (S-2), and which can be preferably used in the invention, are illustrated below.

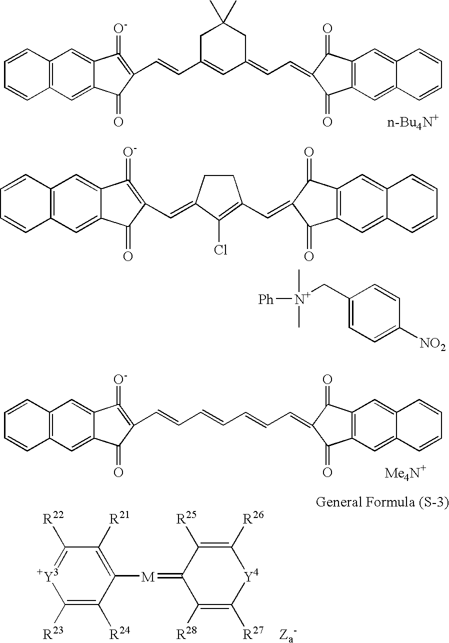

In general formula (S-3), Y³ and Y⁴ each independently represent an oxygen, sulfur, selenium or tellurium atom; M represents a methine chain having 5 or more conjugated carbon atoms; R²¹ to R²⁴ and R²⁵ to R²⁸, which may be the same or different, each represents a hydrogen or halogen atom, or a cyano, alkyl, aryl, alkenyl, alkynyl, carbonyl, thio, sulfonyl, sulfinyl, oxy or amino group; and Za⁻ represents a counter anion, and has the same meaning as Za⁻ in general formula (S-1).

Specific examples of the dye which is represented by general formula (S-3) and which can be preferably used in the invention, are illustrated below.

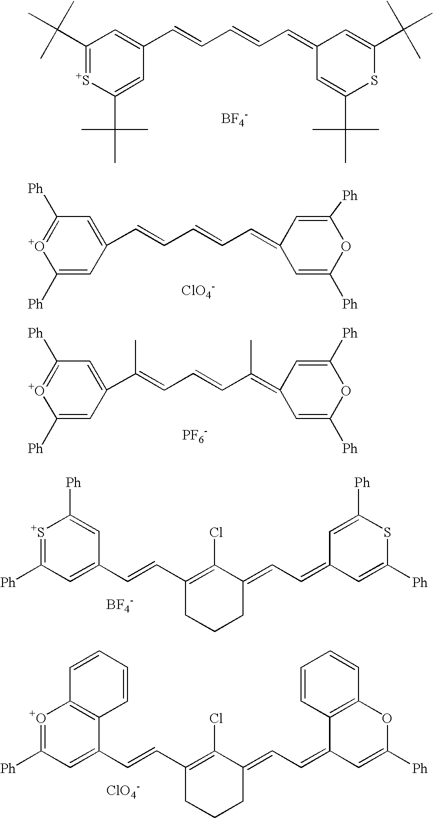

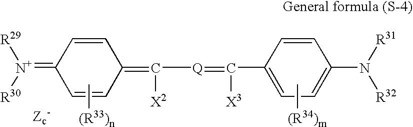

In general formula (S-4), R²⁹ to R³¹ each independently represents a hydrogen atom, an alkyl group or an aryl group; R³³ and R³⁴ each independently represents an alkyl group, a substituted oxy group, or a halogen atom; n and m each independently represents an integer of 0 to 4; and R²⁹ and R³⁰, or R³¹ and R³² may be bonded to each other to form a ring, or R²⁹ and/or R³⁰ may be bonded to R³³ to form a ring and R³¹ and/or R³² may be bonded to R³⁴ to form a ring. When plural R³³'s and R³⁴'s are present, R³³'s may be bonded to each other to form a ring, or R³⁴'s may be bonded to each other to form a ring.

X² and X³ each independently represents a hydrogen atom, an alkyl group or an aryl group, and at least one of X² and X³ represents a hydrogen atom or an alkyl group.

Q represents a trimethine group or a pentamethine group which may have a substituent, and may be combined with an bivalent linking group to form a cyclic structure. Zc⁻ represents a counter anion and has the same meanings as Za⁻ in general formula (S-1).

Specific examples of the dye represented by general formula (S-4) and which can be preferably used in the invention, are illustrated below. 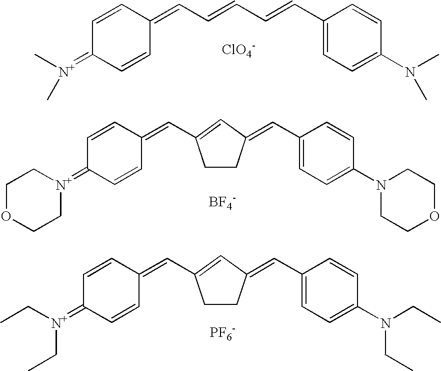
General formula (S-5)

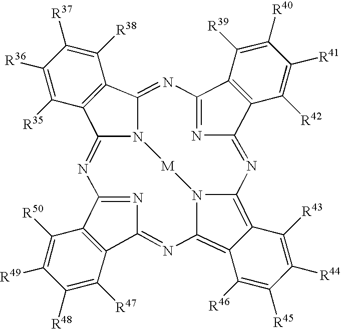

In general formula (S-5), R³⁵ to R⁵⁰ each independently represents a hydrogen or halogen atom, or a cyano, alkyl, aryl, alkenyl, alkynyl, hydroxyl, carbonyl, thio, sulfonyl, sulfinyl, oxy or amino group, or an onium salt structure, each of which may have a substituent; M represents two hydrogen atoms, a metal atom, a halo metal group, or an oxy metal group. Examples of the metal contained therein include atoms in IA, IIA, IIIB and IVB groups in the periodic table, transition metals in the first, second and third periods therein, and lanthanoid elements. Among these examples, preferable are copper, magnesium, iron, zinc, cobalt, aluminum, titanium, and vanadium.

Specific examples of the dye represented by general formula (S-5) and which can be preferably used in the invention, are illustrated below.

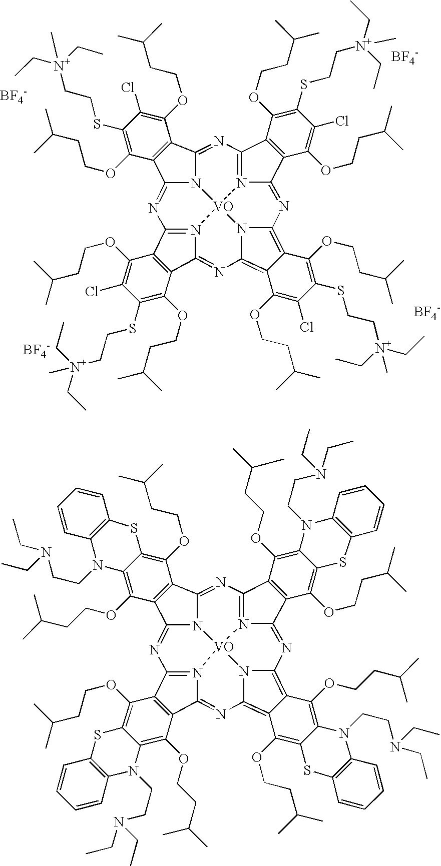

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Technique” (by CMC Publishing Co., Ltd. in 1986.

The particle size of the pigment is preferably from 0.01 to 10 μm, more preferably from 0.05 to 1 μm, and even more preferably from 0.1 to 1 μm. When a particle size is within the preferable range, a superior dispersion stability of the pigment in the photosensitive composition can be obtained, whereby, when the photosensitive composition of the invention is used for a recording layer of the photosensitive printing plate precursor, it is possible to form a homogeneous recording layer.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

From the viewpoints of sensitivity, uniformity of the film to be formed and durability, the pigment or dye can be added to the photosensitive composition in a ratio of 0.01 to 50%, preferably 0.1 to 10%, and more preferably 0.5 to 10% (in the case of the dye) or 0.1 to 10% (in the case of pigment) by mass, relative to the total solid contents which constitute the photosensitive composition.

[Sulfonium Salt (D)]

The photosensitive composition according to the invention contains a sulfonium salt (D).

The sulfonium salts for use in the invention include the sulfonium salts represented by the following General Formula (x).

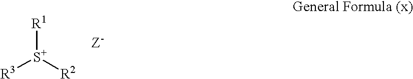

In General Formula (x), R¹ , R² and R³ each independently represent a hydrocarbon group having 20 or fewer carbons which may have one or more substituents. Preferable substituents include halogen atoms, nitro group, alkyl groups having 12 or fewer carbons, alkoxy groups having 12 or fewer carbons, and aryloxy groups having 12 or fewer carbons.

Z⁻ represents a strong acid residue. Specific examples thereof include halide ions, perchlorate ion, hexafluorophosphate ion, tetrafluoroborate ion, sulfonate ion, sulfinate ion, thiosulfonate ion, and sulfate ion; and perchlorate ion, hexafluorophosphate ion, tetrafluoroborate ion, sulfonate ion, and sulfinate ion are preferable from the viewpoint of stability.

Examples of the sulfonium salt preferably used in the invention include compounds having a triarylsulfonium salt structure. Further, an example of the preferably usable sulfonium salt is a compound in which a sum of Hammett values (Hammett substituent constant σ) of substituents bonded to aryl skeletons is greater then 0.46 (which compound will occasionally be referred to as “a specific sulfonium salt” hereinafter), and particularly is a compound that has a cation structure of an onium salt, in which a sum of Hammett values of substituents bonded to aryl skeletons is greater then 0.46. The specific sulfonium salt is preferable in view points of providing stability of the non-image areas due to its main skeleton, and providing good removal property of the exposed regions (the good removal property is provided because decomposability of the sulfonium salt by exposure is enhanced by acceleration of thermal decomposition or lowering of potential), thereby achieving effective suppression of staining.

—Triarylsulfonium Salt Structure—

Compounds having a triarylsulfonium salt structure are known, for example, as polymerization initiators, and can be easily synthesized according to methods described, for example, in: J. Amer. Chem. Soc. Vol. 112 (16), 1990, pp. 6004-6015; J. Org. Chem., 1988, pp. 5571-5573; WO 02/081439A1; and EP 1113005.

—Substituent Bonded to Aryl Skeleton—

As the substituents bonded to the aryl skeletons of the triarylsulfonium salt structure of the specific compound, an electron attracting substituent is preferable. The sum of Hammett values of the electron attracting substituents bonded to the three aryl skeletons needs to be greater than 0.46, and preferably is greater than 0.60. If the sum of Hammett values is 0.46 or less, a sufficient anti-scumming property cannot be provided.

The Hammett value represents a degree of an electron attracting property of a cation having a triarylsulfonium salt structure, and there is no upper limit specified in view of provision of high sensitivity. However, in view of reactivity and stability, the Hammett value is preferably greater than 0.46 and less than 4.0, more preferably is greater than 0.50 and less than 3.5, and particularly preferably is greater than 0.60 and less than 3.0.

It should be noted that, as the Hammett values in this invention, values described in “Chemistry Seminar 10 Hammett Rule—Structure and Reactivity—” (edited by Naoki Inamoto, published by Maruzen, 1983) are used.

Examples of the electron attracting substituent introduced in the aryl skeleton include a trifluoromethyl group, a halogen atom, an ester group, a sulfoxide group, a cyano group, an amide group, a carboxyl group and a carbonyl group. Hammett values of these substituents are as follows: trifluoromethyl group (—CF₃, m: 0.43, p: 0.54); halogen atom [for example, —F (m:0.34, p:0.06), —Cl (m:0.37, p: 0.23), —Br (m:0.39, p:0.23), —I (m:0.35, p:0.18)]; ester group (for example, —COCH₃, o:0.37, p: 0.45); sulfoxide group (for example, —SOCH₃, m: 0.52, p: 0.45); cyano group (—CN, m: 0.56, p: 0.66), amide group (for example, —NHCOCH₃, m: 0.21, p: 0.00); carboxyl group (—COOH, m: 0.37, p: 0.45); carbonyl group (—CHO, m: 0.36, p:(0.43)). The descriptions contained in the parentheses represent positions for introducing the substituents into the aryl skeleton and Hammett values thereof, and “(m: 0.50)”, for example, represents that the Hammett value of the relevant substituent introduced in the meta-position is 0.50.

Among these substituents, nonionic substituents such as a halogen atom and an alkyl halide group are preferable in view of hydrophobicity. Among nonionic substituents, —Cl is preferable in view of reactivity, and —F, —CF₃, —Cl and —Br are preferable in view of providing hydrophobicity to the film.

These substituents may be introduced in any one of three aryl skeletons in the triarylsulfonium salt structure, or may be introduced into two or more aryl skeletons thereof. Further, one or plural substituents may be introduced into the individual three aryl skeletons. Positions for substitution and the number of substituents are not particularly specified as long as the sum of the Hammett values of the substituents introduced into the aryl skeletons is greater than 0.46. For example, one substituent having a particularly large Hammett value (a Hammett value exceeding 0.46 on its own) may be introduced into one of the aryl skeletons of the triarylsulfonium salt structure, or alternatively, plural substituents may be introduced so that the sum of the Hammett values thereof exceeds 0.46.

As described above, the Hammett values of the substituents vary depending on positions where they are introduced, and therefore, the sum of the Hammett values of the triarylsulfonium salt initiator will be determined according to the types of substituents, positions for introduction and the number of introduced substituents.

It should be noted that a Hammett side is usually represented by m-position, p-position, however, in the invention, as an indication of the electron attracting property, an effect of a substituent at o-position is considered as the same as that at p-position in calculation.

Among the specific sulfonium salts, a sulfonium salt substituted at three positions by chloro groups is most preferable, and specifically, a sulfonium salt having a triarylsulfonium salt structure where —Cl is introduced into each of three aryl skeletons is preferable.

Examples of a counter anion of the sulfonium salt preferably usable, in view of stability, in the invention include sulfonic acid anion, benzoylformic acid anion, PF₆⁻, BF₄⁻, ClO₄⁻, carboxylic acid anion, sulfinic acid anion, sulfuric acid anion, borate anion, halogen anion, phosphoric acid anion, phosphonic acid anion, phosphinic acid anion, active imide anion, polymeric sulfonic acid anion and polymeric carboxylic acid anion. It should be noted that a hydrophilicity/hydrophobicity parameter log P of the counter anion is preferably less than 2, in view point of effective suppression of scumming in the non-image areas, which is achieved by the recording layer being quickly removed and dispersed in a developing solution to expose a hydrophilic surface of a support with no residual film remaining thereon. More preferably, a value of log P is in a range from −1 to 1 in view of alkali developability and a film forming property.

Here, log P of the anion refers to log P of the log P of an acidic compound when the anion exists in the form of the acidic compound. In the invention, the hydrophilicity/hydrophobicity parameter log P of the anion moiety means a common logarithm of a partition coefficient P of the acidic compound including the anion moiety, and is a physical property value representing, as a quantitative value, how a certain organic compound is distributed at equilibrium in a two-phase system containing an oil (typically, 1-octanol) and water, which can be found by the following equation:
log P=log(Coil/Cwater),
where Coil represents a mol concentration in oil phase and Cwater represents a mol concentration in water phase. A larger absolute value of log P in a positive direction from 0 represents a greater solubility in oil, whereas a larger absolute value of log P in a negative direction from 0 represents a greater solubility in water. There is a negative correlation between this value and a water-solubility of an organic compound, and this value is widely used as a parameter for estimating hydrophilicity/hydrophobicity of a compound. In principle, log P values are empirically measured in a distribution experiment. However, since this experiment is complicated, log P values value are usually obtained using an on-line database containing actual measurement values or calculation software for estimating log P values from structural formulae. The invention uses values calculated by using a log P value estimating program: CLOGP, developed by MedChem Project by C. Hansch, A. Leo, et al. from Pomona College, U.S.A. and Biobyte Corporation (CLOGP program: algorithm=4.01, fragment database=17, incorporated into a system: PCModels (ver. 1.02) provided by Daylight Chemical Information Systems, Inc.).

It should be noted that the most preferable aspect of the sulfonium salt used in the invention includes compounds having the above-described cation structure and the anion structure where the hydrophilicity/hydrophobicity parameter log P is less than 2.

In the invention, typical examples of the favorable sulfonium salts represented by General Formula (x) [exemplary compounds (1) to (101)] are listed below, but the invention is not restricted thereto:

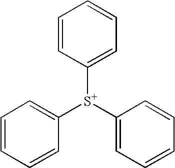

σ = 0.00

| | | |
|---|---|---|
| (1) | HOSO₃⁻ | −2.174 |
| (2) | CH₃SO₃⁻ | −1.224 |
| (3) | C₄H₉SO₃⁻ | 0.363 |
| (4) | C₁₄H₂₉SO₃^{—} | 4.453 |
| (5) | CH₂ClCOO⁻ | 0.081 |
| (6) | CF₃SO₃⁻ | 0.885 |
| (7) | C₈F₁₇SO₃⁻ | 2.275 |
| (8) | 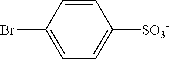 | 0.218 |
| (9) | 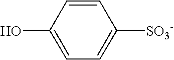 | −1.312 |
| (10) | 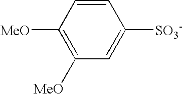 | −0.987 |
| (11) | 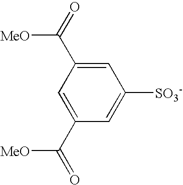 | −0.707 |
| (12) | 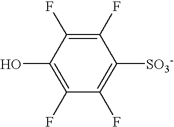 | −0.760 |
| (13) | 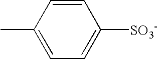 | −0.146 |
| (14) | 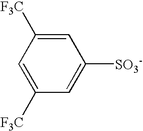 | 1.121 |
| (15) | 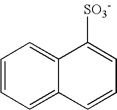 | 0.529 |
| (16) | 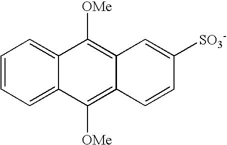 | 1.711 |
| (17) | 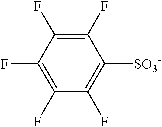 | −0.140 |
| (18) | 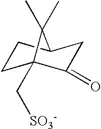 | 0.636 |
| (19) | H₂N—SO₃⁻ | −2.358 |
| (20) | 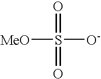 | −1.298 |
| (21) | 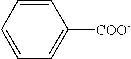 | 1.885 |
| (22) | 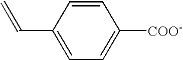 | 2.609 |
| (23) | 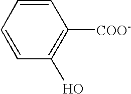 | 2.187 |
| (24) | 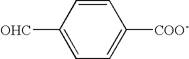 | 2.609 |
| (25) | 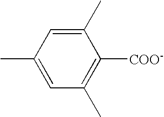 | 2.782 |
| (26) | 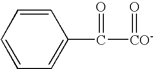 | 1.225 |
| (27) | 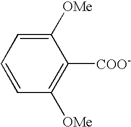 | 1.155 |
| (28) | 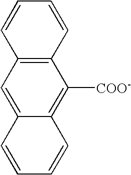 | 4.233 |
| (29) | 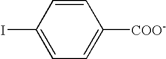 | 3.106 |
| (30) | 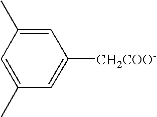 | 2.412 |
| (31) | 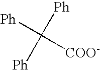 | 4.200 |
| (32) | 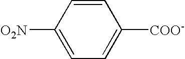 | 1.838 |
| (33) | CF₃COO⁻ | 0.365 |
| (34) | 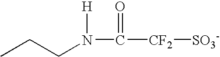 | −0.303 |
| (35) | HCOO⁻ | −0.540 |
| (36) | CH₃COO⁻ | −0.194 |
| (37) | 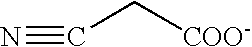 | −0.828 |
| (38) | 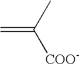 | 0.660 |
| (39) | 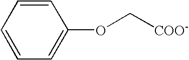 | 1.350 |
| (40) | 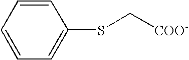 | 1.884 |
| (41) | 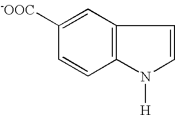 | 2.067 |
| (42) | 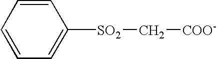 | 0.445 |
| (43) | 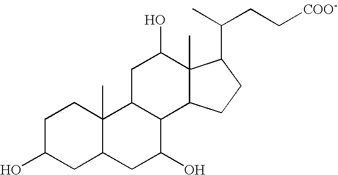 | 2.427 |
| (44) | 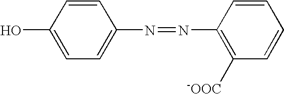 | 3.776 |
| (45) | 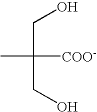 | −0.646 |
| (46) | 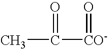 | −0.194 |
| (47) | 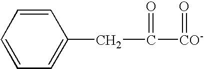 | 0.524 |
| (48) | 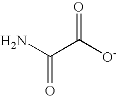 | −2.787 |
| (49) | 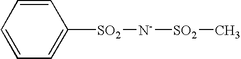 | −1.389 |
| (50) | 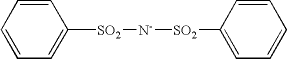 | 0.520 |
| (51) | 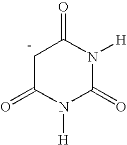 | −1.441 |
| (52) | 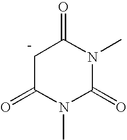 | −0.779 |
| (53) | 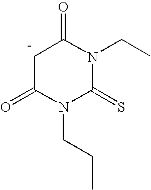 | 0.802 |
| (54) | 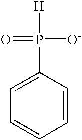 | −0.723 |
| (55) | 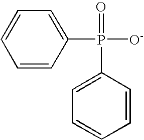 | 1.115 |
| (56) | 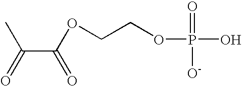 | −0.927 |
| (57) | ClO₄⁻ | |
| (58) | BF₄⁻ | |
| (59) | PF₆⁻ | |
| (60) | AsF₆⁻ | |
| (61) | SbF₆⁻ | |
| (62) | 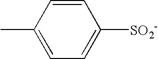 | 0.205 |
| (63) | 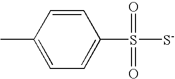 | 1.598 |
| (64) | 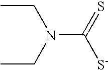 | 0.590 |
| (65) | 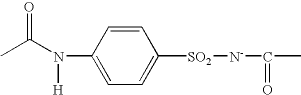 | −0.750 |

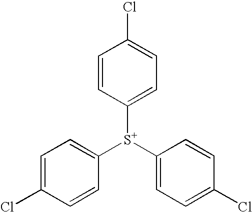

0.69

| | | |
|---|---|---|
| (66) | 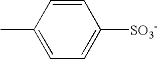 | −0.146 |
| (67) | 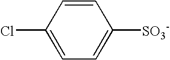 | 0.068 |
| (68) | 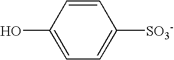 | −1.312 |
| (69) | 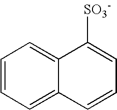 | 0.529 |
| (70) | 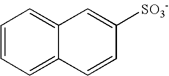 | 0.529 |
| (71) | 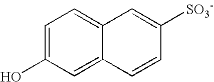 | −0.138 |
| (72) | 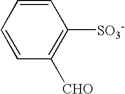 | −1.292 |
| (73) | 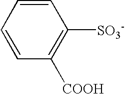 | −0.902 |
| (74) | 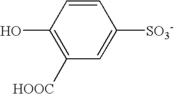 | −0.600 |
| (75) | 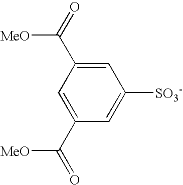 | −0.707 |
| (76) | 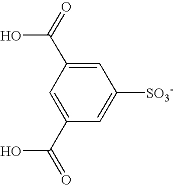 | −0.935 |
| (77) | 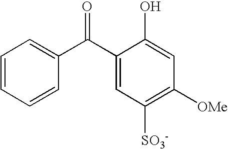 | 0.799 |
| (78) | 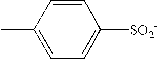 | 0.205 |
| (79) | 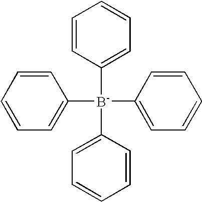 | |
| (80) | PF₆⁻ | |
| (81) | Br⁻ | |
| (82) | I⁻ | |
| (83) | 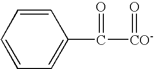 | 1.225 |

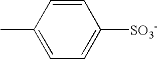

log P.
−0.146

| | | |
|---|---|---|
| (84) | 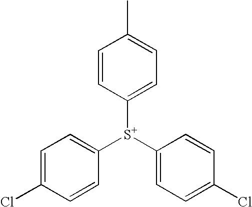 | 0.29 |
| (85) | 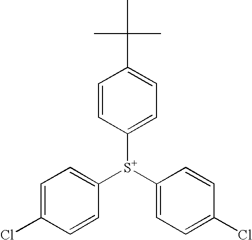 | 0.26 |
| (86) | 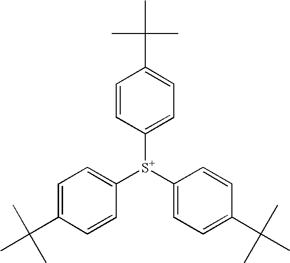 | −0.59 |
| (87) | 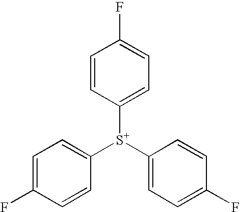 | 0.186 |
| (88) | 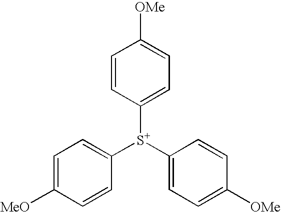 | −0.804 |
| (89) | 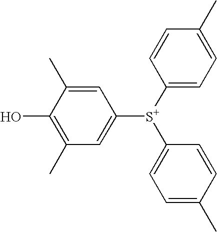 | −0.848 |
| (90) | 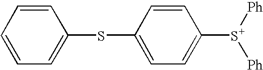 | |
| (91) | 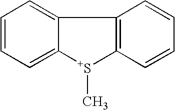 | |
| (92) | 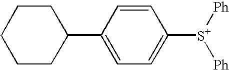 | |
| (93) | 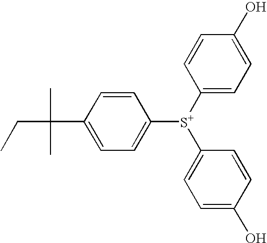 | |
| (94) | 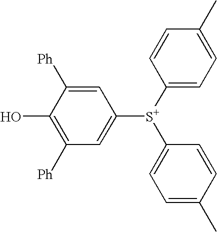 | |
| (95) | 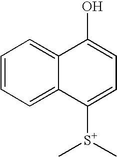 | |
| (96) | 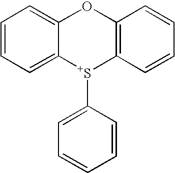 | |
| (97) | 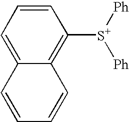 | |
| (98) | 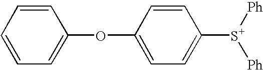 | |
| (99) | 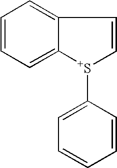 | |
| (100) | 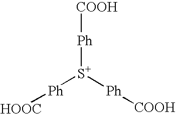 | |
| | (*COOH at p-position) | |
| (101) | 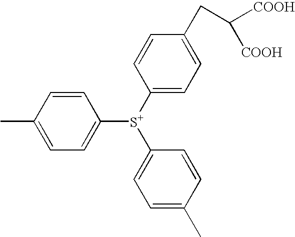 | |

The sulfonium salt (D) for use in the invention preferably has a maximum absorption wavelength of 400 nm or less and more preferably 360 nm or less. By bringing the absorption maximum wavelength into the ultraviolet region in this manner, it becomes possible to handle the photosensitive composition under white light.

The sulfonium salts (D) according to the invention may be used alone or in combination of two or more. When the photosensitive composition according to the invention is applied to a recording layer of planographic printing plate precursor, these sulfonium salts (D) may be added into the same layer together with other components or into another layer separately therefrom.

The sulfonium salts (D) favorably used in the invention include those containing a sulfonate or carboxylate anion as the counter anion.

The sulfonium salt (D) according to the invention may be added in an amount of 0.1 to 50% by weight, preferably 0.5 to 40% by weight, and particularly preferably 1 to 30% by weight with respect to the total solid matter in photosensitive composition from the viewpoints of sensitivity and elimination of interaction.

[Other Components]

Besides the essential components above, the photosensitive composition according to the invention may further contain other components as needed. Examples thereof include thermal degradable compounds such as onium salts, o-quinone diazide compounds, aromatic sulfone compounds, aromatic sulfonic ester compounds, and the like, and combined use of a material (thermally decomposable solubilization inhibitor) that practically reduces the solubility of alkali-soluble resin when not decomposed, is preferable for further reducing the solubilization thereof in the image region into the developer.

[Onium Salt]

Examples of the onium salts which are used as the other component in the photosensitive composition according to the invention include diazonium salts, ammonium salts, phosphonium salts, iodonium salts, selenonium salts, arsonium salts, and the like.

Preferable examples of the onium salt used in the invention include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al., Macromolecules, 17, 2468 (1984), C. S. Wen et al., Teh, Proc. Conf. Rad. Curing ASIA, p478 Tokyo, October (1988), and U.S. Pat. Nos. 4,069,055 and 4,069,056; iodonium salts described in J. V. Crivello et al., Macromolecules, 10 (6), 1307 (1977), Chem. & Eng. News, Nov. 28, p31 (1988), EP No. 104,143, U.S. Pat. Nos. 5,041,358 and 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 5,041,358, 4,491,628, 4,760,013, 4,734,444 and 2,833,827, and DE Patent Nos. 2,904,626, 3,604,580 and 3,604,581; selenonium salts described in J. V. Crivello et al., Macromolecules, 10 (6), 1307 (1977), J. V Crivello et al., J. Polymer Sci., Polymer Chem. Ed., 17, 1047 (1979); arsonium salts described in C. S. Wen et al., and The Proc. Conf. Rad. Curing ASIA, p478, Tokyo, October (1988).

Among such onium salts, diazonium salts are particularly preferable. The diazonium salts disclosed in the JP-A No. 5-158230 are the most preferable.

Examples of the counter ion of the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among these examples, hexafluorophosphoric acid, and alkylaromatic sulfonic acids such as triisopropylnaphthalenesulfonic acid and 2,5-dimethylbezenesulfonic acid are particularly preferable.

The amount of the onium salt added is preferably in the range of 0.1 to 10%, still more preferably 0.1 to 5%, and particularly preferably 0.1 to 2% by weight with respect to the total solid matter in the image-recording layer.

These onium salts may be used alone or as a mixture of several salts.

[o-Quinone Diazide Compound]

o-Quinone diazide compound for use in the photosensitive composition according to the invention is, for example, a compound having at least one o-quinone diazide group that becomes more alkali soluble by thermal decomposition, and such compounds in various structures may be used. Namely, o-quinone diazide makes the photosensitive composition more soluble by thermal decomposition, both by reducing the solubilization-inhibiting potential of novolak resin (A) and specific alkali-soluble resin (B) and converting itself to an alkali-soluble material. Examples of the o-quinone diazide compounds for use in the invention include the compounds described on pp. 339 to 352 of “Light Sensitive Systems” (J. Corsair Ed., John Wiley & Sons. Inc.), and in particular, sulfonic esters or sulfonic acid amides of the o-quinone diazides, which are prepared in reaction with various aromatic polyhydroxy compounds or aromatic amino compounds, are favorable. In addition, the esters from benzoquinone-(1,2)-diazido-sulfonylchloride or naphthoquinone-(1,2)-diazido-5-sulfonylchloride and a pyrogallol-acetone resin described in JP-B No. 43-28403, and the esters from benzoquinone-(1,2)-diazido-sulfonylchloride or naphthoquinone-(1,2)-diazido-5-sulfonylchloride and a phenol-formaldehyde resin described in U.S. Pat. Nos. 3,046,120 and 3,188,210 are also favorably used.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803,48-96575, 49-38701 and 48-13354, JP-B No. 41-11222,45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Patent No. 854,890.

The amount of the o-quinone diazide compound added is preferably in the range of 0 to 10%, still more preferably 0 to 5%, and particularly preferably 0 to 2% by weight with respect to the total solid matter in photosensitive composition.

These o-quinone diazide compounds may be used alone or as a mixture of several compounds.

The amount of the thermally decomposable solubilization inhibitors excluding the onium salt and o-quinone diazide compound above is preferably 0 to 5%, still more preferably 0 to 2, and particularly preferably 0.1 to 1.5% by weight with respect to the total solid matters in photosensitive composition.

[Other Additives]

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No.60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to a recording layer of a planographic printing plate precursor, the ratio thereof in the recording layer is preferably from 0.05 to 20%, more preferably from 0.1 to 15%, and even more preferably from 0.1 to 10% by mass.

When the photosensitive composition according to the invention is used in a recording layer coating solution for a planographic printing plate precursor, in order to enhance stability in processes which affect conditions of developing, the following can be added: nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 11-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the photosensitive composition is preferably from 0.05 to 15% by mass, and more preferably from 0.1 to 5% by mass.

To the photosensitive composition of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

As the image coloring agent, a dye different from the above-mentioned salt-formable organic dye may be used. Preferable examples of such a dye, and of the salt-formable organic dye, include oil-soluble dyes and basic dyes.

Specific examples thereof include Oil yellow #101, Oil Yellow #103, Oil Pink #312, Oil Green BG, Oil Blue BOS, Oil Blue #603, Oil Black BY, Oil Black BS, and Oil Black T-505 (each of which is manufactured by Orient Chemical Industries Ltd.); Victoria Pure Blue, Crystal Violet (CI42555), Methyl Violet (CI42535), Ethyl Violet, Rhodamine B (CI 45170B), Malachite Green (CI42000), and Methylene Blue (CI52015).

Dyes described in JP-A No.62-293247 are particularly preferable. These dyes may be added to the photosensitive composition at a ratio of 0.01 to 10% by mass, and preferably 0.1 to 3% by mass, relative to the total solid contents therein.

Whenever necessary, a plasticizer may be added to the photosensitive composition of the invention to give flexibility to a coating film made from the composition. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

In addition to the above, the following may be appropriately added to the composition, depending on the objective: an epoxy compound; a vinyl ether; a phenol compound having a hydroxymethyl group and a phenol compound having an alkoxymethyl group, described in JP-A No. 8-276558; and a cross-linkable compound having an effect of suppressing dissolution in an alkali, described in JP-A No. 11-160860, and which was previously proposed by the present inventors.

The photosensitive composition according to the invention can be applied to various recording materials in various applications such as planographic printing plate precursor, color-proof materials, and display material, by dissolving the respective components in a suitable solvent and applying the solution onto a support. In particular, it is useful as a heat mode-compatible positive-type planographic printing plate precursor that allows direct plate making by infrared laser exposure.

[Planographic Printing Plate Precursor]

Hereinafter, specific embodiments of the invention will be described, by taking application of the photosensitive composition to a recording layer of planographic printing plate precursor as an example. The planographic printing plate precursor has a support and a recording layer formed thereon, and may have additionally an undercoat layer, resin intermediate layer, backcoat layer, or the like according to applications. In the same way, the planographic printing plate precursor can be formed on by mounting the photosensitive composition on the support.

[Recording Layer]

A recording layer from the photosensitive composition according to the invention is formed by dissolving the components for the recording layer (the photosensitive composition according to the invention) in a solvent, thus forming a coating solution for recording layer, and applying the solution onto a suitable support. Other layers, including undercoat layer, resin intermediate layer, backcoat layer, and the like, can also be formed similarly.

Examples of the solvent in this case include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetoamide, N,N-dimethylformamide, tetramethylurea, N-methylpyrrolidone, dimethylsulfoxide, sulfolane, γ-butyrolactone, and toluene. However, the solvent is not limited thereto. Moreover, these solvents may be used alone, or in a mixture form.

The concentration of the components for recording layer in the solvent (all solid matters including additives) is preferably 1 to 50% by weight.

In addition, a surfactant for improvement in coating property, for example, one of the fluorochemical surfactants described in JP-A No. 62-170950, may be added to the coating solution for recording layer. The preferable addition amount is 0.01 to 1% and still more preferably 0.05 to 0.5% by weight with respect to the total solid matters.

Various coating methods, for example, including bar coater coating, spin coating, spray coating, curtain coating, dip coating, air knife coating, blade coating, roll coating, and the like, may be used as the coating method.

The amount of the coat on the support obtained after application and drying (solid matter) may vary according to applications, but is generally, preferably 0.5 to 5.0 g/m² in the case of the recording layer for planographic printing plate precursors. Decrease in the coating amount leads to apparent increase in sensitivity but also to deterioration in the film properties of image-forming layer.

The recording layer may be a single layer or a layer in the multilayer structure.

[Support]

The support used in the planographic printing plate precursor is a plate having dimensional stability. A plate satisfying required physical properties such as strength and flexibility can be used without any restriction. Examples thereof include paper, plastic (such as polyethylene, polypropylene or polystyrene)-laminated papers, metal plates (such as aluminum, zinc and copper plates), plastic films (such as cellulose biacetate, cellulose triacetate, cellulose propionate, cellulose lactate, cellulose acetate lactate, cellulose nitrate, polyethylene terephthalate, polyethylene, polystyrene, polypropylene, polycarbonate, and polyvinyl acetate films), and papers or plastic films on which, as described above, a metal is laminated or vapor-deposited.

The support is preferably a polyester film or an aluminum plate, and more preferably an aluminum plate, since an aluminum plate is superior in terms of dimensional stability and is also relatively inexpensive.

Preferable examples of the aluminum plate include a pure aluminum plate and alloy plates made of aluminum as a main component with a very small amount of other elements. A plastic film on which aluminum is laminated or vapor-deposited may also be used.

Examples of other elements contained in the aluminum alloys include silicon, iron, manganese, copper, magnesium, chromium, zinc, bismuth, nickel, and titanium. The content by percentage of different elements in the alloy is at most 10% by mass. A particularly preferable aluminum plate in the invention is a pure aluminum plate; however, since from the viewpoint of refining a completely pure aluminum cannot be easily produced, a very small amount of other elements may also be contained in the plate.

The aluminum plate used as the support is not specified in terms of the composition thereof. Thus, aluminum plates which are conventionally known can be appropriately used. The thickness of the aluminum plate used in the invention is from about 0.1 to 0.6 mm, preferably from 0.15 to 0.4 mm, and more preferably from 0.2 to 0.3 mm.

If necessary, prior to the surface-roughening treatment, the aluminum plate may optionally be subjected to degreasing treatment, in order to remove rolling oil or the like on the surface, with a surfactant, an organic solvent, an aqueous alkaline solution or the like.

The surface-roughening treatment of the aluminum surface can be performed by various methods such as a mechanical surface-roughening method, a method of dissolving and roughening the surface electrochemically, and a method of dissolving the surface selectively in a chemical manner.

Mechanical surface-roughening methods which can be used may be known methods, such as a ball polishing method, a brush polishing method, a blast polishing method or a buff polishing method. An electrochemical surface-roughening method may be a method of performing surface-roughening in an electrolyte of hydrochloric acid or nitric acid, by use of an alternating current or a direct current. As disclosed in JP-A No. 54-63902, a combination of the two kinds of methods may be used.

An aluminum plate whose surface is roughened as described above is if necessary subjected to alkali-etching treatment and neutralizing treatment. Thereafter, an anodizing treatment is optionally applied in order to improve the water holding capacity and wear resistance of the surface.

The electrolyte used in the anodizing treatment of the aluminum plate is any one selected from various electrolytes which can form a porous oxide film. Among which in general use are electrolytes of sulfuric acid, phosphoric acid, oxalic acid, chromic acid, or a mixed acid thereof. The concentration of the electrolyte may be appropriately decided depending on the kind of electrolyte selected.

Treatment conditions for anodization cannot be specified as a general rule since conditions vary depending on the electrolyte used; however, the following range of conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of anodic oxide film is less than 1.0 g/m², printing resistance is inadequate or non-image portions of the planographic printing plate tend to become easily damaged and the so-called “blemish stains”, resulting from ink adhering to damaged portions at the time of printing, are easily generated.

After the anodizing treatment, the surface of the aluminum is if necessary subjected to treatment for obtaining hydrophilicity. This securance of hydrophilicity treatment may be an alkali metal silicate (for example, an aqueous sodium silicate solution) method, as disclosed in U.S. Pat. Nos. 2,714,066, 3,181,461, 3,280,734, and 3,902,734. In this method, the support is subjected to an immersing treatment or an electrolyzing treatment with an aqueous sodium silicate solution.

In addition, the following methods may also be used: a method of treating the support with potassium fluorozirconate, as disclosed in JP-B No. 36-22063, or with polyvinyl phosphonic acid, as disclosed in U.S. Pat. Nos. 3,276,868, 4,153,461, and 4,689,272.

[Undercoat Layer]

In the planographic printing plate precursor of the present invention, if necessary, an undercoat layer may be formed between the support and the recording layer.

As components of the undercoat layer, various organic compounds can be used. Examples thereof include carboxymethylcellulose, dextrin, gum arabic, phosphonic acids having an amino group, such as 2-aminoethylphosphonic acid, organic phosphonic acids which may have a substituent, such as phenyl phosphonic acid, naphthylphosphonic acid, alkylphosphonic acid, glycerophosphonic acid, methylenediphosphonic acid and ethylenediphosphonic acid, organic phosphoric acids which may have a substituent, such as phenylphosphoric acid, naphthylphosphoric acid, alkylphosphoric acid and glycerophosphoric acid, organic phosphinic acids which may have a substituent, such as phenylphosphinic acid, naphthylphosphinic acid, alkylphosphinic acid and glycerophosphinic acid, amino acids such as glycine and β-alanine, and hydrochlorides of amines having a hydroxyl group, such as a hydrochloride of triethanolamine. These organic compounds may be used alone or in the form of a mixture made up of two or more thereof.

This organic undercoat layer may be formed by methods which can be described as follows: a method of applying onto the aluminum plate a solution wherein the above-mentioned organic compound is dissolved in water, or an organic solvent such as methanol, ethanol or methyl ethyl ketone, or a mixed solvent thereof and then drying the resultant aluminum plate, or a method of immersing the aluminum plate into a solution wherein the above-mentioned organic compound is dissolved in water, or an organic solvent such as methanol, ethanol or methyl ethyl ketone, or a mixed solvent thereof so as to adsorb the compound, washing the aluminum plate with water or the like, and then drying the resultant aluminum plate.

In the former method, the solution of the organic compound having a concentration of 0.05 to 10% by mass may be applied in various ways. In the latter method, the concentration of the organic compound in the solution is from 0.01 to 20%, preferably from 0.05 to 5%, the temperature for the immersion is from 20 to 90° C., preferably from 25 to 50° C., and the time taken for immersion is from 0.1 second to 20 minutes, preferably from 2 seconds to 1 minute.

The pH of the solution used in the above-mentioned methods can be adjusted into a range of 1 to 12 with a basic material such as ammonia, triethylamine or potassium hydroxide, or an acidic material such as hydrochloric acid or phosphoric acid. Moreover, a yellow dye may be added to the solution, in order to improve the tone reproducibility of the recording layer.

The amount of organic undercoat layer applied is suitably from 2 to 200 mg/m², preferably from 5 to 100 mg/m².

[Resin Intermediate Layer]

The planographic printing plate precursor may have a resin intermediate layer formed as needed between the support and the recording layer (or, between the undercoat layer and the support if the undercoat layer has been formed).

Presence of the resin intermediate layer has advantages that it allows formation of a recording layer, i.e., an infrared ray-sensitive layer that becomes more soluble in alkaline developer by exposure, on the exposure surface or at a site closer thereto, improving the sensitivity thereof to the infrared laser, and at the same time, the resin intermediate layer, a polymer layer between the support and the infrared ray-sensitive layer, functions as a heat-insulating layer, prohibiting diffusion of the heat generated by exposure of infrared laser to the support, allowing more efficient use of the heat for image formation, and thus making the recording layer more sensitive.

In the unexposed region, the recording layer non-permeable into the alkaline developer seems to function as a protective layer for the resin intermediate layer, improving developing stability, providing images superior in color discrimination and stability over time.

In the exposed region, the components in the recording layer, which are set free from solubilization inhibition, become dissolved or dispersed in the developer rapidly and the resin intermediate layer consisting of an alkali-soluble polymer, which is readily soluble in the developer and present close to the support, dissolves rapidly without leaving residual layer or the like, improving the printing properties, for example, even when a less active developer or the like is used. Thus, the resin intermediate layer is useful in various ways.

[Preparation of planographic Printing Plate Precursor]

Plate making steps for the planographic printing plate precursor having respective layers formed as above (image exposure, development, and printing step) are next described below.

(Light Exposure)

Light sources for the beam used in image exposure are favorably, for example, light sources having an emission wavelength in the near-infrared to infrared regions, and particularly preferably, solid state lasers and semiconductor lasers.

When applied to a recording layer of planographic printing plate precursor, the photosensitive composition according to the invention does not cause deterioration in printing properties because of its superior post-exposure stability, even when the applied planographic printing plate precursor is not developed immediately after exposure but developed after a certain time. Thus, such a planographic printing plate precursor is useful, for example, when multiple planographic printing plate precursors stocked after exposure are processed together in an automatic developing machine, and shows such a printing properties that the images developed after a certain time are not inferior in quality to those immediately after exposure.

(Development)

As the developer and replenisher for the planographic printing plate precursor wherein the photosensitive composition of the invention is used as its recording layer, aqueous solutions of a conventional alkali agent can be used.

Examples of the alkali agent include inorganic alkali salts such as sodium silicate, potassium silicate, trisodium phosphate, tripotassium phosphate, triammonium phosphate, disodium hydrogenphosphate, dipotassium hydrogenphosphate, diammonium hydrogenphosphate, sodium carbonate, potassium carbonate, ammonium carbonate, sodium hydrogencarbonate, potassium hydrogencarbonate, ammonium hydrogen carbonate, sodium borate, potassium borate, ammonium borate, sodium hydroxide, ammonium hydroxide, potassium hydroxide and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine. These alkali agents may be used alone or in combinations of two or more thereof.

Among these alkali agents, silicates such as sodium silicate and potassium silicate are particularly preferable for the developer. This is because the developing capacity of the developer can be controlled by adjusting the ratio between silicon oxide (SiO₂) and alkali metal oxide (M₂O), which are components of any one of the silicates, and by adjusting the concentrations thereof. For example, alkali metal silicates as described in JP-A No. 54-62004 or JP-B No. 57-7427 can be effectively used.

In a case where an automatic developing machine is used to perform development, an aqueous solution having a higher alkali intensity than that of the developer (or, replenisher) can be added to the developer. It is known that this makes it possible to treat a great number of photosensitive plates without recourse to replacing the developer in the developing tank over a long period of time. This replenishing manner is also preferably used in the invention.

If necessary, various surfactants or organic solvents can be incorporated into the developer and the replenisher in order to promote and suppress development capacity, disperse development scum, and enhance the ink-affinity of image portions of the printing plate.

Preferable examples of the surfactant include anionic, cationic, nonionic and amphoteric surfactants. If necessary, the following may be added to the developer and the replenisher: a reducing agent (such as hydroquinone, resorcin, a sodium or potassium salt of an inorganic acid such as sulfurous acid or hydrogen sulfite acid), an organic carboxylic acid, an antifoaming agent, and a water softener.

The printing plate developed with the developer and replenisher described above is subsequently subjected to treatments with washing water, a rinse solution containing a surfactant and other components, and a desensitizing solution containing gum arabic and a starch derivative. For after treatment following use of the photosensitive composition of the invention as a planographic printing plate precursor, various combinations of these treatments may be employed.

In recent years, automatic developing machines for printing plate precursors have been widely used in order to rationalize and standardize plate-making processes in the plate-making and printing industries. These automatic developing machines are generally made up of a developing section and a post-processing section, and include a device for carrying printing plate precursors, various treating solution tanks, and spray devices. These machines are machines for spraying respective treating solutions, which are pumped up, onto an exposed printing plate through spray nozzles, for development, while the printing plate is transported horizontally.

Recently, a method has also attracted attention in which a printing plate precursor is immersed in treating solution tanks filled with treating solutions and conveyed by means of in-liquid guide rolls. Such automatic processing can be performed while replenishers are being replenished into the respective treating solutions in accordance with the amounts to be treated, operating times, and other factors.

A so-called use-and-dispose processing manner can also be used, in which treatments are conducted with treating solutions which in practice have yet been used.

In cases where unnecessary image portions (for example, a film edge mark of an original picture film) are present on a planographic printing plate obtained by exposing imagewise to light a planographic printing plate precursor to which the invention is applied, developing the exposed precursor, and subjecting the developed precursor to water-washing and/or rinsing and/or desensitizing treatment(s), unnecessary image portions can be erased.

The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

(Heating Treatment (Baking Treatment))

The developed planographic printing plate thus obtained may be further coated with a desensitizing gum if desired before it is sent to the printing process; or the plate is additionally subjected to a baking treatment if desired for the purpose of obtaining planographic printing plates higher in printing durability. In particular, when the photosensitive composition according to the invention is applied to a recording layer of planographic printing plate precursor, a common baking treatment leads to drastic increase in printing durability, because the recording layer contains a novolak resin (A) having phenolic hydroxyl groups and thus is heat-crosslinkable.

It is preferable to treat the plate precursor with an affinitizing solution described in JP-B Nos. 61-2518 and 55-28062 and JP-A Nos. 62-31859 and 61-159655 before the baking treatment. The methods include application of the affinitizing solution onto the planographic printing plate with a sponge or cotton moistened therewith, application by immersing the printing plate into a bath filled with the affinitizing solution, and application by an automatic coater. Additionally, adjustment of the coating amount to uniformity by using a squeezee or a squeezee roller after application of the affinitizing solution leads to further preferable results.

The suitable amount of the affinitizing solution coated is generally 0.03 to 0.8 g/m² (as dry weight). Then, the planographic printing plate with the affinitizing solution applied may be dried as needed.

The planographic printing plat according to the invention is subsequently subjected to a heating treatment. The heating method is not particularly limited if it is effective in improving the printing durability, one of the advantageous effects of the invention by applying heat onto plate surface, and the examples thereof include methods of heating in a baking processor and others.

In the invention, among the heating methods above, preferable is a method of heating at high temperature in a baking processor (e.g. Baking Processor BP-1300, sold by Fuji Photo Film) or the like. The temperature and the period of the heating vary according to the kind of the components constituting the upper layer and the image-recording layer, but are preferably in the range of 150 to 300° C. for 0.5 to 20 minutes and more preferably in the range of 180 to 270° C. for 1 to 10 minutes.

The planographic printing plate after the baking treatment may be then subjected if needed to treatments commonly practiced in the art such as water washing and gumming, but if an affinitizing solution containing a water-soluble polymer compound or the like is used, so-called desensitizing treatments such as gumming and the like may be eliminated.

The planographic printing plates obtained after these treatments are then supplied to an offset printing machine or the like, wherein they are used for printing numerous papers.

### EXAMPLES

Hereinafter, the present invention will be described with reference to Examples, but it should be understood that the scope of the invention is not limited to these Examples.

### Examples 1 to 40 and Comparative Examples 1 to 8

(Preparation of Support)

Supporting plates were prepared in the following steps, using a JIS-A-1050 aluminium plate having a thickness of 0.3 mm.

(a) Mechanical Surface-Roughening Treatment

While a suspension of an abrasive agent (silica sand) having a specific gravity of 1.12 in water was supplied as an abrading slurry onto a surface of any one of the aluminum plates, the surface was mechanically roughened with rotating roller-form nylon brushes. The average grain size of the abrasive agent was 8 μm and the maximum grain size thereof was 50 μm. The material of the nylon brushes was 6.10-nylon, the length of bristles thereof was 50 mm, and the diameter of the bristles was 0.3 mm. The nylon brushes were each obtained by making holes in a stainless steel cylinder having a diameter of 300 mm and then planting bristles densely into the holes. The number of the used rotating brushes was three. The distance between the two supporting rollers (diameter: 200 mm) under each of the brushes was 300 mm. Each of the brush rollers was pushed against the aluminum plate until the load of a driving motor for rotating the brush became 7 kW larger than the load before the brush roller was pushed against the aluminum plate. The rotating direction of the brush was the same as the moving direction of the aluminum plate. The rotation speed of the brush was 200 rpm.

(b) Alkali Etching Treatment

A 70° C. aqueous solution of NaOH (NaOH concentration: 26% by mass, and aluminum ion concentration: 6.5% by mass) was sprayed onto the aluminum plate obtained in the above-mentioned manner to etch the aluminum plate, thereby dissolving the aluminum plate by 6 g/m². Thereafter, the aluminum plate was washed with water.

(c) Desmutting Treatment

The aluminum plate was subjected to desmutting treatment with a 30° C. aqueous solution having a nitric acid concentration of 1% by mass (and containing 0.5% by mass of aluminum ions), which was sprayed, and then washed with water. The aqueous nitric acid solution used in the desmutting treatment was waste liquid derived from the step of conducting electrochemical surface-roughening treatment using alternating current in an aqueous nitric acid solution.

(d) Electrochemical Surface-Roughening Treatment

Alternating current having a frequency of 60 Hz was used to conduct electrochemical surface-roughening treatment continuously. The electrolyte used at this time was a 10.5 g/L solution of nitric acid in water (containing 5 g/L of aluminum ions), and the temperature thereof was 50° C. The wave of the used alternating current was a trapezoidal wave wherein the time TP until the current value was raised from zero to a peak was 0.8 msec, and the duty ratio of the current was 1:1. This trapezoidal wave alternating current was used, and a carbon electrode was set as a counter electrode to conduct the electrochemical surface-roughening treatment. Ferrite was used as an auxiliary anode. The used electrolyte bath was a radial cell type bath.

The density of the current was 30 A/dm² when the current was at the peak. The total amount of consumed electricity when the aluminum plate functioned as an anode was 220 C/dm². Five percent of the current sent from a power source was allowed to flow into the auxiliary anode.

Thereafter, the aluminum plate was washed with water.

(e) Alkali Etching Treatment

An aqueous solution having a caustic soda of 26% by mass and an aluminum ion concentration of 6.5% by mass was sprayed onto the aluminum plate to etch the plate at 32° C. so as to dissolve the aluminum plate by 0.20 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with water.

(f) Desmut Treatment

The aluminum plate was subjected to desmutting treatment with a 30° C. aqueous solution having a nitric acid concentration of 15% by mass (and containing 4.5% by mass of aluminum ions), which was sprayed, and then washed with water. The aqueous nitric acid solution used in the desmutting treatment was waste liquid derived from the step of conducting the electrochemical surface-roughening treatment using the alternating current in the aqueous nitric acid solution.

(g) Electrochemical Surface-Roughening Treatment

Alternating current having a frequency of 60 Hz was used to conduct electrochemical surface-roughening treatment continuously. The electrolyte used at this time was a 7.5 g/L solution of hydrochloric acid in water (containing 5 g/L of aluminum ions), and the temperature thereof was 35° C. The wave of the alternating current was a rectangular wave. A carbon electrode was set as a counter electrode to conduct the electrochemical surface-roughening treatment. Ferrite was used as an auxiliary anode. The used electrolyte bath was a radial cell type bath.

The density of the current was 25 A/dm² when the current was at the peak. The total amount of consumed electricity when the aluminum plate functioned as an anode was 50 C/dm².

Thereafter, the aluminum plate was washed with water.

(h) Alkali Etching Treatment

An aqueous solution having a caustic soda of 26% by mass and an aluminum ion concentration of 6.5% by mass was sprayed onto the aluminum plate to etch the plate at 32° C. so as to dissolve the aluminum plate by 0.10 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with water.

(i) Desmutting Treatment

The aluminum plate was subjected to desmutting treatment with a 60° C. aqueous solution having a sulfuric acid concentration of 25% by mass (and containing 0.5% by mass of aluminum ions), which was sprayed, and then washed with water.

(j) Anodizing Treatment

As electrolytes, sulfuric acid was used. The electrolytes were each an electrolyte having a sulfuric acid concentration of 170 g/L (and containing 0.5% by mass of aluminum ions), and the temperature thereof was 43° C. Thereafter, the support was washed with water.

The current densities were each about 30 A/dm². The final amount of the oxidation film was 2.7 g/m².

<Support A>

The above steps (a) to (j) were successively performed and the etching amount in step (e) was set to 3.4 g/m², so as to form a support A.

<Support B>

The above-mentioned steps other than steps (g), (h) and (i) were successively performed to form a support B.

<Support C>

The above-mentioned steps other than steps (a), (g), (h) and (i) were successively performed to form a support C.

<Support D>

The above-mentioned steps other than the steps (a), (g), (h) and (i) were successively performed, and the total amount of consumed electricity in step (g) was set to 450 C/dm², to form a support D.

The supports A, B, C and D obtained in the above-mentioned manner were subjected to the following treatment to make the support surface hydrophilic and apply undercoat to the support.

(k) Treatment with Alkali Metal Silicate

Each of the aluminum supports A to D obtained in the above-mentioned manner was immersed into a treatment tank containing a 30° C. aqueous solution of #3 sodium silicate (concentration of sodium silicate: 1% by mass) for 10 seconds to subject the support to treatment with the alkali metal silicate (silicate treatment). Thereafter, the support was washed with water. The amount of the silicate adhering at this time was 3.5 mg/m².

(Undercoat Treatment)

An undercoat solution having the following composition was applied onto each of the aluminum supports treated with the alkali metal silicate, which supports were obtained in the above-mentioned manner, and the resultant was dried at 80° C. for 15 seconds. The applied amount of solid contents after the drying was 18 mg/m².

<Undercoat solution composition>

| | |
|---|---|
| Polymer compound having a structure illustrated below | 0.3 g |
| Methanol | 100 g |
| Water | 1.0 g |

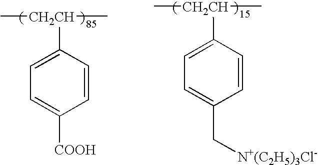

Weight-average molecular weight: 26,000
(Formation of Lower Layer and Image-Recording Layers)

Then, a recording layer-coating solution (photosensitive composition) having the composition listed below was applied onto each of the supports A to D having undercoat layers obtained as described above, and the support was dried in an oven at 150° C. for 1 minute, to give a positive-type planographic printing plate precursor having a recording layer with a dry film thickness of 1.7 g/m². The supports used in respective Examples are summarized in Table 1.

<Coating solution for recording layer>

| | | |
|---|---|---|
| (A) Phenol and cresol-formaldehyde novolak resin | 0.95 | g |
| (phenol:m-cresol:p-cresol = 50:30:20, | | |
| weight-average molecular weight: 7,700) | | |
| (B) Specific alkali-soluble resin shown in Table 1 | 0.08 | g |
| (C) Cyanine dye A (having the structure below) | 0.015 | g |
| (C) Cyanine dye B (having the structure below) | 0.025 | g |
| (D) Sulfonium salt shown in Table 13 | 0.20 | g |
| 2,4,6-Tris(hexyloxy)benzenediazonium- | 0.01 | g |
| 2-hydroxy-4-methoxybenzophenone-5-sulfonate | | |
| p-Toluenesulfonic acid | 0.003 | g |
| Cyclohexane-1,2-dicarboxylic acid anhydride | 0.06 | g |
| Dye, Victoria Pure Blue BOH, | 0.015 | g |
| having an 1-naphthalenesulfonate anion | | |
| as the counter anion | | |
| Fluorochemical surfactant | 0.02 | g |
| (Magafac F-176, manufactured by | | |
| Dainippon Ink and Chemicals, Inc.) | | |
| Methylethylketone | 15 | g |
| 1-Methoxy-2-propanol | 7 | g |

| | |
|---|---|
| | Cyanine dye A |
| 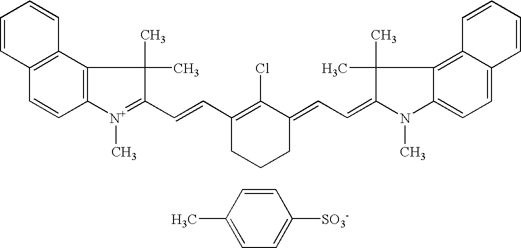 | |
| 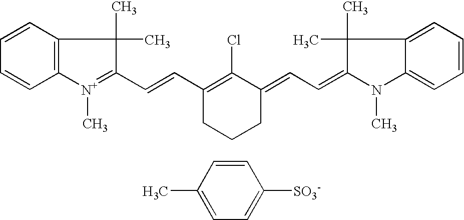 | Cyanine dye B |

[Evaluation of Planographic Printing Plate Precursor]

Then, the development latitude, sensitivity, and post-exposure stability respectively of the positive-type planographic printing plate precursors obtained in Examples 1 to 8 and Comparative Examples 1 and 2 were evaluated. Details of the evaluation methods are described below.

[Evaluation of Development Latitude]

A test pattern was formed on the planographic printing plate precursors obtained using a Trendsetter 3244 VX, manufactured by Creo, at a beam intensity of 9 W and a drum rotational velocity of 150 rpm.

Then, the planographic printing plate precursor was developed at a constant liquid temperature of 30° C. and a development period of 22 seconds in a PS Processor 900H manufactured by Fuji Photo Film Co. Ltd., that contained a diluted solution of alkaline developer A or B having the compositions as listed below, of which the electrical conductivity was modified by changing the amount of water and thus the dilution rate. The difference between the maximum and minimum values of electrical conductivity of the developers during the development above that provided good development was determined as the development latitude, without any solubilization of the image regions and without stains or discoloration derived from persistent layer in poorly developed photosensitive layer. Results are summarized in Table 1. The developers used are also included in Table 1.

<Composition of alkaline developer A>

| | |
|---|---|
| SiO₂.K₂O [K₂O/SiO₂ = 1/1 (molar ratio)] | 4.0% by weight |
| Citric acid | 0.5% by weight |
| Polyethylene glycol laurylether | 0.5% by weight |
| (weight-average molecular weight: 1,000) | |
| Water | 95.0% by weight |

<Composition of alkaline developer B>

| | |
|---|---|
| D-sorbit | 2.5% by weight |
| Sodium hydroxide | 0.85% by weight |
| Polyethylene glycol laurylether | 0.5% by weight |
| (weight-average molecular weight: 1,000) | |
| Water | 96.15% by weight |

[Evaluation of Sensitivity]

Test patterns of an image were drawn at different exposure energies on the planographic printing plate precursors obtained using the Trendsetter 3244 VFS manufactured by Creo.

Subsequently, the patterns were developed using an alkaline developer having an intermediate (average value) electrical conductivity between the maximum and minimum values of the electrical conductivity of the developer that provided good development without any solubilization of the image regions and without stains and discoloration derived from persistent layer in poorly developed photosensitive layer during the evaluation of the development latitude above. The exposure quantity (beam intensity at a drum rotational velocity of 160 rpm) that allowed development of non-image regions using this developer was determined and designated as the sensitivity. The smaller the value, the higher the sensitivity is. The results are summarized in Table 1.

[Evaluation of Post-Exposure Stability]

The planographic printing plate precursors obtained were evaluated in a similar manner to the sensitivity evaluation, except that the precursor was left in an environment of a relative humidity of 70% at 25° C. for one hour after exposure. Then, the difference between the previous results (sensitivity immediately after exposure) and the result of this sensitivity evaluation was used as the indicator of sensitivity retention. Results are summarized in Table 1.

The post-exposure stability in Table 1 indicates the sensitivity remaining one hour after exposure, and when it is close to the sensitivity immediately after exposure, the plate precursor has a better sensitivity retention.

TABLE 1

| | | | | | Development | | Post- |
|---|---|---|---|---|---|---|---|
| | | Component | Component (D): | | latitude | Sensitivity | exposure |
| | Support | (B): resin | sulfonium salt | Developer | (mS/cm) | (W) | stability (W) |
| Example 1 | A | AP-1 | (13) | A | 7 | 4.5 | 4.8 |
| Example 2 | B | AP-2 | (11) | A | 7 | 4.5 | 4.8 |
| Example 3 | C | AP-3 | (15) | A | 7 | 4.5 | 4.8 |
| Example 4 | D | AP-3 | (21) | A | 7 | 4.5 | 4.8 |
| Example 5 | A | AP-3 | (23) | A | 6 | 5.0 | 5.2 |
| Example 6 | A | AP-5 | (26) | B | 6 | 5.0 | 5.2 |
| Example 7 | A | AP-8 | (36) | B | 6 | 5.0 | 5.2 |
| Example 8 | A | AP-11 | (66) | B | 6 | 5.0 | 5.2 |
| Example 9 | A | Compound A | (10) | A | 6 | 5.5 | 6.0 |
| Example 10 | A | Compound B | (19) | A | 6 | 5.5 | 6.0 |
| Example 11 | A | Compound C | (24) | A | 6 | 5.5 | 6.0 |
| Example 12 | A | Compound D | (51) | A | 6 | 5.5 | 6.0 |
| Comparative | A | None | (13) | A | 2 | 6.0 | 8.0 |
| Example 1 | | | | | | | |
| Comparative | A | AP-1 | Ammonium salt A | A | 3 | 6.0 | 7.5 |
| Example 2 | | | | | | | |

The components (B), i.e., the specific alkali-soluble resins, used in Examples 1 to 8 in Table 1 are typical examples of the particular vinyl polymers described before, and the structures of compounds A to D used in Examples 9 to 12 are shown below.

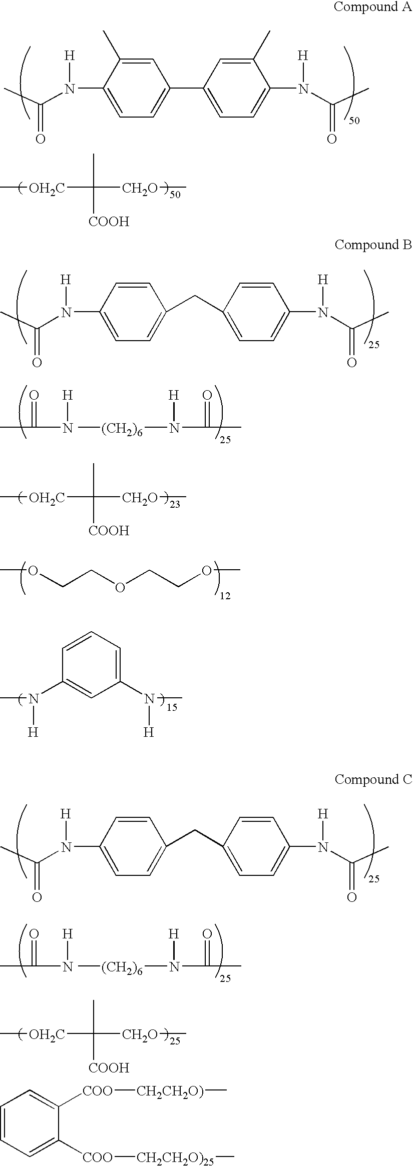

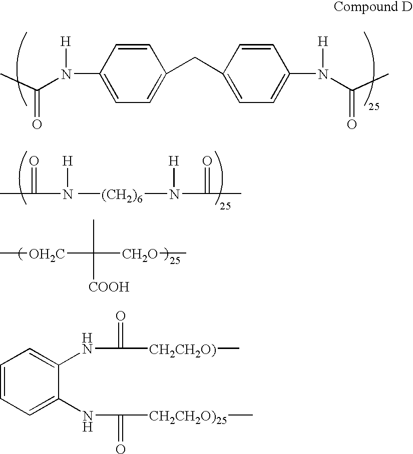

The components (D), i.e., sulfonium salts, in Table 1 are typical examples of the sulfonium salts represented by General Formula (x).

In addition, the structure of ammonium salt A used in Comparative Example 2 is shown below.

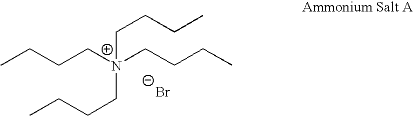

As apparent from the results in Table 1, all planographic printing plate precursors employing the photosensitive composition according to the invention as the recording layer were superior in development latitude, sensitivity, and post-exposure stability when compared to the planographic printing plate precursors in Comparative Examples that do not employ the photosensitive composition according to the invention as the component for the recording layer.

The results indicate that the photosensitive composition according to the invention is superior in sensitivity, layer strength, and, ability to release the interaction by infrared ray exposure.

### Examples 13 to 20 and Comparative Examples 3 and 4

After application of the undercoat solution above onto the support B obtained above in a similar manner to Examples 1 to 12, a coating solution for a lower layer having the composition below was applied thereon by using a wire bar with a wet coating rate of 28 ml/m², and the coated support was dried in a drying oven at 150° C. for 60 seconds to give a dry coating amount of 1.5 g/m².

A coating solution for upper layer having the composition below was applied onto supporting plate having the lower layer thus obtained by using a wire bar with a wet coating capacity of 11 ml/m². After application, the support was dried in a drying oven at 140° C. for 70 seconds, to give a positive-type planographic printing plate precursor with a total coating amount of 1.8 g/m².

<Coating solution for lower layer>

| | | |
|---|---|---|
| Copolymer from N- | 2.003 | g |
| (p-aminosulfonylphenyl)methacrylamide, | | |
| methyl methacrylate, and acrylonitrile | | |
| (molar ratio: 37:33:30, weight-average molecular weight: 65,000) | | |
| Cyanine dye A (having the structure above) | 0.01 | g |
| 4,4′-Bishydroxyphenylsulfone | 0.106 | g |
| Cyclohexanedicarboxylic acid anhydride | 0.100 | g |
| Bis(hydroxymethyl)-p-cresol | 0.090 | g |
| p-Toluenesulfonic acid | 0.012 | g |
| Ethyl violet having 6- | 0.100 | g |
| hydroxynaphthalenesulfonic acid | | |
| substituted as the counter anion | | |
| 3-Methoxy-4-diazodiphenylamine | 0.05 | g |
| hexafluorophosphate (thermodegradable compound) | | |
| Fluorine based surfactant | 0.035 | g |
| (Magafac F-176, Dainippon Ink and Chemicals, Inc.) | | |
| Methylethylketone | 26.6 | g |
| 1-Methoxy-2-propanol | 13.6 | g |
| N,N-Dimethylacetamide | 13.8 | g |

<Coating solution for upper layer>

| | | |
|---|---|---|
| (A) Cresol novolak resin | 0.3 | g |
| (PR-54046, manufactured by Sumitomo Bakelite) | | |
| (B) Specific alkali-soluble resin shown in Table 2 | 0.3 | g |
| (C) Cyanine dye C (having the structure below) | 0.008 | g |
| (D) Sulfonium salt shown in Table 2 | 0.016 | g |
| Tetrabutylammonium bromide | 0.030 | g |
| Fluorine based surfactant | 0.035 | g |
| (Magafac F-176, manufactured by | | |
| Dainippon Ink and Chemicals, Inc.) | | |
| 1-Methoxy-2-propanol | 40.2 | g |

| | |
|---|---|
| 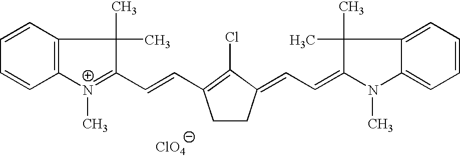 | Cyanine Dye C |

[Evaluation of Planographic Printing Plate Precursor]

The development latitude, sensitivity, and post-exposure stability of the planographic printing plate precursors obtained were evaluated in a similar manner to the methods of Examples 1 to 12. The developer of composition B was used. Results are summarized in Table 2.

TABLE 2

| | | Component | | | |
|---|---|---|---|---|---|
| | | (D): | | | |
| | Component | sulfonium | Development | Sensitivity | Post-exposure |
| | (B): resin | salt | latitude (mS/cm) | (W) | stability (W) |
| Example 13 | AP-7 | (70) | 8 | 4.7 | 5.0 |
| Example 14 | AP-10 | (76) | 7 | 4.7 | 5.0 |
| Example 15 | AP-12 | (52) | 8 | 4.7 | 5.0 |
| Example 16 | AP-13 | (21) | 8 | 4.7 | 5.0 |
| Example 17 | AP-2 | (13) | 7 | 4.8 | 5.2 |
| Example 18 | AP-5 | (3) | 7 | 4.8 | 5.2 |
| Example 19 | AP-9 | (28) | 8 | 4.8 | 5.2 |
| Example 20 | P-10 | (36) | 7 | 4.8 | 5.2 |
| Comparative | None | (70) | 2 | 5.5 | 7.5 |
| Example 3 | | | | | |
| Comparative | AP-7 | Ammonium | 3 | 6.0 | 7.5 |
| Example 4 | | salt A | | | |

The components (B), i.e., specific alkali-soluble compounds, in Table 2 are typical examples of the particular vinyl polymers described before, and the components (D), sulfonium salts, typical examples of the sulfonium salts represented by General Formula (x).

The ammonium salt A used in Comparative Example 2 is the same as that described above.

As apparent from the results in Table 2, the planographic printing plate precursors employing the photosensitive composition according to the invention as the recording layer were superior in development latitude, sensitivity, and post-exposure stability when compared to the planographic printing plate precursors in the Comparative Examples that do not employ the photosensitive composition according to the invention as the component for recording layer. This is true even when the recording layer is a laminate consisting of a lower and an upper layer, and advantageous effects similar to the recording layers of the single layer structure. It is assumed that this is because the photosensitive composition according to the invention is superior in sensitivity, layer strength, and, the ability to eliminate the interaction by infrared ray exposure.

[Evaluation of Anti-Scumming Property of Non-Image Areas]

Anti-scumming property of non-image areas were evaluated by conducitng examples 21 to 40 and comparative examples 5 to 8. In this evaluation, among the planographic printing plates obtained during the above-described evaluation, the planographic printing plates which were developed with a developer having an intermediate developing activity between the maximum and minimum electrical conductivities of the developers that successfully provided good development without stains and coloration due to residues of a poorly developed photosensitive layer in the non-image areas, were used to conduct printing on MITSUBISHI DIAMOND-TYPE F2 PRINTER (manufactured by Mitsubishi Heavy Industries., Ltd.) with DIC-GEOS (s) crimson ink to obtain 10,000 prints, and then staining on a blanket was visually evaluated. The results of the evaluation are shown in Table 3 below.

Criteria for the evaluation were:
A: no staining,
B: little staining, and

C: significant staining.

TABLE 3

| | Anti-scumming |
|---|---|
| | property |
| Example 21 | C |
| Example 22 | C |
| Example 23 | C |
| Example 24 | C |
| Example 25 | C |
| Example 26 | C |
| Example 27 | C |
| Example 28 | A |
| Example 29 | C |
| Example 30 | C |
| Example 31 | C |
| Example 32 | C |
| Example 33 | A |
| Example 34 | A |
| Example 35 | C |
| Example 36 | C |
| Example 37 | C |
| Example 38 | C |
| Example 39 | C |
| Example 40 | C |
| Comp. Example 5 | C |
| Comp. Example 6 | C |
| Comp. Example 7 | A |
| Comp. Example 8 | C |

In summary, the results of the Examples indicate that the photosensitive compositions according to the invention (the first embodiment) are useful as a recording layer for positive-type planographic printing plate precursor compatible with infrared ray.

### Second Embodiment

Hereinafter, the second embodiment of the invention will be described in detail.

The positive-type photosensitive composition (image-forming material) according to the invention (in the present embodiment) has a support and an image-forming layer (C) having a novolak-type phenol resin (A) containing phenol as the structural unit, a photothermal converter (B), and a sulfonium salt.

Hereinafter, constituent components for the image-forming layer according to the invention are described respectively in detail.

[Novolak-Type Phenol Resin (A) Containing Phenol as the Structural Unit]

The image-forming layer according to the invention contains a novolak-type phenol resin containing phenol as the structural unit (particular novolak resin). The particular novolak resin is not particularly limited if it contains phenol in the molecular structural unit, and preferably, the content of the phenol as the structural unit in the structural units constituting the novolak resin is preferably in the range of 20 to 90 mole %, more preferably 31 to 8.5 mole %, and most preferably 51 to 80 mole %.

Preferable examples of the particular novolak resin include resins (A-1) prepared by condensation of phenol and a substituted phenol represented by the following General Formula (I) with an aldehyde. Other preferable examples are resins (A-2) prepared by condensation of a phenol selected from phenols selected from cresol and xylenol with an aldehyde. The number of the substituted phenol components constituting the particular novolak resin except phenol may be plural.

<Resin (A-1) Prepared by Condensation of Phenol and a Substituted Phenol Represented by the Following General Formula (1) with an Aldehyde>

First, resin (A-1) prepared by condensation of a phenol and a substituted phenol represented by the following General Formula (I) with an aldehyde (hereinafter, referred to as “resin (A-1)” will be described in detail.

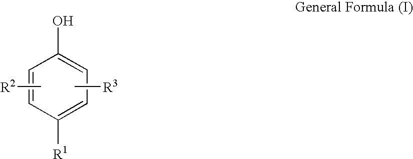

In General Formula (I), R¹ and R² each independently represent a hydrogen atom, alkyl group, or halogen atom. The alkyl group is preferably an alkyl group having 1 to 3 carbons and more preferably an alkyl group having 1 or 2 carbons. The halogen atom is a fluorine, chlorine, bromine, or iodine atom, and preferably a chlorine atom or bromine atom. R³ represents an alkyl or cycloalkyl group having 3 to 6 carbons.

Specific examples of the substituted phenols represented by General Formula (I) used as the component for resin (A-1) include isopropylphenol, t-butylphenol, t-amyl phenol, hexylphenol, cyclohexylphenol, 3-methyl-4-chloro-6-t-butylphenol, isopropylcresol, t-butylcresol, t-amylcresol, and the like. Among them, preferable are t-butylphenol and t-butylcresol.

Examples of the aldehydes used in resin (A-1) include aliphatic and aromatic aldehydes such as formaldehyde, acetaldehyde, acrolein, and crotonaldehyde. Among them, preferable are formaldehyde and acetaldehyde.

The content of the phenol in the monomers constituting the resin (A-1) is preferably 21 to 90 mole %, more preferably 31 to 85 mole %, and still more preferably 51 to 80 mole %.

The weight-average molecular weight of the resin (A-1) is preferably 500 to 50,000, more preferably 700 to 20,000, and particularly preferably 1,000 to 10,000.

The content of the resin (A-1) is preferably 0.1 to 20%, more preferably 0.2 to 10%, and particularly preferably 0.2 to 5% by weight with respect to the total solid matters in the image-forming layer according to the invention. A content of less than 0.1% by weight often leads to insufficient effects by addition, while a content of more than 20% decrease in sensitivity.

<Resin (A-2) Prepared by Condensation of a Phenol Selected from Phenol, Cresol, and Xylenol with an Aldehyde>

The resin (A-2) prepared by condensation of a phenol selected from phenol, cresol, and xylenol with an aldehyde (hereinafter, referred to as “resin (A-2)”) will be described below in detail.

Aldehydes for use in the condensation reaction for the resin (A-2) are those described in the description of the resin (A-1).

Favorable examples of the resins (A-2) for use in the invention include novolak resins such as phenol formaldehyde resins, mixed phenol/(m-, p-, or mixed m- /p-)cresol-fromaldehyde resins, and the like.

The content of phenol in the monomers constituting the resin (A-2) is preferably 21 to 90 mole %, more preferably 31 to 85 mole %, and particularly preferably 51 to 80 mole %. m-Cresol is preferably present in an amount of 10 mole % or more in the monomers.

The weight-average molecular weight of the resin (A-2) is preferably 500 to 50,000, more preferably 700 to 20,000, and particularly preferably 1,000 to 10,000. Further, the number-average molecular weight thereof is preferably 500 or more and more preferably 750 to 650,000. The molecular weight distribution (weight-average molecular weight/number-average molecular weight) is preferably 1.1 to 10.

The resin (A-2) for use in the invention preferably is present in an amount preferably of 10 to 95% and more preferably 20 to 90% by weight with respect to the total solid matters in the image-recording layer of image-forming material. A content of less than 10% by weight may result in unfitness for use due to the insufficient improvement in printing durability by baking treatment.

The particular novolak resins according to the invention such as resins (A-1) and resins (A-2) may be used alone or in combination of two or more.

Any one of common novolak resins different from the particular novolak resins according to the invention may be used in combination. In such a case, the novolak resin except the particular novolak resins may be added in an amount in the range of 5 to 50%, more preferably in the range of 5 to 30%, and particularly preferably 5 to 20% by weight with respect to the total novolak resins.

The particular novolak resin according to the invention can be prepared, for example, by reacting a solution of phenol and a substituted phenol (e.g., cresols, the second component in the description on the resins (A-1) and resins (A-2), or the like) in a solvent with an aqueous formaldehyde solution in the presence of an acid catalyst and thus binding formaldehyde to the o- or p-position of the phenol and the substituted phenol component in dehydration condensation, as described in Section 300 of “New Experimental Chemistry [19] Polymer Chemistry [1]” (published by Maruzen Co., Ltd., 1993).

The dehydration condensation between the o- or p-position of phenol and the substituted phenol component and formaldehyde is carried out by adding formaldehyde into a solvent solution containing phenol and the substituted phenol component at a molar ratio of 0.2 to 2.0, preferably 0.4 to 1.4, and particularly preferably 0.6 to 1.2 with respect to total number of moles of phenol and the substituted phenol component, and further adding an acid catalyst at molar ratio of 0.01 to 0.1, preferably 0.02 to 0.05 with respect to total number of moles of phenol and the substituted phenol component at a temperature in the range of 10° C. to 150° C., so that the total concentration of phenol and the substituted phenol component becomes 60 to 90%, preferably 70 to 80% by weight, and stirring the mixture for several hours in the same temperature range. The reaction temperature is preferably in the range of 70° C. to 150° C., and more preferably in the range of 90° C. to 140° C.

Examples of the solvents used include water, acetic acid, methanol, ethanol, 2-propanol, 2-methoxyethanol, ethyl propionate, ethoxyethyl propionate, 4-methyl-2-pentanone, dioxane, xylene, benzene, and the like.

Examples of the acid catalysts include hydrochloric acid, sulfuric acid, p-toluenesulfonic acid, phosphoric acid, oxalic acid, tartaric acid, citric acid, zinc acetate, manganese acetate, cobalt acetate, magnesium methylsulfonate, aluminum chloride, zinc oxide, and the like.

The monomers and dimers remaining in the phenol resin prepared are removed by distillation, preferably until the concentration of the remaining monomers and dimers is lowered to 0.01 to 10% and more preferably to 0.01 to 2.0% by weight.

Typical examples of the particular novolak resins favorably used in the invention [(S-1) to (S-18)] are listed below.

(S-1) Condensation polymer from phenol, m-cresol, and p-cresol (molar ratio: 30:50:20, weight-average molecular weight: 4,000)

(S-2) Condensation polymer from phenol, m-cresol, and o-cresol (molar ratio: 50:30:20, weight-average molecular weight: 5,500)

(S-3) Condensation polymer from phenol, m-cresol, and p-cresol (molar ratio 70:10:20, weight-average molecular weight 4,500)

(S-4) Condensation polymer from phenol, m-cresol, and p-cresol (molar ratio 50:30:20, weight-average molecular weight 4,200)

(S-5) Condensation polymer from phenol and m-cresol (molar ratio: 70:30, weight-average molecular weight: 4,500)

(S-6) Condensation polymer from phenol and p-cresol (molar ratio: 60:40, weight-average molecular weight: 6,000)

(S-7) Condensation polymer from phenol and o-cresol (molar ratio: 50:50, weight-average molecular weight: 3,900)

(S-8) Condensation polymer from phenol and p-ethylphenol (molar ratio: 40:60, weight-average molecular weight: 4,000)

(S-9) Condensation polymer from phenol and p-tertiary-butylphenol (molar ratio: 80:20, weight-average molecular weight: 5,000)

(S-10) Condensation polymer from phenol and 2,5-xylenol (molar ratio: 90:10, weight-average molecular weight: 8,000)

(S-11 ) Condensation polymer from phenol and 2,3-xylenol (molar ratio: 75:25, weight-average molecular weight: 4,400)

(S-12) Condensation polymer form phenol and 2,4-xylenol (molar ratio 80:20, weight-average molecular weight 5,500)

(S-13) Condensation polymer from phenol and 3,4-xylenol (molar ratio: 70:30, weight-average molecular weight: 7,400)

(S-14) Condensation polymer from phenol and p-nonylphenol (molar ratio: 30:70, weight-average molecular weight: 9,800)

(S-15) Condensation polymer from phenol and p-phenylphenol (molar ratio: 65:45, weight-average molecular weight: 4,000)

(S-16) Condensation polymer from phenol and o-phenylphenol (molar ratio: 50:50, weight-average molecular weight: 4,500)

(S-17) Condensation polymer from phenol, m-cresol, and 2,5-xylenol (molar ratio: 80:15:5, weight-average molecular weight: 5,500)

(S-18) Condensation polymer from phenol, m-cresol, and p-phenylphenol (molar ratio: 40:10:50, weight-average molecular weight: 4,500)

Among them, polymers (S-1) to (S-13) are preferable, and polymers (S-1) to (S-8) are more preferable.

Besides the particular novolak resin, the image-forming layer according to the invention preferably contains a water-insoluble and alkaline water-soluble resin (hereinafter, referred to as “other alkali-soluble resin”), and the combined use thereof is preferable for expanding development latitude.

Examples of the other alkali-soluble resins include polyhydroxystyrene, polyhalogenated hydroxystyrenes, copolymers of N-(4-hydroxyphenyl)methacrylamide, copolymers of hydroquinone monomethacrylate, as well as the sulfonylimide polymers described in JP-A No. 7-28244 and the carboxyl group-containing polymers described in JP-A No. 7-36184, and the like. In addition, various alkali-soluble polymeric compounds including the phenolic hydroxyl group-containing acrylic resins disclosed in JP-A No. 51-34711 and the acrylic resins having a sulfonamide group, urethane resins, and others described in JP-A No. 2-866 may be used.

The weight-average molecular weight of the other alkali-soluble resin is preferably 500 to 200,000, and the number-average molecular weight thereof 200 to 60,000.

The other alkali-soluble resins may be used alone or in combination of two or more. The addition amount is preferably in the range of 0.5 to 30% and more preferably 0.5 to 20% by weight with respect to the total solid matters in the recording layer.

[Sulfonium Salt (C)]

The photosensitive composition according to the invention contains a sulfonium salt (C).

The sulfonium salts for use in the invention include the sulfonium salts represented by the following General Formula (x).

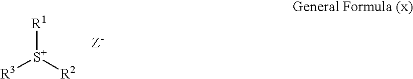

In General Formula (x), R¹, R² and R³ each independently represent a hydrocarbon group having 20 or fewer carbons which may have one or more substituents. Preferable substituents include halogen atoms, nitro group, alkyl groups having 12 or fewer carbons, alkoxy groups having 12 or fewer carbons, and aryloxy groups having 12 or fewer carbons.

Z⁻ represents a strong acid residue. Specific examples thereof include halide ions, perchlorate ion, hexafluorophosphate ion, tetrafluoroborate ion, sulfonate ion, sulfinate ion, thiosulfonate ion, and sulfate ion; and perchlorate ion, hexafluorophosphate ion, tetrafluoroborate ion, sulfonate ion, and sulfinate ion are preferable from the viewpoint of stability.

Examples of the sulfonium salt preferably used in the invention include compounds having a triarylsulfonium salt structure. Further, an example of the preferably usable sulfonium salt is a compound in which a sum of Hammett values (Hammett substituent constant a) of substituents bonded to aryl skeletons is greater then 0.46 (which compound will occasionally be referred to as “a specific sulfonium salt” hereinafter), and particularly is a compound that has a cation structure of an onium salt, in which a sum of Hammett values of substituents bonded to aryl skeletons is greater then 0.46. The specific sulfonium salt is preferable in view points of providing stability of the non-image areas due to its main skeleton, and providing good removal property of the exposed regions (the good removal property is provided because decomposability of the sulfonium salt by exposure is enhanced by acceleration of thermal decomposition or lowering of potential), thereby achieving effective suppression of staining.

—Triarylsulfonium Salt Structure—

Compounds having a triarylsulfonium salt structure are known, for example, as polymerization initiators, and can be easily synthesized according to methods described, for example, in: J. Amer. Chem. Soc. Vol. 112 (16), 1990, pp. 6004-6015; J. Org. Chem., 1988, pp. 5571-5573; WO 02/081439A1; and EP 1113005.

—Substituent Bonded to Aryl Skeleton—

As the substituents bonded to the aryl skeletons of the triarylsulfonium salt structure of the specific compound, an electron attracting substituent is preferable. The sum of Hammett values of the electron attracting substituents bonded to the three aryl skeletons needs to be greater than 0.46, and preferably is greater than 0.60. If the sum of Hammett values is 0.46 or less, a sufficient anti-scumming property cannot be provided.

The Hammett value represents a degree of an electron attracting property of a cation having a triarylsulfonium salt structure, and there is no upper limit specified in view of provision of high sensitivity. However, in view of reactivity and stability, the Hammett value is preferably greater than 0.46 and less than 4.0, more preferably is greater than 0.50 and less than 3.5, and particularly preferably is greater than 0.60 and less than 3.0.

It should be noted that, as the Hammett values in this invention, values described in “Chemistry Seminar 10 Hammett Rule—Structure and Reactivity—” (edited by Naoki Inamoto, published by Maruzen, 1983) are used.

Examples of the electron attracting substituent introduced in the aryl skeleton include a trifluoromethyl group, a halogen atom, an ester group, a sulfoxide group, a cyano group, an amide group, a carboxyl group and a carbonyl group. Hammett values of these substituents are as follows: trifluoromethyl group (—CF₃, m: 0.43, p: 0.54); halogen atom [for example, —F (m:0.34, p:0.06), —Cl (m:0.37, p: 0.23), —Br (m:0.39, p:0.23), —I (m:0.35, p:0.18)]; ester group (for example, —COCH₃, o:0.37, p: 0.45); sulfoxide group (for example, —SOCH₃, m: 0.52, p: 0.45); cyano group (—CN, m: 0.56, p: 0.66), amide group (for example, —NHCOCH₃, m: 0.21, p: 0.00); carboxyl group (—COOH, m: 0.37, p: 0.45); carbonyl group (—CHO, m: 0.36, p:(0.43)). The descriptions contained in the parentheses represent positions for introducing the substituents into the aryl skeleton and Hammett values thereof, and “(m: 0.50)”, for example, represents that the Hammett value of the relevant substituent introduced in the meta-position is 0.50.

Among these substituents, nonionic substituents such as a halogen atom and an alkyl halide group are preferable in view of hydrophobicity. Among nonionic substituents, —Cl is preferable in view of reactivity, and —F, —CF₃, —Cl and —Br are preferable in view of providing hydrophobicity to the film.

These substituents may be introduced in any one of three aryl skeletons in the triarylsulfonium salt structure, or may be introduced into two or more aryl skeletons thereof. Further, one or plural substituents may be introduced into the individual three aryl skeletons. Positions for substitution and the number of substituents are not particularly specified as long as the sum of the Hammett values of the substituents introduced into the aryl skeletons is greater than 0.46. For example, one substituent having a particularly large Hammett value (a Hammett value exceeding 0.46 on its own) may be introduced into one of the aryl skeletons of the triarylsulfonium salt structure, or alternatively, plural substituents may be introduced so that the sum of the Hammett values thereof exceeds 0.46.

As described above, the Hammett values of the substituents vary depending on positions where they are introduced, and therefore, the sum of the Hammett values of the triarylsulfonium salt initiator will be determined according to the types of substituents, positions for introduction and the number of introduced substituents.

It should be noted that a Hammett side is usually represented by m-position, p-position, however, in the invention, as an indication of the electron attracting property, an effect of a substituent at o-position is considered as the same as that at p-position in calculation.

Among the specific sulfonium salts, a sulfonium salt substituted at three positions by chloro groups is most preferable, and specifically, a sulfonium salt having a triarylsulfonium salt structure where —Cl is introduced into each of three aryl skeletons is preferable.

Examples of a counter anion of the sulfonium salt preferably usable, in view of stability, in the invention include sulfonic acid anion, benzoylformic acid anion, PF₆⁻, BF₄⁻, ClO₄⁻, carboxylic acid anion, sulfinic acid anion, sulfuric acid anion, borate anion, halogen anion, phosphoric acid anion, phosphonic acid anion, phosphinic acid anion, active imide anion, polymeric sulfonic acid anion and polymeric carboxylic acid anion. It should be noted that a hydrophilicity/hydrophobicity parameter log P of the counter anion is preferably less than 2, in view point of effective suppression of scumming in the non-image areas, which is achieved by the recording layer being quickly removed and dispersed in a developing solution to expose a hydrophilic surface of a support with no residual film remaining thereon. More preferably, a value of log P is in a range from −1 to 1 in view of alkali developability and a film forming property.

Here, log P of the anion refers to log P of the log P of an acidic compound when the anion exists in the form of the acidic compound. In the invention, the hydrophilicity/hydrophobicity parameter log P of the anion moiety means a common logarithm of a partition coefficient P of the acidic compound including the anion moiety, and is a physical property value representing, as a quantitative value, how a certain organic compound is distributed at equilibrium in a two-phase system containing an oil (typically, 1-octanol) and water, which can be found by the following equation:
log P=log(Coil/Cwater),
where Coil represents a mol concentration in oil phase and Cwater represents a mol concentration in water phase. A larger absolute value of log P in a positive direction from 0 represents a greater solubility in oil, whereas a larger absolute value of log P in a negative direction from 0 represents a greater solubility in water. There is a negative correlation between this value and a water-solubility of an organic compound, and this value is widely used as a parameter for estimating hydrophilicity/hydrophobicity of a compound. In principle, log P values are empirically measured in a distribution experiment. However, since this experiment is complicated, log P values value are usually obtained using an on-line database containing actual measurement values or calculation software for estimating log P values from structural formulae. The invention uses values calculated by using a log P value estimating program: CLOGP, developed by MedChem Project by C. Hansch, A. Leo, et al. from Pomona College, U.S.A. and Biobyte Corporation (CLOGP program: algorithm=4.01, fragment database=17, incorporated into a system: PCModels (ver. 1.02) provided by Daylight Chemical Information Systems, Inc.).

It should be noted that the most preferable aspect of the sulfonium salt used in the invention includes compounds having the above-described cation structure and the anion structure where the hydrophilicity/hydrophobicity parameter log P is less than 2.

In the invention, typical examples of the favorable sulfonium salts represented by General Formula (x) [exemplary compounds (1) to (101)] are listed below, but the invention is not restricted thereto:

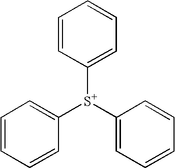

σ = 0.00

| | | |
|---|---|---|
| (1) | HOSO₃⁻ | −2.174 |
| (2) | CH₃SO₃⁻ | −1.224 |
| (3) | C₄H₉SO₃⁻ | 0.363 |
| (4) | C₁₄H₂₉SO₃^{—} | 4.453 |
| (5) | CH₂ClCOO⁻ | 0.081 |
| (6) | CF₃SO₃⁻ | 0.885 |
| (7) | C₈F₁₇SO₃⁻ | 2.275 |
| (8) | 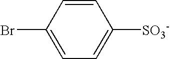 | 0.218 |
| (9) | 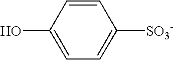 | −1.312 |
| (10) | 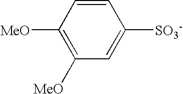 | −0.987 |
| (11) | 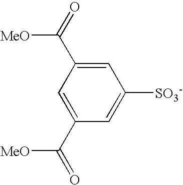 | −0.707 |
| (12) | 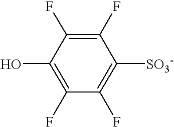 | −0.760 |
| (13) | 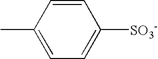 | −0.146 |
| (14) | 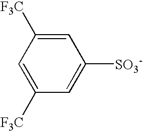 | 1.121 |
| (15) | 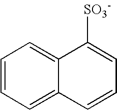 | 0.529 |
| (16) | 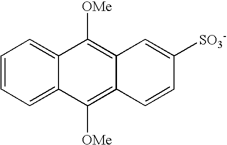 | 1.711 |
| (17) | 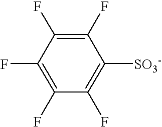 | −0.140 |
| (18) | 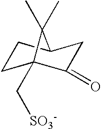 | 0.636 |
| (19) | H₂N—SO₃⁻ | −2.358 |
| (20) | 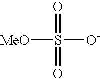 | −1.298 |
| (21) | 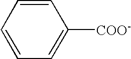 | 1.885 |
| (22) | 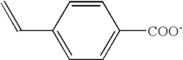 | 2.609 |
| (23) | 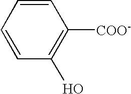 | 2.187 |
| (24) | 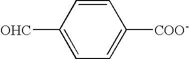 | 2.609 |
| (25) | 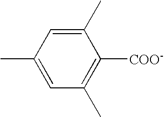 | 2.782 |
| (26) | 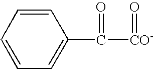 | 1.225 |
| (27) | 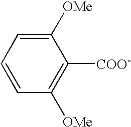 | 1.155 |
| (28) | 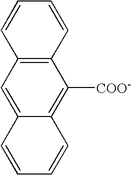 | 4.233 |
| (29) | 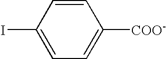 | 3.106 |
| (30) | 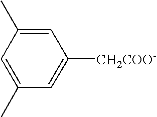 | 2.412 |
| (31) | 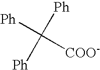 | 4.200 |
| (32) | 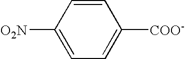 | 1.838 |
| (33) | CF₃COO⁻ | 0.365 |
| (34) | 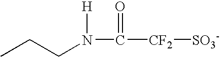 | −0.303 |
| (35) | HCOO⁻ | −0.540 |
| (36) | CH₃COO⁻ | −0.194 |
| (37) | 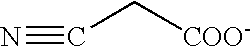 | −0.828 |
| (38) | 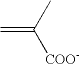 | 0.660 |
| (39) | 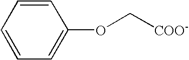 | 1.350 |
| (40) | 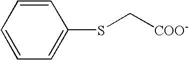 | 1.884 |
| (41) | 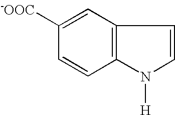 | 2.067 |
| (42) | 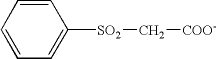 | 0.445 |
| (43) | 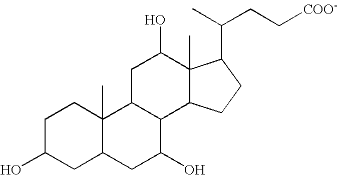 | 2.427 |
| (44) | 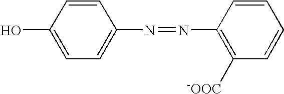 | 3.776 |
| (45) | 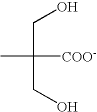 | −0.646 |
| (46) | 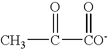 | −0.194 |
| (47) | 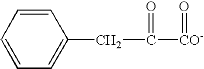 | 0.524 |
| (48) | 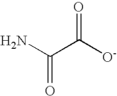 | −2.787 |
| (49) | 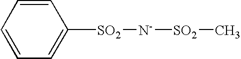 | −1.389 |
| (50) | 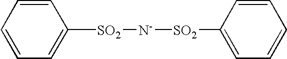 | 0.520 |
| (51) | 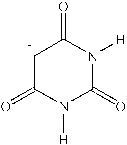 | −1.441 |
| (52) | 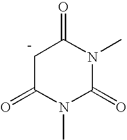 | −0.779 |
| (53) | 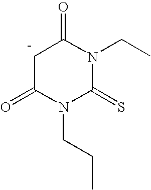 | 0.802 |
| (54) | 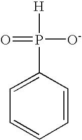 | −0.723 |
| (55) | 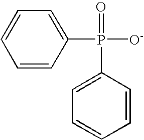 | 1.115 |
| (56) | 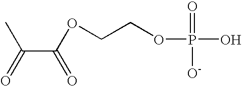 | −0.927 |
| (57) | ClO₄⁻ | |
| (58) | BF₄⁻ | |
| (59) | PF₆⁻ | |
| (60) | AsF₆⁻ | |
| (61) | SbF₆⁻ | |
| (62) | 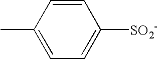 | 0.205 |
| (63) | 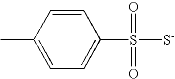 | 1.598 |
| (64) | 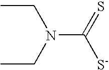 | 0.590 |
| (65) | 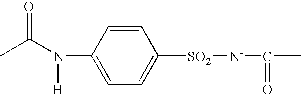 | −0.750 |

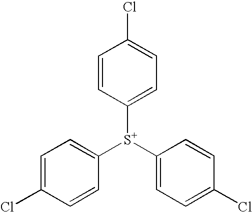

0.69

| | | |
|---|---|---|
| (66) | 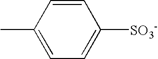 | −0.146 |
| (67) | 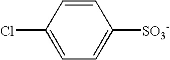 | 0.068 |
| (68) | 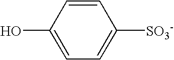 | −1.312 |
| (69) | 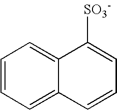 | 0.529 |
| (70) | 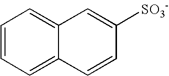 | 0.529 |
| (71) | 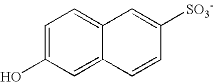 | −0.138 |
| (72) | 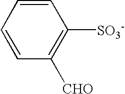 | −1.292 |
| (73) | 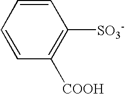 | −0.902 |
| (74) | 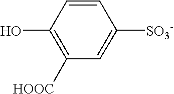 | −0.600 |
| (75) | 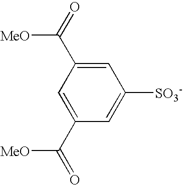 | −0.707 |
| (76) | 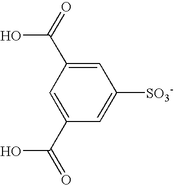 | −0.935 |
| (77) | 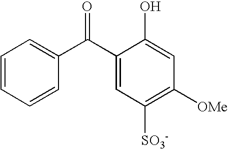 | 0.799 |
| (78) | 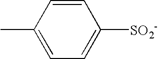 | 0.205 |
| (79) | 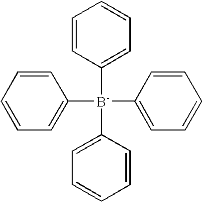 | |
| (80) | PF₆⁻ | |
| (81) | Br⁻ | |
| (82) | I⁻ | |
| (83) | 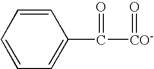 | 1.225 |

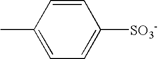

log P.
−0.146

| | | |
|---|---|---|
| (84) | 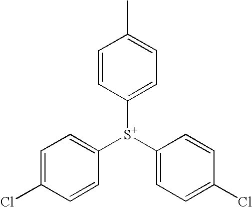 | 0.29 |
| (85) | 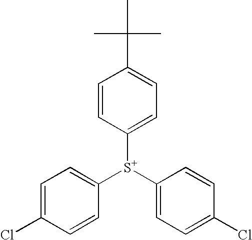 | 0.26 |
| (86) | 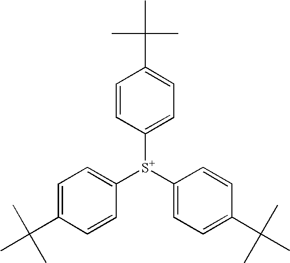 | −0.59 |
| (87) | 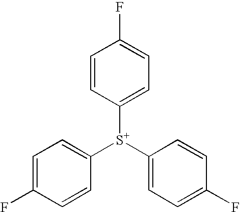 | 0.186 |
| (88) | 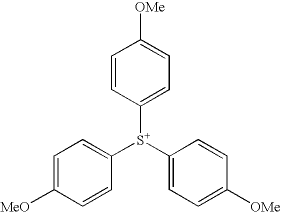 | −0.804 |
| (89) | 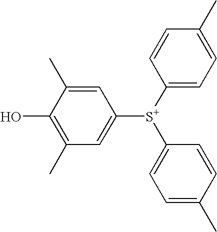 | −0.848 |
| (90) | 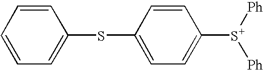 | |
| (91) | 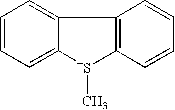 | |
| (92) | 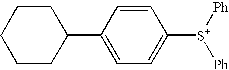 | |
| (93) | 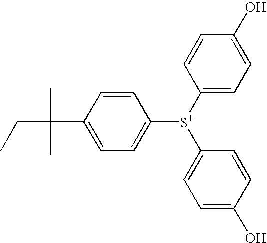 | |
| (94) | 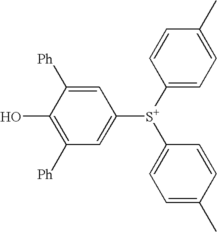 | |
| (95) | 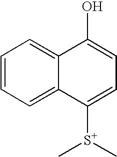 | |
| (96) | 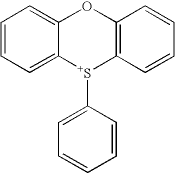 | |
| (97) | 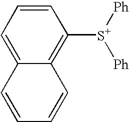 | |
| (98) | 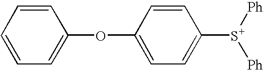 | |
| (99) | 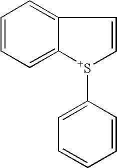 | |
| (100) | 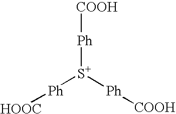 | |
| | (*COOH at p-position) | |
| (101) | 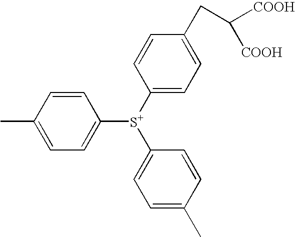 | |

The sulfonium salt (C) for use in the invention preferably has a maximum absorption wavelength of 400 nm or less and more preferably 360 nm or less. By bringing the absorption maximum wavelength into the ultraviolet region in this manner, it becomes possible to handle the photosensitive composition under white light.

The sulfonium salts (C) according to the invention may be used alone or in combination of two or more. When the photosensitive composition according to the invention is applied to a recording layer of planographic printing plate precursor, these sulfonium salts (C) may be added into the same layer together with other components or into another layer separately therefrom.

The sulfonium salts (C) favorably used in the invention include those containing a sulfonate or carboxylate anion as the counter anion.

The sulfonium salt (C) according to the invention may be added in an amount of 0.1 to 50% by weight, preferably 0.5 to 40% by weight, and particularly preferably 1 to 30% by weight with respect to the total solid matter in photosensitive composition from the viewpoints of sensitivity and elimination of interaction.

Typical examples of the sulfonium salts represented by General Formula (II) favorably used in the present embodiment are the same as those of the sulfonium salts represented by General Formula (x) described in the first embodiment [exemplary compounds (1) to (101)], and thus the description thereof is omitted.

In addition, the properties such as maximum absorption wavelength of the sulfonium salts obtained in the present embodiment and the addition amount thereof with respect to the total solid matters in positive-type image-recording layer are also the same as those for the sulfonium salt (D) in the first embodiment, and the description thereof is omitted.

[Infrared Absorbing Agent (B)]

Infrared-absorbing dyes or pigments having an absorption maximum wavelength in the range of 760 nm to 1,200 nm are favorably used as the infrared absorbing agent (B) usable in the photosensitive composition according to the invention, from the viewpoint of compatibility with high-output lasers, i.e., readily available exposure-light sources.

The dyes may be commercially available ones and, for example, known ones described in publications such as “Dye Handbook” (edited by the Society of Synthesis Organic Chemistry, Japan, and published in 1970). Specific examples thereof include azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squalirium dyes, pyrylium dyes, metal thiolate complexes, oxonol dyes, diimonium dyes, aminium dyes, and croconium dyes.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squalirium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentamethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squalirium dyes, pyrylium salts, thiopyrylium dyes, and nickel thiolate complexes. Dyes represented by the following general formulae (a) to (e) are also preferable since such dyes are excellent in terms of photothermal conversion efficiency. The cyanine dyes represented by the following general formula (S-1) are most preferable for the following reason: when the dyes are used in the photosensitive composition of the invention, the dyes manifest a high degree of interaction with the alkali-soluble resin, and the dyes are also excellent in terms of stability and economy.
General formula (S-1)

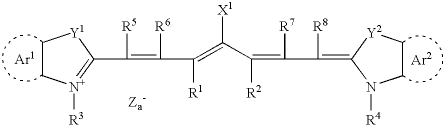

In general formula (S-1), X¹ represents a hydrogen atom, a halogen atom, —NPh₂, X²-L¹ (wherein X² represents an oxygen atom or a sulfur atom, L¹ represents a hydrocarbon group having 1 to 12 carbon atoms, an aromatic cyclic group having a heteroatom, or a hydrocarbon group containing a heteroatom and having 1 to 12 carbon atoms, and the heteroatom referred to herein is N, S, O, a halogen atom, or Se), or a group represented by the following: 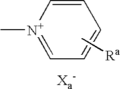
wherein Xa⁻ has the same definition as Za⁻, which will be described at a later time, and R^{a} represents a substituent selected from a hydrogen atom, an alkyl group, an aryl group, a substituted or unsubstituted amino group, or a halogen atom;

R¹ and R² each independently represents a hydrocarbon group having 1 to 12 carbon atoms, and from the viewpoint of the storage stability of the photosensitive composition of the invention when it is used in a coating solution for forming a recording layer of a planographic printing plate precursor, it is preferable that R¹ and R² each independently represents a hydrocarbon group having 2 or more carbon atoms, and more preferably R¹ and R² are bonded to each other to form a 5-membered or 6-membered ring.

Ar¹ and Ar², which may be the same or different, each represent an aromatic hydrocarbon group which may have a substituent. Preferable examples of the aromatic hydrocarbon group include benzene and naphthalene rings. Preferable examples of the substituent include hydrocarbon groups having 12 or less carbon atoms, halogen atoms, and alkoxy groups having 12 or less carbon atoms.

Y¹ and Y², which may be the same or different, each represents a sulfur atom, or a dialkylmethylene group having 12 or less carbon atoms.

R³ and R⁴, which may be the same or different, each represents a hydrocarbon group which has 20 or less carbon atoms and may have a substituent. Preferable examples of the substituent include alkoxy groups having 12 or less carbon atoms, a carboxyl group, and a sulfo group. R⁵, R⁶, R⁷ and R⁸, which may be the same or different, each represents a hydrogen atom, or a hydrocarbon group having 12 or less carbon atoms, and since the raw materials thereof can easily be obtained, each preferably represents a hydrogen atom.

Za⁻ represents a counter anion. However, in a case where the cyanine dye represented by general formula (S-1) has an anionic substituent in the structure thereof and there is accordingly no need to neutralize electric charges in the dye, Za⁻ is not required. From the viewpoint of the storage stability of the recording layer coating solution, Za⁻ is preferably an ion of a halogen, perchlorate, tetrafluroborate, hexafluorophosphate, carboxylate or sulfonate. From the viewpoints of compatibility of the dye with the alkali-soluble resin and solubility in the coating solution, Za⁻ is preferably a halogen ion, or an organic acid ion such as a carboxylic acid ion or sulfonic acid ion, more preferably a sulfonic acid ion, and even more preferably an arylsulfonic acid ion.

Specific examples of the cyanine dye represented by general formula (S-1), and which can be preferably used in the invention, include dyes in JP-A No. 2001-133969 (paragraphs [0017] to [0019]), JP-A No. 2002-40638 (paragraphs [0012] to [0038]), and JP-A No. 2002-23360 (paragraphs [0012] to [0023]), as well as dyes illustrated below. 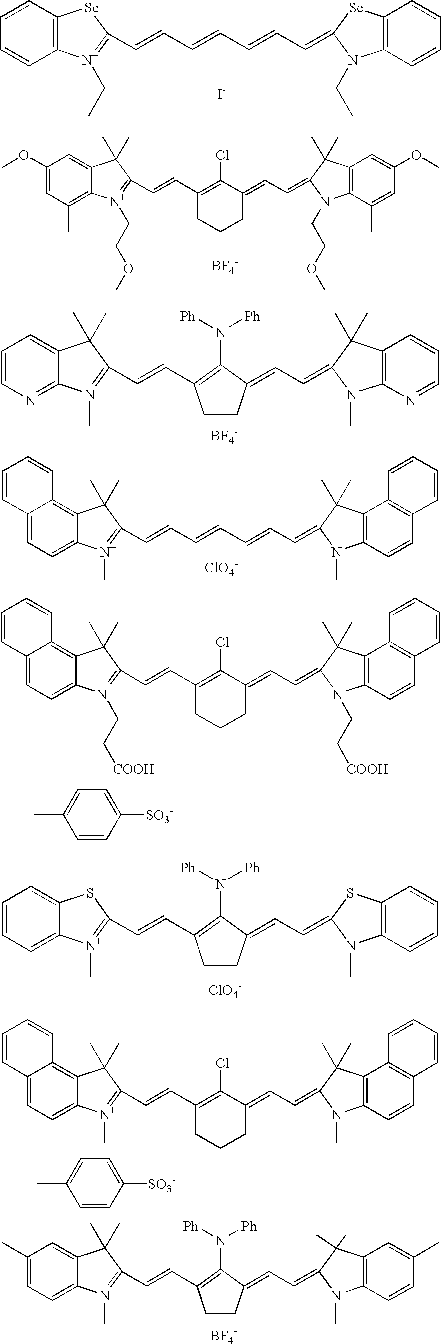 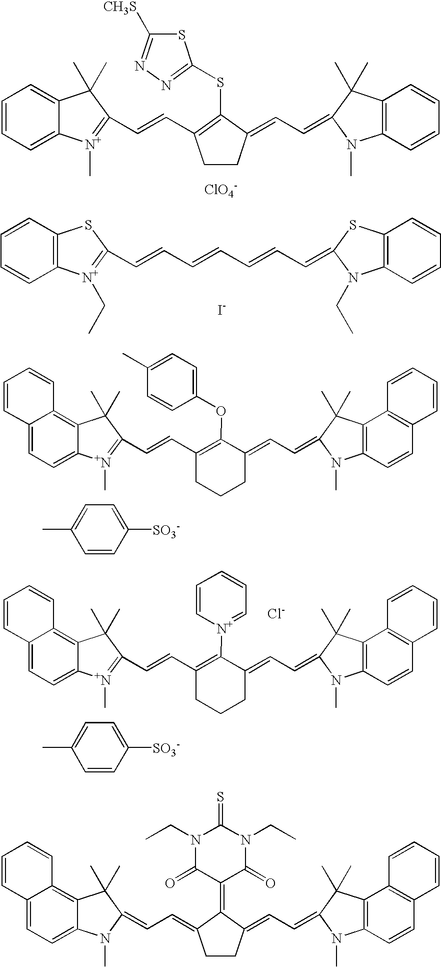
General formula (S-2)

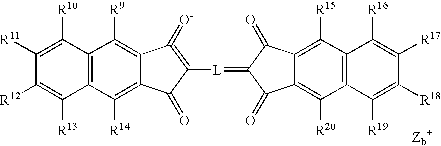

In general formula (S-2), L represents a methine chain having 7 or more conjugated carbon atoms, and the methine chain may have one or more substituent. The substituents may be bonded to each other to form a cyclic structure. Zb⁺ represents a counter cation. Preferable examples of the counter cation include ammonium, iodonium, sulfonium, phosphonium and pyridinium ions, and alkali metal cations (such as Ni⁺, K⁺ and Li⁺).

R⁹ to R¹⁴ and R¹⁵ to R²⁰ each independently represents a substituent selected from hydrogen atom, halogen atom, and cyano, alkyl, aryl, alkenyl, alkynyl, carbonyl, thio, sulfonyl, sulfinyl, oxy and amino groups; or a substituent obtained by combining two or three from among these substituents. Two or three out of R⁹ to R¹⁴ and R¹⁵ to R²⁰ may be bonded to each other to form a cyclic structure.

A dye wherein L in general formula (S-2) represents a methine chain having 7 conjugated carbon atoms, and each of R⁹ to R¹⁴ and R¹⁵ to R²⁰ represents a hydrogen atom, is preferable since such a dye can be easily obtained and exhibits advantageous effects.

Specific examples of the dye represented by general formula (S-2), and which can be preferably used in the invention, are illustrated below.

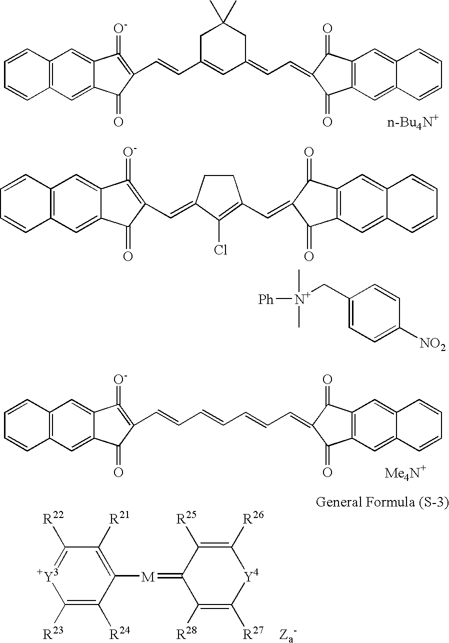

In general formula (S-3), Y³ and Y⁴ each independently represent an oxygen, sulfur, selenium or tellurium atom; M represents a methine chain having 5 or more conjugated carbon atoms; R²¹ to R²⁴ and R²⁵ to R²⁸, which may be the same or different, each represents a hydrogen or halogen atom, or a cyano, alkyl, aryl, alkenyl, alkynyl, carbonyl, thio, sulfonyl, sulfinyl, oxy or amino group; and Za⁻ represents a counter anion, and has the same meaning as Za⁻ in general formula (S-1).

Specific examples of the dye which is represented by general formula (S-3) and which can be preferably used in the invention, are illustrated below. 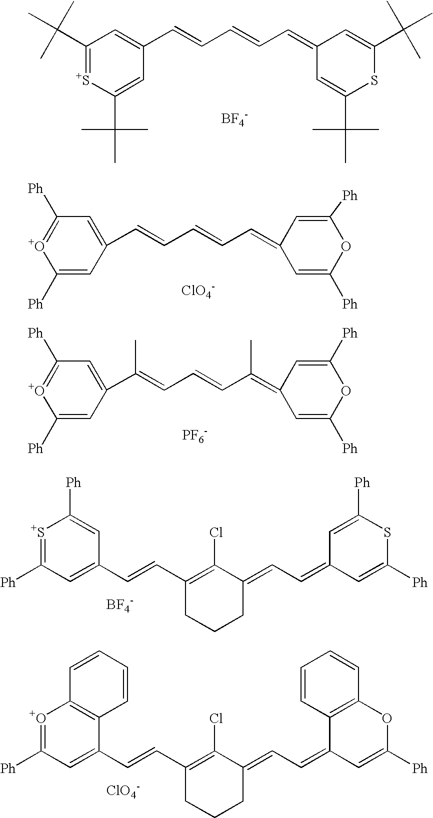
General Formula (S-4)

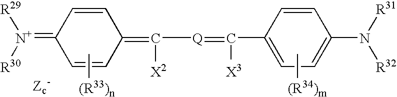

In general formula (S-4), R²⁹ to R³¹ each independently represents a hydrogen atom, an alkyl group or an aryl group; R³³ and R³⁴ each independently represents an alkyl group, a substituted oxy group, or a halogen atom; n and m each independently represents an integer of 0 to 4; and R²⁹ and R³⁰, or R³¹ and R³² may be bonded to each other to form a ring, or R²⁹ and/or R³⁰ may be bonded to R³³ to form a ring and R³¹ and/or R³² may be bonded to R³⁴ to form a ring. When plural R³³'s and R³⁴'s are present, R³³'s may be bonded to each other to form a ring, or R³⁴'s may be bonded to each other to form a ring.

X² and X³ each independently represents a hydrogen atom, an alkyl group or an aryl group, and at least one of X² and X³ represents a hydrogen atom or an alkyl group.

Q represents a trimethine group or a pentamethine group which may have a substituent, and may be combined with an bivalent linking group to form a cyclic structure. Zc⁻ represents a counter anion and has the same meanings as Za⁻ in general formula (S-1).

Specific examples of the dye represented by general formula (S-4) and which can be preferably used in the invention, are illustrated below. 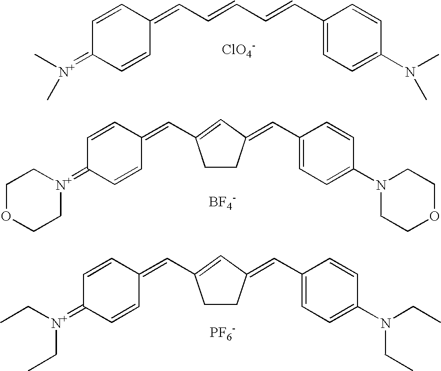
General Formula (S-5)

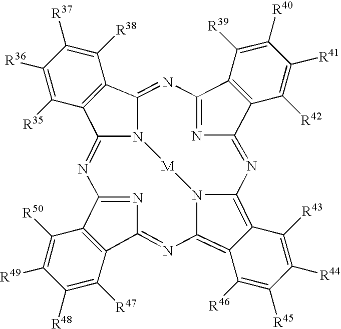

In general formula (S-5), R³⁵ to R⁵⁰ each independently represents a hydrogen or halogen atom, or a cyano, alkyl, aryl, alkenyl, alkynyl, hydroxyl, carbonyl, thio, sulfonyl, sulfinyl, oxy or amino group, or an onium salt structure, each of which may have a substituent; M represents two hydrogen atoms, a metal atom, a halo metal group, or an oxy metal group. Examples of the metal contained therein include atoms in IA, IIA, IIIB and IVB groups in the periodic table, transition metals in the first, second and third periods therein, and lanthanoid elements. Among these examples, preferable are copper, magnesium, iron, zinc, cobalt, aluminum, titanium, and vanadium.

Specific examples of the dye represented by general formula (S-5) and which can be preferably used in the invention, are illustrated below.

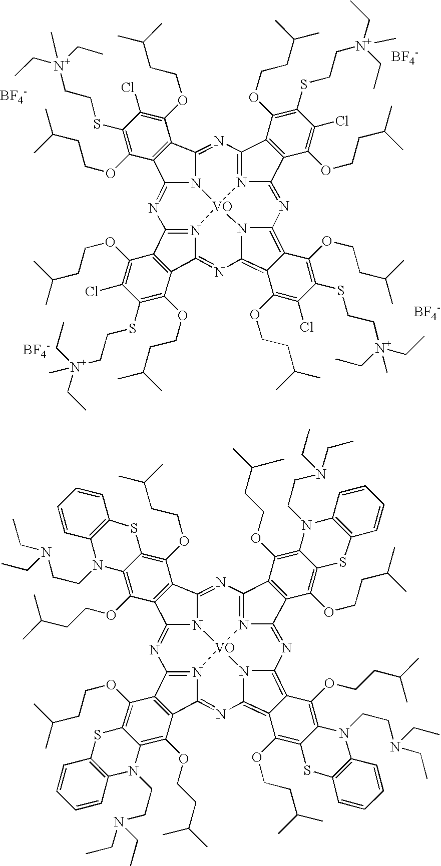

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments, nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Technique” (by CMC Publishing Co., Ltd. in 1986.

The particle size of the pigment is preferably from 0.01 to 10 μm, more preferably from 0.05 to 1 μm, and even more preferably from 0.1 to 1 μm. When a particle size is within the preferable range, a superior dispersion stability of the pigment in the photosensitive composition can be obtained, whereby, when the photosensitive composition of the invention is used for a recording layer of the photosensitive printing plate precursor, it is possible to form a homogeneous recording layer.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

From the viewpoints of sensitivity, uniformity of the film to be formed and durability, the pigment or dye can be added to the photosensitive composition in a ratio of 0.01 to 50%, preferably 0.1 to 10%, and more preferably 0.5 to 10% (in the case of the dye) or 0.1 to 10% (in the case of pigment) by mass, relative to the total solid contents which constitute the photosensitive composition.

[Other Components]

Besides the essential components above, the photosensitive composition according to the invention may further contain other components as needed. Examples thereof include thermal degradable compounds such as onium salts, o-quinone diazide compounds, aromatic sulfone compounds, aromatic sulfonic ester compounds, and the like, and combined use of a material (thermally decomposable solubilization inhibitor) that practically reduces the solubility of alkali-soluble resin when not decomposed, is preferable for further reducing the solubilization thereof in the image region into the developer.

[Onium Salt]

Examples of the onium salts which are used as the other component in the photosensitive composition according to the invention include diazonium salts, ammonium salts, phosphonium salts, iodonium salts, selenonium salts, arsonium salts, and the like.

Preferable examples of the onium salt used in the invention include diazonium salts described in S. I. Schlesinger, Photogr. Sci. Eng., 18, 387 (1974), T. S. Bal et al., Polymer, 21, 423 (1980), and JP-A No. 5-158230; ammonium salts described in U.S. Pat. Nos. 4,069,055 and 4,069,056, and JP-A No. 3-140140; phosphonium salts described in D. C. Necker et al., Macromolecules, 17, 2468 (1984), C. S. Wen et al., Teh, Proc. Conf. Rad. Curing ASIA, p478 Tokyo, October (1988), and U.S. Pat. Nos. 4,069,055 and 4,069,056; iodonium salts described in J. V. Crivello et al., Macromolecules, 10 (6), 1307 (1977), Chem. & Eng. News, Nov. 28, p31 (1988), EP No. 104,143, U.S. Pat. Nos. 5,041,358 and 4,491,628, and JP-A Nos. 2-150848 and 2-296514; sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromolecules, 14 (5), 1141 (1981), J. V. Crivello et al., J. Polymer Sci., Polymer Chem. Ed., 17, 2877 (1979), EP Nos. 370,693, 233,567, 297,443 and 297,442, U.S. Pat. Nos. 4,933,377, 3,902,114, 5,041,358, 4,491,628, 4,760,013, 4,734,444 and 2,833,827, and DE Patent Nos. 2,904,626, 3,604,580 and 3,604,581; selenonium salts described in J. V. Crivello et al., Macromolecules, 10 (6), 1307 (1977), J. V. Crivello et al., J. Polymer Sci., Polymer Chem. Ed., 17, 1047 (1979); arsonium salts described in C. S. Wen et al., and The Proc. Conf. Rad. Curing ASIA, p478, Tokyo, October (1988).

Among such onium salts, diazonium salts are particularly preferable. The diazonium salts disclosed in the JP-A No. 5-158230 are the most preferable.

Examples of the counter ion of the onium salt include tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid, and p-toluenesulfonic acid. Among these examples, hexafluorophosphoric acid, and alkylaromatic sulfonic acids such as triisopropylnaphthalenesulfonic acid and 2,5-dimethylbezenesulfonic acid are particularly preferable.

The amount of the onium salt added is preferably in the range of 0.1 to 10%, still more preferably 0.1 to 5%, and particularly preferably 0.1 to 2% by weight with respect to the total solid matter in the image-recording layer.

These onium salts may be used alone or as a mixture of several salts.

[o-Quinone Diazide Compound]

o-Quinone diazide compound for use in the photosensitive composition according to the invention is, for example, a compound having at least one o-quinone diazide group that becomes more alkali soluble by thermal decomposition, and such compounds in various structures may be used. Namely, o-quinone diazide makes the photosensitive composition more soluble by thermal decomposition, both by reducing the solubilization-inhibiting potential of novolak resin (A) and specific alkali-soluble resin (B) and converting itself to an alkali-soluble material. Examples of the o-quinone diazide compounds for use in the invention include the compounds described on pp. 339 to 352 of “Light Sensitive Systems” (J. Corsair Ed., John Wiley & Sons. Inc.), and in particular, sulfonic esters or sulfonic acid amides of the o-quinone diazides, which are prepared in reaction with various aromatic polyhydroxy compounds or aromatic amino compounds, are favorable. In addition, the esters from benzoquinone-(1,2)-diazido-sulfonylchloride or naphthoquinone-(1,2)-diazido-5-sulfonylchloride and a pyrogallol-acetone resin described in JP-B No. 43-28403, and the esters from benzoquinone-(1,2)-diazido-sulfonylchloride or naphthoquinone-(1,2)-diazido-5-sulfonylchloride and a phenol-formaldehyde resin described in U.S. Pat. Nos. 3,046,120 and 3,188,210 are also favorably used.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803, 48-96575, 49-38701 and 48-13354, JP-B No. 41-11222, 45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Patent No. 854,890.

The amount of the o-quinone diazide compound added is preferably in the range of 0 to 10%, still more preferably 0 to 5%, and particularly preferably 0 to 2% by weight with respect to the total solid matter in photosensitive composition.

These o-quinone diazide compounds may be used alone or as a mixture of several compounds.

The amount of the thermally decomposable solubilization inhibitors excluding the onium salt and o-quinone diazide compound above is preferably 0 to 5%, still more preferably 0 to 2, and particularly preferably 0.1 to 1.5% by weight with respect to the total solid matters in photosensitive composition.

[Other Additives]

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No. 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No.60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to a recording layer of a planographic printing plate precursor, the ratio thereof in the recording layer is preferably from 0.05 to 20%, more preferably from 0.1 to 15%, and even more preferably from 0.1 to 10% by mass.

When the photosensitive composition according to the invention is used in a recording layer coating solution for a planographic printing plate precursor, in order to enhance stability in processes which affect conditions of developing, the following can be added: nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 11-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the photosensitive composition is preferably from 0.05 to 15% by mass, and more preferably from 0.1 to 5% by mass.

To the photosensitive composition of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

As the image coloring agent, a dye different from the above-mentioned salt-formable organic dye may be used. Preferable examples of such a dye, and of the salt-formable organic dye, include oil-soluble dyes and basic dyes.

Specific examples thereof include Oil yellow #101, Oil Yellow #103, Oil Pink #312, Oil Green BG, Oil Blue BOS, Oil Blue #603, Oil Black BY, Oil Black BS, and Oil Black T-505 (each of which is manufactured by Orient Chemical Industries Ltd.); Victoria Pure Blue, Crystal Violet (CI42555), Methyl Violet (CI42535), Ethyl Violet, Rhodamine B (CI145170B), Malachite Green (CI42000), and Methylene Blue (CI52015).

Dyes described in JP-A No.62-293247 are particularly preferable. These dyes may be added to the photosensitive composition at a ratio of 0.01 to 10% by mass, and preferably 0.1 to 3% by mass, relative to the total solid contents therein.

Whenever necessary, a plasticizer may be added to the photosensitive composition of the invention to give flexibility to a coating film made from the composition. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

In addition to the above, the following may be appropriately added to the composition, depending on the objective: an epoxy compound; a vinyl ether; a phenol compound having a hydroxymethyl group and a phenol compound having an alkoxymethyl group, described in JP-A No. 8-276558; and a cross-linkable compound having an effect of suppressing dissolution in an alkali, described in JP-A No. 11-160860, and which was previously proposed by the present inventors.

The photosensitive composition according to the invention can be applied to various recording materials in various applications such as planographic printing plate precursor, color-proof materials, and display material, by dissolving the respective components in a suitable solvent and applying the solution onto a support. In particular, it is useful as a heat mode-compatible positive-type planographic printing plate precursor that allows direct plate making by infrared laser exposure.

[Planographic Printing Plate Precursor]

Hereinafter, typical embodiments of the planographic printing plate according to the invention precursor will be described by taking application thereof to a planographic printing plate precursor as an example.

[Image-Forming Layer]

The planographic printing plate precursor to which the image-forming material according to the invention is applied can be prepared by dissolving components for photosensitive layer (image-forming layer)-coating solution in a solvent and applying the resulting solution onto a suitable support. A protective layer, resin intermediate layer, or backcoat layer can also be formed similarly according to applications.

Typical examples, concentration, and others of the solvent used are the same as those of the “solvents for photosensitive layer-coating solution” in the first embodiment above, and the description thereof is omitted.

The amount of the coated layer on support obtained after application and drying (solid matter) may vary according to applications, but is generally, preferably 0.5 to 5.0 g/m² in the case of the recording layer of planographic printing plate precursors. Decrease in the coating amount leads to apparent increase in sensitivity but also to deterioration in the film properties of image-forming layer.

Further, the recording layer may be a single layer or a layer in the multilayer structure.

Any one of various coating methods: for example, bar coater coating, spin coating, spray coating, curtain coating, dip coating, air knife coating, blade coating, roll coating, and the like, may be used as the coating method.

In addition, a surfactant for improvement in coating property, for example, one of the fluorochemical surfactants described in JP-A No. 62-170950, may be added to the image-forming layer according to the invention. The preferable addition amount is 0.01 to 1% and still more preferably 0.05 to 0.5% by weight with respect to the total solid matters.

[Resin Intermediate Layer]

The planographic printing plate precursor may have a resin intermediate layer as needed between the image-forming layer and the support. The resin intermediate layer in the present embodiment is the same as the resin intermediate layer described in the first embodiment above, and the description thereof is omitted.

[Support and Undercoat Layer]

The support for use and the undercoat layer in the invention are also the same as the support and the undercoat layer described in the first embodiment above, and the description thereof is omitted.

[Exposure and Development]

The positive-type planographic printing plate precursor prepared as described above is normally subjected to image exposure and development. The exposure and development in the present embodiment are the same as those described in the first embodiment above, and the description thereof is omitted.

### EXAMPLES

Hereinafter, the present invention will be described in detail with reference to Examples, but it should be understood that the invention is not limited to the Examples.

(Preparation of Support)

Supports A, B, C, and D were prepared by using a JIS-A-1050 aluminum plate having a thickness of 0.3 mm in the combination of steps described below.

Supports A, B, C, and D were obtained in the steps (a) to (j) of the first embodiment described above. Then each of the supports A, B, C, and D thus obtained was subjected to an undercoating process using a hydrophilizing treatment similar to that described in the step (k) and the undercoat-coating process as described in the first embodiment above.

### Examples 1 to 8 and Comparative Examples 1 and 2

The coating solution for the first layer (lower layer), having the composition described below, was applied by using a wire bar onto the support A thus obtained to give a coating amount of 0.85 g/m² after the support A was dried in a drying oven at 150° C. for 60 seconds.

The coating solution for the second layer (upper layer), having the composition described below, was then applied onto the supporting plate having the undercoat layer thus obtained by a wire bar. After application, the support A was dried in a drying oven at 145° C. for 70 seconds, to give positive-type planographic printing plate precursors of Examples 1 to 8 and Comparative Examples 1 and 2 respectively, having total coating amounts of 1.15 g/m².

<Coating solution for first layer (lower layer)>

| | |
|---|---|
| Copolymer 1 (prepared as described below) | 2.133 g |
| Cyanine dye A (having the structure below) | 0.098 g |
| 2-Mercapto-5-methylthio-1,3,4-thiadiazole | 0.030 g |
| Cis-Δ4-tetrahydrophthalic acid anhydride | 0.100 g |
| 4,4′-Sulfonyl diphenol | 0.090 g |
| p-Toluenesulfonic acid | 0.008 g |
| Ethyl violet having | 0.100 g |
| 6-hydroxynaphthalenesulfonic acid substituted | |
| as the counter anion | |
| 3-Methoxy-4-diazodiphenylamine | 0.030 g |
| hexafluorophosphate | |
| Fluorochemical surfactant | 0.035 g |
| (Magafac F-780, manufactured by | |
| Dainippon Ink and Chemicals, Inc.) | |
| Methylethylketone | 26.6 g |
| 1-Methoxy-2-propanol | 13.6 g |
| γ-Butylolactone | 13.8 g |

| | |
|---|---|
| | Cyanine dye A |
| 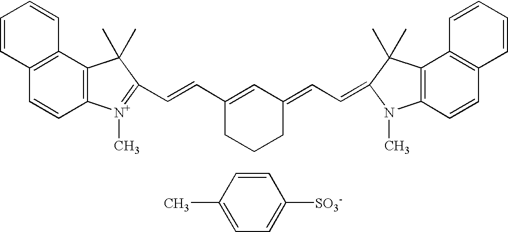 | |

<Preparation of copolymer 1>

After stirring, 31.0 g (0.36 mole) of methacrylic acid, 39.1 g (0.36 mole) of ethyl chloroformate, and 200 ml of acetonitrile were placed in a 500 ml three-necked flask equipped with a stirrer, a condenser tube, and a dropping funnel, and the mixture was stirred while being cooled in an ice water bath. 36.4 g (0.36 mole) of triethylamine was added to the mixture dropwise via a dropping funnel over the period of approximately 1 hour. After the dropwise addition, the ice water bath was removed and the mixture was stirred at room temperature for 30 minutes.

51.7 g (0.30 mole) of p-aminobenzenesulfonamide was added to the reaction mixture, and the resulting mixture was then stirred in an oil bath while heated at 70° C. for 1 hour. After completion of the reaction, the mixture was poured into 1 liter of water while stirring, and the mixture was stirred additionally for 30 minutes. The precipitate was collected by filtration of the mixture and re-suspended in 500 ml of water, and the solid obtained by filtration of this slurry was dried, to give white a solid of N-(p-aminosulfonylphenyl)methacrylamide (yield: 46.9 g).

Then, 4.61 g (0.0192 mole) of N-(p-aminosulfonylphenyl) methacrylamide, 2.58 g (0.0258 mole) of ethyl methacrylate, 0.80 g (0.015 mole) of acrylonitrile, and 20 g of N,N-dimethylacetamide were placed in a 20 ml three-necked flask equipped with a stirrer, a condenser tube, and a dropping funnel, and the mixture was stirred while heated in a hot water bath at 65° C.

To the mixture, 0.15 g of 2,2′-azobis(2,4-dimethylvaleronitrile)(brand name: “V-65”, manufactured by Wako Pure Chemical Industries) was added as a polymerization initiator, and the mixture was stirred at 65° C. under a nitrogen stream for 2 hours.

Further, a mixture of 4.61 g of N-(p-aminosulfonylphenyl) methacrylamide, 2.58 g of methyl methacrylate, 0.80 g of acrylonitrile, 20 g of N,N-dimethylacetamide and 0.15 g of “V-65” was added dropwise via a dropping funnel to the reaction mixture over 2 hours. After dropwise addition, the mixture obtained was additionally stirred at 65° C. for 2 hours.

After completion of the reaction, 40 g of methanol was added to the mixture; the resulting mixture was cooled and poured into 2 liters of water while stirring; the resulting mixture was stirred for 30 minutes; and the precipitate obtained by filtration was dried to give 15 g of a white solid. The weight-average molecular weight (polystyrene standard) of the particular copolymer 1 as determined by gel-permeation chromatography was 54,000.

<Coating solution for second layer (upper layer)>

| | |
|---|---|
| Copolymer from ethyl methacrylate | 0.030 g |
| and 2-methacryloyloxyethylsuccinic acid | |
| (molar ratio: 67:33, weight-average molecular weight: 92,000 | |
| Particular novolak resin (compound shown in Table 1) | 0.300 g |
| Sulfonium salt (compound shown in Table 1) | 0.1 g |
| Cyanine dye A (having the structure above) | 0.015 g |
| Ethyl violet having | 0.012 g |
| 6-hydroxynaphthalenesulfonic acid | |
| substituted as the counter anion | |
| Fluorochemical surfactant | 0.022 g |
| (Magafac F-780, manufactured by | |
| Dainippon Ink and Chemicals, Inc.) | |
| Methylethylketone | 13.1 g |
| 1-Methoxy-2-propanol | 6.79 g |

[Evaluation of planographic printing plate precursor]

The development latitude, sensitivity, and, post-exposure stability of the planographic printing plate precursors were examined. Details of the evaluation methods are as follows:

1. Development Latitude

Each planographic printing plate precursor obtained was kept under conditions of a temperature of 25° C. and a relative humidity of 50% for 5 days, and a test pattern was formed on the planographic printing plate precursor obtained in Trendsetter 3244 VX manufactured by Creo at a beam intensity of 9 W and a drum rotational velocity of 130 rpm.

Then, the planographic printing plate precursor was developed at a constant liquid temperature of 30° C. and a development period of 22 seconds in a PS Processor 900H manufactured by Fuji Photo Film Co. Ltd., that contained a diluted solution of the alkaline developer A or B, having the compositions set out below, of which the electrical conductivity was adjusted by changing the amount of water and thus the dilution rate. The difference between the maximum and minimum values of electrical conductivity of the developer that provided good development, without any solubilization of the image regions and without stains and discoloration derived from in poorly developed remaining photosensitive layer, was determined as the development latitude during the development above,

<Composition of alkaline developer A>

| | |
|---|---|
| SiO₂—K₂O [K₂O/SiO₂ = 1/1 (molar ratio)] | 4.0% by weight |
| Citric acid | 0.5% by weight |
| Polyethylene glycol laurylether | 0.5% by weight |
| (weight-average molecular weight: 1,000) | |
| Water | 95.0% by weight |

<Composition of alkaline developer B>

| | |
|---|---|
| D-sorbit | 2.5% by weight |
| Sodium hydroxide | 0.85% by weight |
| Polyethylene glycol laurylether | 0.5% by weight |
| (weight-average molecular weight: 1,000) | |
| Water | 96.15% by weight |

2. Sensitivity

Test patterns of an image were drawn at different exposure energies on the planographic printing plate precursor obtained with a Trendsetter 3244 VX manufactured by Creo.

Subsequently, the patterns were developed using an alkaline developer having an intermediate (average value) in electrical conductivity between the maximum and minimum values of the electrical conductivity of the developer that provided the image of good development without any solubilization of the image regions and without stains and discoloration derived from poorly developed remaining photosensitive layer, during evaluation of the development latitude above. The exposure quantity (beam intensity at a drum rotational velocity of 130 rpm) that allowed development of non-image regions using this developer was determined and designated as the sensitivity. The smaller the value, the higher the sensitivity.

3. Post-Exposure Stability

After exposure the planographic printing plate precursors were kept in an environment of 25° C. and a relative humidity of 70% for one hour, and then the sensitivity thereof was evaluated in a similar manner to the sensitivity evaluation above. The degree of decrease in sensitivity from that immediately after exposure was used as an indicator for the sensitivity retention. The post-exposure stability represents the sensitivity 1 hour after exposure, and when it is close to the sensitivity immediately after exposure, the plate precursor has a better residual retention.

### Evaluation of the Planographic Printing Plate Precursors of Examples 1 to 8 and Comparative Examples 1 and 2

The development latitude, sensitivity, and post-exposure stability of each of the planographic printing plate precursors obtained in Examples 11 to 8 and Comparative Examples 1 and 2 were evaluated by the methods described above. The developer used was developer B. Results are summarized in Table 1.

The particular novolak resins (A) (P1 and P2) shown in the following Table 1, and the novolak resin (C1) outside the scope of the invention, are as follows:

Novolak resin P1: phenol cresol-formaldehyde novolak (phenol:m-cresol:p-cresol:30: 30: 40, weight-average molecular weight: 5,500)

Novolak resin P2: phenol cresol-formaldehyde novolak (phenol:m-cresol:p-cresol:60:30:10, weight-average molecular weight: 7,700)

Novolak resin C1: cresol-formaldehyde novolak (m-cresol:p-cresol:60:40, weight-average molecular weight: 5,000)

TABLE 1

| | | | | | Development |
|---|---|---|---|---|---|
| | Novolak | | | Post-exposure | latitude |
| | resin | Sulfonium salt | Sensitivity (w) | stability (W) | (mS/cm) |
| Example 1 | P1 | 13 | 5.5 | 5.8 | 8 |
| Example 2 | P1 | 11 | 5.5 | 5.8 | 8 |
| Example 3 | P1 | 15 | 5.5 | 5.8 | 8 |
| Example 4 | P1 | 21 | 5.5 | 5.8 | 8 |
| Example 5 | P2 | 23 | 5.0 | 5.2 | 7 |
| Example 6 | P2 | 26 | 5.0 | 5.2 | 7 |
| Example 7 | P2 | 36 | 5.0 | 5.2 | 7 |
| Example 8 | P2 | 66 | 5.0 | 5.2 | 7 |
| Comparative | C1 | 13 | 6.0 | 8 | 5 |
| Example 1 | | | | | |
| Comparative | P1 | (Ammonium | 6.0 | 7.5 | 3 |
| Example 2 | | salt A) | | | |

In Comparative Example 2, the following ammonium compound A (Ammonium A) was added, replacing a sulfonium salt.

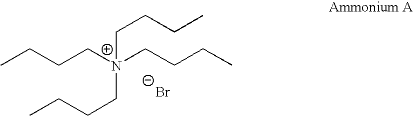

As apparent from Table 1, the planographic printing plate precursors obtained in Examples 1 to 8 are more improved in post-exposure stability while maintaining development latitude and sensitivity. In contrast, both the planographic printing plate precursors of Comparative Example 1, which uses a novolak resin containing no phenol as the structural unit replacing the particular novolak resin according to the invention, and of Comparative Example 2, which uses an ammonium salt instead of a sulfonium salt, were inferior in development latitude and post-exposure stability to those of the Examples above.

### Examples 9 to 16 and Comparative Examples 3 and 4

The coating solution for the first layer (lower layer) having the composition described below was applied by using a wire bar onto the support C to obtain a coating amount of 0.60 g/m² after drying in a drying oven at 130° C. for 60 seconds.

The coating solution for the second layer (upper layer) having the composition described below was applied onto the supporting plate having a undercoat layer obtained with a wire bar. After application, the supporting plate was dried in a drying oven at 150° C. for 60 seconds, to give positive-type plano graphic printing plate precursors having a total coating amount of 1.25 g/m² of Examples 9 to 16 and Comparative Examples 3 and 4.

<Coating solution for first layer (lower layer)>

| | |
|---|---|
| Copolymer 1 | 2.133 g |
| Cyanine dye A (having the structure as before) | 0.098 g |
| 2-Mercapto-5-methylthio-1,3,4-thiadiazole | 0.030 g |
| Cis-Δ4-tetrahydrophthalic acid anhydride | 0.100 g |
| 4,4′-Sulfonyl diphenol | 0.090 g |
| p-Toluenesulfonic acid | 0.008 g |
| Ethyl violet having | 0.100 g |
| 6-hydroxynaphthalenesulfonic acid | |
| substituted as the counter anion | |
| 3-Methoxy-4- | 0.030 g |
| diazodiphenylamine hexafluorophosphate | |
| Fluorochemical surfactant | 0.035 g |
| (Magafac F-780, manufactured by | |
| Dainippon Ink and Chemicals, Inc.) | |
| Methylethylketone | 26.6 g |
| 1-Methoxy-2-propanol | 13.6 g |
| Dimethylsulfoxide | 13.8 g |

<Coating solution for second layer (upper layer)>

| | |
|---|---|
| Copolymer from ethyl methacrylate and | 0.030 g |
| 2-methacryloyloxyethylsuccinic acid | |
| (molar ratio: 67:33, weight-average molecular weight: 92,000) | |
| Novolak resin (compound shown in Table 2) | 0.300 g |
| Sulfonium salt (compound shown in Table 2) | 0.016 g |
| Cyanine dye A (having the structure above) | 0.015 g |
| Fluorochemical surfactant | 0.022 g |
| (Magafac F-780, manufactured by | |
| Dainippon Ink and Chemicals, Inc.) | |
| Methylethylketone | 13.1 g |
| 1-Methoxy-2-propanol | 6.79 g |

### Evaluation of the Planographic Printing Plate Precursors of Examples 9 to 16 and Comparative Examples 3 and 4

Each of the planographic printing plate precursors obtained in Examples 9 to 16 and Comparative Examples 3 and 4 was evaluated by the same methods as those in Example 1. The developer used was developer B. Results are summarized in Table 2.

Details of the particular novolak resins (A) (P3 and P4) shown in the following Table 2 are as follows:

Novolak resin P3: phenol cresol-formaldehyde novolak (phenol:m-cresol:p-cresol=40:40:20, weight-average molecular weight: 5,200)

Novolak resin P4: phenol cresol-formaldehyde novolak (phenol:2,5-xylenol=70:30, weight-average molecular weight: 4,600)

Novolak resin C1 used in Comparative Example 3 was the same as that used in Comparative Example 1, and ammonium compound A (ammonium A) used in Comparative Example 4 replacing a sulfonium salt was the same as that used in Comparative Example 2.

TABLE 2

| | | | | | Development |
|---|---|---|---|---|---|
| | | Sulfonium | Sensitivity | Post-exposure | latitude |
| | Novolak resin | salt | (W) | stability (W) | (mS/cm) |
| Example 9 | P3 | 70 | 5.2 | 5.5 | 8 |
| Example 10 | P3 | 76 | 5.2 | 5.5 | 7 |
| Example 11 | P3 | 52 | 5.2 | 5.5 | 8 |
| Example 12 | P3 | 21 | 5.2 | 5.5 | 8 |
| Example 13 | P4 | 13 | 4.8 | 5.0 | 7 |
| Example 14 | P4 | 3 | 4.8 | 5.0 | 7 |
| Example 15 | P4 | 28 | 4.8 | 5.0 | 8 |
| Example 16 | P4 | 26 | 4.8 | 5.0 | 7 |
| Comparative | C1 | 70 | 5.5 | 7.5 | 5 |
| Example 3 | | | | | |
| Comparative | P1 | (Ammonium | 6.0 | 7.5 | 3 |
| Example 4 | | salt A) | | | |

As apparent from Table 2, the samples of Examples are improved in post-exposure stability while maintaining development latitude and sensitivity. In contrast, the samples in Comparative Examples 3 and 4, which do not have the particular novolak resin according to the invention or a sulfonium salt, were inferior in development latitude and post-exposure stability.

Comparison between Examples 9 to 16 plus Comparative Examples 3 and 4 and Examples 1 to 8 plus Comparative Examples 1 and 2 revealed that the advantageous effects of the invention could be obtained not only with a single layer but also with a multi-layer image-forming layer. In addition, a further increase in sensitivity and development latitude was observed by making the image-forming layer a multi-layer structure.

### Examples 17 to 24 and Comparative Examples 5 and 6

The coating solution for the first layer (lower layer) having the composition below was applied with a wire bar onto the support D to obtain a coating amount of 0.81 g/m² after the resulting support was dried in a drying oven at 150° C. for 60 seconds.

The coating solution for the second layer (upper layer) having the composition below was then applied onto the supporting plate having an undercoat layer obtained with a wire bar. After application, the support was dried in a drying oven at 150° C. for 60 seconds, to give positive-type planographic printing plate precursors having a total coating amount of 0.99 g/m² of Examples 17 to 24 and Comparative Examples 5 and 6.

<Coating solution for first layer (lower layer)>

| | |
|---|---|
| Copolymer 1 | 2.133 g |
| Cyanine dye A (having the structure above) | 0.098 g |
| Cis-Δ4-tetrahydrophthalic acid anhydride | 0.110 g |
| 4,4′-Sulfonyldiphenol | 0.090 g |
| p-Toluenesulfonic acid | 0.008 g |
| Ethyl violet having | 0.100 g |
| 6-hydroxynaphthalenesulfonic acid substitute | |
| as the counter anion | |
| 3-Methoxy-4-diazodiphenylamine | 0.030 g |
| hexafluorophosphate | |
| Fluorochemical surfactant | 0.035 g |
| (Magafac F-780, manufactured by | |
| Dainippon Ink and Chemicals, Inc.) | |
| Methylethylketone | 26.6 g |
| 1-Methoxy-2-propanol | 13.6 g |
| γ-Butylolactone | 13.8 g |

<Coating solution for second layer (upper layer)>

| | |
|---|---|
| Copolymer from ethyl methacrylate and | 0.030 g |
| 2-methacryloyloxyethylsuccinic acid | |
| (molar ratio: 67:33, weight-average molecular weight: 92,000) | |
| Novolak resin (compound shown in Table 3) | 0.300 g |
| Sulfonium salt (compound shown in Table 3) | 0.020 g |
| Cyanine dye A (having the structure as before) | 0.015 g |
| Fluorochemical surfactant | 0.022 g |
| (Magafac F-780, manufactured by | |
| Dainippon Ink and Chemicals, Inc.) | |
| Methylethylketone | 13.1 g |
| 1-Methoxy-2-propanol | 6.79 g |

### Evaluation of the Planographic Printing Plate Precursors Obtained in Examples 17 to 24 and Comparative Examples 5 and 6

The planographic printing plate precursors obtained were evaluated according to the methods above. The developer used was developer A. Results are summarized in Table 3.

Details of the particular novolak resins (A) (P5 and P6) shown in the following Table 3, and the novolak resin (C2) outside the scope of the invention, were as follows.

Novolak resin P5: phenol cresol-formaldehyde novolak (phenol:m-cresol:p-cresol:40:40:20, weight-average molecular weight: 8,000)

Novolak resin P4: phenol cresol-formaldehyde novolak (phenol:m-cresol:p-cresol:60:30:10, weight-average molecular weight: 7,700)

Novolak resin C2: cresol-formaldehyde novolak (m-cresol:p-cresol:70:30, weight-average molecular weight: 10,000)

In Comparative Example 6, the following ammonium compound B (Ammonium B) was used instead of a sulfonium salt.

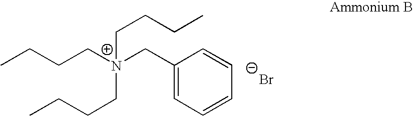

TABLE 3

| | | | | | Development |
|---|---|---|---|---|---|
| | | Sulfonium | Sensitivity | Post-exposure | latitude |
| | Novolak resin | salt | (W) | stability (W) | (mS/cm) |
| Example 17 | P5 | 75 | 5.5 | 6 | 8 |
| Example 18 | P5 | 83 | 5.5 | 6 | 7 |
| Example 19 | P5 | 15 | 5.5 | 6 | 8 |
| Example 20 | P5 | 13 | 5.5 | 6.5 | 8 |
| Example 21 | P6 | 86 | 5.5 | 6 | 7 |
| Example 22 | P6 | 88 | 5.5 | 6 | 8 |
| Example 23 | P6 | 69 | 5.5 | 6 | 8 |
| Example 24 | P6 | 6 | 5.5 | 6 | 7 |
| Comparative | C2 | 75 | 7.0 | 12 | 5 |
| Example 5 | | | | | |
| Comparative | P5 | (Ammonium | 7.0 | 8.5 | 3 |
| Example 6 | | salt B) | | | |

As apparent from Table 3, the planographic printing plate precursors of Examples 17 to 24 are improved in post-exposure stability while maintaining development latitude and sensitivity. In contrast, the samples in Comparative Examples 5 and 6, which do not have either the particular novolak resin according to the invention or a sulfonium salt, were inferior in development latitude and post-exposure stability.

### Examples 25 to 32 and Comparative Examples 7 and 8

The following image-forming layer-coating solution was applied onto supports D; and the resulting image-forming layers thus formed were dried at 150° C. for 1 minute, to give the planographic printing plate precursors of Examples 25 to 32 and Comparative Examples 7 and 8. The coating amount after drying was 1.55 g/m².

<Image-forming layer-coating solution>

| | |
|---|---|
| Novolak resin (compound shown in Table 4) | 1.0 g |
| Sulfonium salt (compound shown in Table 4) | 0.05 g |
| Cyanine dye A (having the structure above) | 0.05 g |
| Victoria Pure Blue BOH dye | 0.01 g |
| having 1-naphthalenesulfonate anion | |
| substituted as the counter anion | |
| Fluorochemical surfactant | 0.05 g |
| (Magafac F-177, manufactured by | |
| Dainippon Ink and Chemicals, Inc.) | |
| Methylethylketone | 9.0 g |
| 1-Methoxy-2-propanol | 9.0 g |

### Evaluation of the Planographic Printing Plate Precursors of Examples 25 to 32 and Comparative Examples 7 and 8

Each of the planographic printing plate precursors obtained in Examples 25 to 32 and Comparative Examples 7 and 8 was evaluated by the same methods as those in Example 1. The developer used was developer A. Results are summarized in Table 4.

Details of the particular novolak resins (A) (P7 and P8) shown in the following Table 4 are as follows:

Novolak resin P7: phenol cresol-formaldehyde novolak (phenol:m-cresol:p-cresol:20:60:20, weight-average molecular weight: 10,200)

Novolak resin P8: phenol xylenol-formaldehyde novolak (phenol: 2,5-xylenol: 60:40, weight-average molecular weight: 11,000)

The novolak resin C2 used in Comparative Example 7 was the same as that used in Comparative Example 5, and the ammonium compound B (ammonium B) used in Comparative Example 8 instead of a sulfonium salt was the same as that used in Comparative Example 6.

TABLE 4

| | | | | | Development |
|---|---|---|---|---|---|
| | | Sulfonium | Sensitivity | Post-exposure | latitude |
| | Novolak resin | salt | (W) | stability (W) | (mS/cm) |
| Example 25 | P7 | 11 | 4.0 | 4.5 | 7 |
| Example 26 | P7 | 3 | 4.0 | 4.5 | 6 |
| Example 27 | P7 | 15 | 4.0 | 4.5 | 7 |
| Example 28 | P7 | 28 | 4.0 | 4.5 | 7 |
| Example 29 | P8 | 75 | 4.0 | 4.5 | 6 |
| Example 30 | P8 | 77 | 4.0 | 4.5 | 7 |
| Example 31 | P8 | 86 | 4.0 | 4.5 | 7 |
| Example 32 | P8 | 100 | 4.0 | 4.5 | 6 |
| Comparative | C2 | 11 | 6.0 | 9 | 4 |
| Example 7 | | | | | |
| Comparative | P7 | (Ammonium | 5.0 | 7 | 2 |
| Example 8 | | salt B) | | | |

As apparent from Table 4, the planographic printing plate precursors of Examples 25 to 32 are improved in post-exposure stability while maintaining development latitude and sensitivity. In contrast, the samples in Comparative Examples 7 and 8, which do not have either the particular novolak resin according to the invention or a sulfonium salt, were inferior in development latitude and post-exposure stability.

[Evaluation of Anti-Scumming Property of Non-Image Areas]

Anti-scumming property of non-image areas were evaluated by conducitng examples 33 to 64 and comparative examples 9 to 16. In this evaluation, among the planographic printing plates obtained during the above-described evaluation, the planographic printing plates which were developed with a developer having an intermediate developing activity between the maximum and minimum electrical conductivities of the developers that successfully provided good development without stains and coloration due to residues of a poorly developed photosensitive layer in the non-image areas, were used to conduct printing on MITSUBISHI DIAMOND-TYPE F2 PRINTER (manufactured by Mitsubishi Heavy Industries., Ltd.) with DIC-GEOS (s) crimson ink to obtain 10,000 prints, and then staining on a blanket was visually evaluated. The results of the evaluation are shown in Table 5 below.

Criteria for the evaluation were:
A: no staining,
B: little staining, and

C: significant staining.

TABLE 5

| | Anti-scumming |
|---|---|
| | property |
| Example 33 | C |
| Example 34 | C |
| Example 35 | C |
| Example 36 | C |
| Example 37 | C |
| Example 38 | C |
| Example 39 | C |
| Example 40 | A |
| Example 41 | A |
| Example 42 | A |
| Example 43 | C |
| Example 44 | C |
| Example 45 | C |
| Example 46 | C |
| Example 47 | C |
| Example 48 | C |
| Example 49 | A |
| Example 50 | A |
| Example 51 | C |
| Example 52 | C |
| Example 53 | C |
| Example 54 | C |
| Example 55 | A |
| Example 56 | C |
| Example 57 | C |
| Example 58 | C |
| Example 59 | C |
| Example 60 | C |
| Example 61 | A |
| Example 62 | A |
| Example 63 | C |
| Example 64 | A |
| Comp. Example 9 | C |
| Comp. Example 10 | C |
| Comp. Example 11 | A |
| Comp. Example 12 | C |
| Comp. Example 13 | A |
| Comp. Example 14 | C |
| Comp. Example 15 | C |
| Comp. Example 16 | C |

### Third Embodiment

Hereinafter, the third embodiment of the invention will be described in detail. Note that the third embodiment is substantially the same as the first embodiement and differs therefrom only in that “the specific sulfonium salt”, i.e., a compound having a triarylsulfonium salt structure, is especially employed as the sulfonium salt. Accordingly, “Evaluation method” and “examples”, only in which the present embodiment is different from the first embodiment, will be described below.

In the present embodiment, the sulfonium salt preferably usable in the invention, i.e., the compound in which a sum of Hammett values of substituents bonded to aryl skeletons is greater then 0.46, is described in detail by way of examples. However, these examples are not intended to limit the invention. The photosensitive composition of the invention is evaluated by evaluating planographic printing plate precursors employing the photosensitive composition of the invention in the recording layer.

[Evaluation Method]

The planographic printing plate precursors were stored for 5 days under conditions of a temperature of 25° C. and a relative humidity of 50%, and a test pattern was formed imagewise on each of the planographic printing plate precursors using TRENDSETTER 3244 VX manufactured by Creo at a beam intensity of 10.0 W and a drum rotational velocity of 125 rpm.

Then, the planographic printing plate precursors were developed at a constant liquid temperature of 30° C. and a development period of 25 seconds in PS PROCESSOR 900H manufactured by Fuji Photo Film Co. Ltd., that contained a diluted solution of the alkaline developer A or B, having the compositions described in [Evaluation of development latitude] of the first embodiment, of which the electrical conductivity was adjusted by changing the content of water and thus the dilution rate in the alkali developer. Then, using planographic printing plates, which were developed with a developer having an intermediate developer activity between the maximum and minimum electrical conductivities of the developer that provided good development without dissolution of image areas and without stains and discoloration due to residues of a poorly developed photosensitive layer in non-image areas, printing was conducted on MITSUBISHI DIAMOND-TYPE F2 PRINTER (manufactured by Mitsubishi Heavy Industries., Ltd.) with DIC-GEOS (s) crimson ink to obtain 10,000 prints, and then staining on a blanket was visually evaluated.

Criteria for the evaluation were:
A: no staining,
B: little staining, and
C: significant staining.

### EXAMPLES

[Support and Undercoat Layer]

The support for use and the undercoat layer in the present embodiment are the same as the support and the undercoat layer described in the first embodiment described above, and therefore the description thereof is omitted.

### Examples 1 to 3, Comparative Examples 1 and 2

The coating solution for the first layer (lower layer), having the composition described below, was applied by using a wire bar onto the support A to give a coating amount of 0.95 g/m² after the support A was dried in a drying oven at 150° C. for 60 seconds.

The coating solution for the second layer (upper layer), having the composition described below, was then applied by a wire bar onto the support having the undercoat layer thus obtained. After application, the support A was dried in a drying oven at 130° C. for 90 seconds, to produce positive-type planographic printing plate precursors of Examples 1 to 3 and Comparative Examples 1 and 2 respectively having total coating amounts of 1.25 g/m².

<Coating solution for first layer (lower layer)>

| | | |
|---|---|---|
| Copolymer 1 (prepared as described below) | 1.833 | g |
| Cyanine dye A (having the structure below) | 0.098 | g |
| 2-Mercapto-5-methylthio-1,3,4-thiadiazole | 0.030 | g |
| Cis-Δ⁴-tetrahydrophthalic acid anhydride | 0.100 | g |
| 4,4′-Sulfonyl diphenol | 0.090 | g |
| p-Toluenesulfonic acid | 0.008 | g |
| Ethyl violet having 6-hydroxynaphthalenesulfonic acid | 0.100 | g |
| as the counter anion | | |
| 3-Methoxy-4-diazodiphenylamine hexafluorophosphate | 0.030 | g |
| Fluorochemical surfactant | 0.035 | g |
| (Megafac F-780, manufactured by Dainippon Ink and Chemicals, Inc.) | | |
| Methylethylketone | 26.6 | g |
| 1-Methoxy-2-propanol | 13.6 | g |
| γ-Butylolactone | 13.8 | g |

| | |
|---|---|
| | Cyanine dye A |
| 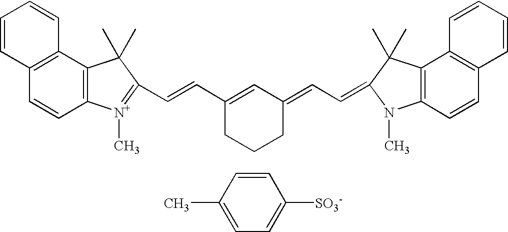 | |

<Synthesis of copolymer 1>
Copolymer 1 was synthesized in the same manner as in the first and second
embodiments.
<Coating solution for second layer (upper layer)>

| | | |
|---|---|---|
| Copolymer from ethyl methacrylate | 0.040 | g |
| and 2-methacryloyloxyethylsuccinic acid | | |
| (molar ratio: 75:25, weight-average molecular weight: 70,000) | | |
| Phenol cresol-formaldehyde novolak | 0.400 | g |
| (phenol:m-cresol:p-cresol = 50:30:20, | | |
| weight average molecular weight: 8800) | | |
| Specific sulfonium salt or comparative onium salt | 0.1 | g |
| Cyanine dye A (having the structure above) | 0.015 | g |
| Ethyl violet having 6-hydroxynaphthalenesulfonic acid | 0.012 | g |
| as the counter anion | | |
| Fluorochemical surfactant | 0.022 | g |
| (Megafac F-780, manufactured by Dainippon Ink and Chemicals, Inc.) | | |
| Methylethylketone | 13.1 | g |
| 1-Methoxy-2-propanol | 6.79 | g |

It should be noted that the numbers given in Table 1 below for the respective specific sulfonium salts correspond to the compound numbers of the exemplary compounds listed above.

TABLE 1

| | | | | Anti-scumming |
|---|---|---|---|---|
| | Sulfonium salt | Hammett value | Log P | property |
| Example 1 | 68 | 0.69 | −1.312 | A |
| Example 2 | 77 | 0.69 | 0.799 | A |
| Example 3 | structure | 0.69 | 2.609 | B |
| | shown below | | | |
| Comp. Ex. 1 | 28 | 0 | 4.233 | C |
| Comp. Ex. 2 | 13 | 0 | −0.146 | C |

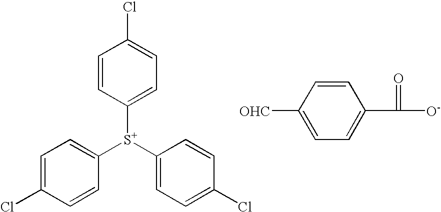

As can be seen from Table 1, the planographic printing plate precursors of Examples 1 to 3 employing the photosensitive composition of the invention in the recording layer accomplishes improvement in the anti-scumming property. On the other hand, the planographic printing plate precursors of Comparative Examples 1 and 2, where compounds having cation moiety with smaller Hammett values are employed, exhibit significantly poorer anti-scumming property. Further, comparing Examples 1 and 2 and Example 3, it is confirmed that a particularly remarkable effect is obtained when a sulfonium salt having a cation structure with a smaller Hammett value, as well as an anion moiety with log P within the preferable range, is used.

### Examples 4 to 6, Comparative Examples 3 and 4

The coating solution for the first layer (lower layer), having the composition described below, was applied by using a wire bar onto the support C to give a coating amount of 0.60 g/m² after the support C was dried in a drying oven at 120° C. for 90 seconds.

The coating solution for the second layer (upper layer), having the composition described below, was then applied by a wire bar onto the support having the undercoat layer thus obtained. After application, the support C was dried in a drying oven at 120° C. for 90 seconds, to produce positive-type planographic printing plate precursors of Examples 4 to 6 and Comparative Examples 3 and 4 respectively having total coating amounts of 1.35 g/m².

<Coating solution for first layer (lower layer)>

| | |
|---|---|
| Copolymer 1 | 2.200 g |
| Cyanine dye A (having the structure above) | 0.098 g |
| 2-Mercapto-5-methylthio-1,3,4-thiadiazole | 0.030 g |
| Cis-Δ⁴-tetrahydrophthalic acid anhydride | 0.100 g |
| 4,4′-Sulfonyl diphenol | 0.090 g |
| p-Toluenesulfonic acid | 0.008 g |
| Ethyl violet having 6-hydroxynaphthalenesulfonic acid | 0.100 g |
| as the counter anion | |
| 3-Methoxy-4-diazodiphenylamine hexafluorophosphate | 0.030 g |
| Fluorochemical surfactant | 0.035 g |
| (Megafac F-780, manufactured by Dainippon Ink and | |
| Chemicals, Inc.) | |
| Methylethylketone | 26.6 g |
| 1-Methoxy-2-propanol | 13.6 g |
| Dimethyl sulfoxide | 13.8 g |

<Coating solution for second layer (upper layer)>

| | |
|---|---|
| Copolymer from ethyl methacrylate | 0.040 g |
| and 2-methacryloyloxyethylsuccinic acid | |
| (molar ratio: 70:30, weight-average molecular weight: 88,000) | |
| Phenol cresol-formaldehyde novolak | 0.250 g |
| (phenol:m-cresol:p-cresol = 30:50:20, | |
| weight average molecular weight: 7700) | |
| Specific sulfonium salt or comparative onium salt compound | 0.02 g |
| Cyanine dye A (having the structure above) | 0.015 g |
| Fluorochemical surfactant | 0.022 g |
| (Megafac F-780, manufactured by Dainippon Ink and | |
| Chemicals, Inc.) | |
| Methylethylketone | 13.1 g |
| 1-Methoxy-2-propanol | 6.79 g |

### Evaluation of Examples 4 to 6 and Comparative Examples 3 and 4

The resulting planographic printing plate precursors of Examples 4 to 6 and Comparative Examples 3 and 4 were respectively evaluated in the same manner as in Example 1. The developer B was used for developing the planographic printing plate precursors. Results are shown in Table 2.

It should be noted that the numbers given in Table 2 below for the respective specific sulfonium salts correspond to the compound numbers of the exemplary compounds listed above.

TABLE 2

| | | | | Anti-scumming |
|---|---|---|---|---|
| | Sulfonium salt | Hammett value | Log P | property |
| Example 4 | 68 | 0.69 | −1.312 | A |
| Example 5 | 72 | 0.69 | −1.292 | A |
| Example 6 | Structure | 0.69 | 2.609 | B |
| | shown below | | | |
| Comp. Ex. 3 | 28 | 0 | 4.233 | C |
| Comp. Ex. 4 | 13 | 0 | −0.146 | C |

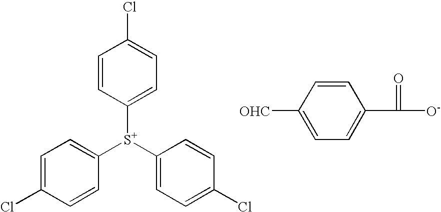

As can be seen from Table 2, comparing with the planographic printing plate precursors of Comparative Examples, the planographic printing plate precursors of Examples 4-6 accomplishes improvement in the anti-scumming property, as in Examples 1 to 3. From this point, it is found that, even if components of the photosensitive layer are varied, the planographic printing plate precursors employing the photosensitive composition of the invention in the recording layer exhibit the same excellent effect.

### Examples 7 to 9, Comparative Examples 5 and 6

The coating solution for the first layer (lower layer), having the composition described below, was applied by using a wire bar onto the support D to give a coating amount of 0.81 g/m² after the support D was dried in a drying oven at 150° C. for 60 seconds.

The coating solution for the second layer (upper layer), having the composition described below, was then applied by a wire bar onto the support having the undercoat layer thus obtained. After application, the support D was dried in a drying oven at 120° C. for 90 seconds, to produce positive-type planographic printing plate precursors of Examples 7 to 9 and Comparative Examples 5 and 6 respectively having total coating amounts of 1.1 g/m².

<Coating solution for first layer (lower layer)>

| | |
|---|---|
| Copolymer 1 above | 2.133 g |
| Cyanine dye A (having the structure above) | 0.098 g |
| Cis-Δ⁴-tetrahydrophthalic acid anhydride | 0.110 g |
| 4,4′-Sulfonyl diphenol | 0.090 g |
| p-Toluenesulfonic acid | 0.008 g |
| Ethyl violet having 6-hydroxynaphthalenesulfonic acid | 0.100 g |
| as the counter anion | |
| 3-Methoxy-4-diazodiphenylamine hexafluorophosphate | 0.030 g |
| Fluorochemical surfactant | 0.035 g |
| (Megafac F-780, manufactured by Dainippon Ink and | |
| Chemicals, Inc.) | |
| Methylethylketone | 26.6 g |
| 1-Methoxy-2-propanol | 13.6 g |
| γ-Butylolactone | 13.8 g |

<Coating solution for second layer (upper layer)>

| | |
|---|---|
| Copolymer from ethyl methacrylate | 0.0350 g |
| and 2-methacryloyloxyethylsuccinic acid | |
| (molar ratio: 65:35, weight-average molecular weight: 78,000) | |
| Cresol-formaldehyde novolak | 0.300 g |
| (m-cresol:p-cresol = 60:40, | |
| weight average molecular weight: 4100) | |
| Specific sulfonium salt or comparative onium salt compound | 0.0150 g |
| Cyanine dye A (having the structure above) | 0.015 g |
| Fluorochemical surfactant | 0.022 g |
| (Megafac F-780, manufactured by Dainippon Ink and | |
| Chemicals, Inc.) | |
| Methylethylketone | 13.1 g |
| 1-Methoxy-2-propanol | 6.79 g |

### Evaluation of Examples 7 to 9 and Comparative Examples 5 and 6

The resulting planographic printing plate precursors were evaluated in the manner described above. The developer A was used for developing the planographic printing plate precursors. Results are shown in Table 3.

The numbers given in Table 3 below for the respective specific sulfonium salts correspond to the compound numbers of the exemplary compounds listed above.

TABLE 3

| | | | | Anti-scumming |
|---|---|---|---|---|
| | Sulfonium salt | Hammett value | Log P | property |
| Example 7 | 75 | 0.69 | −0.707 | A |
| Example 8 | 72 | 0.69 | −1.292 | A |
| Example 9 | structure | 0.69 | 2.609 | B |
| | shown below | | | |
| Comp. Ex. 5 | 28 | 0 | 4.233 | C |
| Comp. Ex. 6 | 13 | 0 | −0.146 | C |

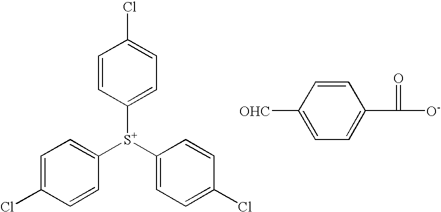

As can be seen from Table 3, the planographic printing plate precursors of Examples 7 to 9 accomplished improvement in the anti-scumming property.

### Examples 10 to 12, Comparative Examples 7 and 8

The image forming layer coating solution having the composition described below was applied onto the support D, and the support D was dried at 120° C. for 90 seconds to form the image forming layer. Thus, planographic printing plate precursors of Examples 10 to 12 and Comparative Examples 7 and 8 were obtained. A dry coating amount was 1.60 g/m².

<Image forming layer coating solution>

| | |
|---|---|
| Phenol cresol-formaldehyde novolak | 1.0 g |
| (phenol:m-cresol:p-cresol = 50:30:20, | |
| weight average molecular weight: 6500) | |
| Specific sulfonium salt or comparative onium salt compound | 0.05 g |
| Cyanine dye A (having the structure above) | 0.05 g |
| Dye, Victoria Pure Blue BOH, | 0.01 g |
| having an 1-naphthalenesulfonate anion as the counter anion | |
| Fluorochemical surfactant | 0.05 g |
| (Megafac F-177, manufactured by Dainippon Ink and | |
| Chemicals, Inc.) | |
| Methylethylketone | 9.0 g |
| 1-Methoxy-2-propanol | 9.0 g |

### Evaluation of Examples 10 to 12 and Comparative Examples 7 and 8

The resulting planographic printing plate precursors of Examples 10 to 12 and Comparative Examples 7 and 8 were respectively evaluated in the same manner as in Example 1. The developer A was used for developing the planographic printing plate precursors. Results are shown in Table 4.

The numbers given in Table 4 below for the specific sulfonium salt correspond to the compound numbers of the exemplary compounds listed above.

TABLE 4

| | | | | Anti-scumming |
|---|---|---|---|---|
| | Sulfonium salt | Hammett value | Log P | property |
| Example 10 | 76 | 0.69 | −0.935 | A |
| Example 11 | 72 | 0.69 | −1.292 | A |
| Example 12 | structure | 0.69 | 2.609 | B |
| | shown below | | | |
| Comp. Ex. 7 | 28 | 0 | 4.233 | C |
| Comp. Ex. 8 | 13 | 0 | −0.146 | C |

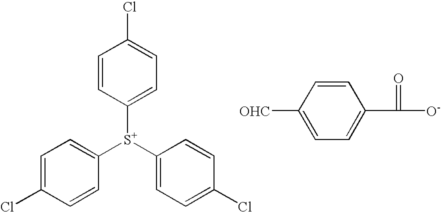

As can be seen from Table 4, the planographic printing plate precursors of Examples 10 to 12 accomplishes improvement in the anti-scumming property.

Further, comparing Examples 1 to 3 and Examples 10 to 12, it is confirmed that the planographic printing plate precursors employing the photosensitive composition of the invention in the recording layer exhibit the same excellent effect of the invention, regardless of the recording layer being single-layered or multi-layered.

1. A positive-type photosensitive composition, comprising:
a novolak resin (A);
an infrared absorbing agent (B); and
a sulfonium salt (C).

2. A positive-type photosensitive composition, comprising:
a novolak resin (A);
a specific alkali-soluble resin (B) selected from the group consisting of resins prepared by addition polymerization of a vinyl compound, imide, amide, urethane, urea, ester, and resol resins prepared by condensation polymerization;
an infrared absorbing agent (C); and
a sulfonium salt (D).

3. A positive-type photosensitive composition, comprising:
a novolak-type phenol resin (A) containing phenol as the structural unit;
an infrared absorbing agent (B); and
a sulfonium salt (C).

4. A positive-type photosensitive composition, comprising:
a novolak resin (A);
an infrared absorbing agent (B); and
a compound having triarylsulfonium salt structure (C), in which a sum of Hammett values of substituents bonded to aryl skeletons is greater then 0.46.

5. The positive-type photosensitive composition of claim 2, wherein the specific alkali-soluble resin (B) is a resin obtained by addition polymerization of a vinyl compound.

6. The positive-type photosensitive composition of claim 2, wherein the specific alkali-soluble resin (B) is a carboxyl group containing vinyl polymer.

7. The positive-type photosensitive composition of claim 2, wherein the specific alkali-soluble resin (B) is a carboxyl group containing vinyl polymer, and has a solubility parameter of less than 21.3 MPa^{1/2}.

8. A positive-type planographic printing plate precursor, comprising:
a hydrophilic support;
a lower layer containing a water-insoluble and alkali-soluble resin, formed on the support; and
an image recording layer containing the positive-type photosensitive composition of claim 2, formed on the lower layer.

9. A positive-type planographic printing plate precursor, comprising:
a hydrophilic support;
a lower layer containing a water-insoluble and alkali-soluble resin, formed on the support; and
an image recording layer containing the positive-type photosensitive composition of claim 6, formed on the lower layer.

10. The positive-type photosensitive composition of claim 3, wherein the novolak-type phenol resin (A) contains phenol, as a structural unit, in an amount of 20 to 90 mole % with respect to the total structural units constituting the novolak resin.

11. The positive-type photosensitive composition of claim 3, wherein the novolak-type phenol resin (A) contains phenol, as a structural unit, in an amount of 31 to 85 mole % with respect to the total structural units constituting the novolak resin.

12. The positive-type photosensitive composition of claim 3, wherein the novolak-type phenol resin (A) contains phenol, as a structural unit, in an amount of 51 to 80 mole % with respect to the total structural units constituting the novolak resin.

13. A positive-type planographic printing plate precursor, comprising:
a hydrophilic support;
a lower layer containing a water-insoluble and alkali-soluble resin, formed on the support; and
an image recording layer containing the positive-type photosensitive composition of claim 3, formed on the lower layer.

14. A positive-type planographic printing plate precursor, comprising:
a hydrophilic support;
a lower layer containing a water-insoluble and alkali-soluble resin, formed on the support; and
an image recording layer containing the positive-type photosensitive composition of claim 12, formed on the lower layer.

15. The positive-type photosensitive composition of claim 4, wherein the compound having triarylsulfonium salt structure (C), in which a sum of Hammett values of substituents bonded to aryl skeletons is greater then 0.46, is a compound including a cation in which a sum of Hammett values of substituents bonded to aryl skeletons of triarylsulfonium is greater then 0.46 and an anion of which hydrophilicity/hydrophobicity parameter log P is less than 2.

16. The positive-type photosensitive composition of claim 4, wherein the compound having triarylsulfonium salt structure (C), in which a sum of Hammett values of substituents bonded to aryl skeletons is greater then 0.46, is a compound including a cation in which a sum of Hammett values of substituents bonded to aryl skeletons of triarylsulfonium is greater then 0.46 and an anion of which hydrophilicity/hydrophobicity parameter log P is in a range of −1 to 1.

17. The positive-type photosensitive composition of claim 4, wherein the compound having triarylsulfonium salt structure (C) is a compound in which a sum of Hammett values of substituents bonded to aryl skeletons is greater then 0.60.

18. The positive-type photosensitive composition of claim 4, wherein the compound having triarylsulfonium salt structure (C), in which a sum of Hammett values of substituents bonded to aryl skeletons is greater then 0.46, is a sulfonium salt having a triarylsulfonium salt structure where —Cl is introduced into each of three aryl skeletons.

19. A positive-type planographic printing plate precursor, comprising:
a hydrophilic support;
a lower layer containing a water-insoluble and alkali-soluble resin, formed on the support; and
an image recording layer containing the positive-type photosensitive composition of claim 4, formed on the lower layer.

20. A positive-type planographic printing plate precursor, comprising:
a hydrophilic support;
a lower layer containing a water-insoluble and alkali-soluble resin, formed on the support; and
an image recording layer containing the positive-type photosensitive composition of claim 15, formed on the lower layer.
